(19) United States
(12) Patent Application Publication
(10) Pub. No.: US 2016/0365118 A1
(43) Pub. Date: Dec. 15, 2016

(54) VIDEO EDITING SYSTEM WITH MULTI-STAKEHOLDER CONTROL

(71) Applicants: Eran Steinberg, San Francsico, CA (US); Yaron Galant, Palo Alto, CA (US); Martin Paul Boliek, San Francisco, CA (US)

(72) Inventors: Eran Steinberg, San Francsico, CA (US); Yaron Galant, Palo Alto, CA (US); Martin Paul Boliek, San Francisco, CA (US)

(21) Appl. No.: 14/879,807

(22) Filed: Oct. 9, 2015

Related U.S. Application Data
(60) Provisional application No. 62/174,166, filed on Jun. 11, 2015.
(60) Provisional application No. 62/217,658, filed on Sep. 11, 2015.

(51) Int. Cl. G11B 27/031; G11B 27/11; G11B 27/34

(52) U.S. Cl. CPC G11B 27/031; G11B 27/34; G11B 27/11

(57) ABSTRACT

A video editing system and method using multi-stakeholder control are described. In one embodiment, the video editing system comprises editing processing logic controllable to perform, on one or more raw input feeds, a plurality of different edits to render one or more final cut clips for viewing, where each of the one or more edits transforms data from one or more of the raw input feeds into the one or more of the plurality of final cut clips by generating tags that identify highlights from signals, and generating one or more variations of the final cut clips as a result of independent control and application of the editing processing logic to data from the one or more raw input feeds, wherein the highlights are generated based on a master highlight list generated based on processing of tags from the tagging.

### PRIORITY

The present patent application claims priority to and incorporates by reference corresponding U.S. provisional patent application Ser. No. 62/174,166, titled, “MULTIPARTICIPANT, MULTISTAGED DYNAMICALLY CONFIGURED VIDEO HIGHLIGHTING SYSTEM,” filed on Jun. 11, 2015 and U.S. provisional patent application Ser. No. 62/217,658, titled, “HIGHLIGHT-BASED MOVIE NAVIGATION AND EDITING,” filed on Sep. 11, 2015.

### FIELD OF THE INVENTION

The technical field relates to systems and methods of capturing, storing, processing editing and viewing of video data. More particularly, the technical field relates to systems and methods for generating videos of potentially interesting events in recordings.

### BACKGROUND OF THE INVENTION

Portable cameras (e.g., action cameras, smart devices, smart phones, tablets) and wearable technology (e.g. wearable video cameras, biometric sensors, GPS devices) have revolutionized recording of data associated with activities. For example, portable cameras have made it possible for cyclists to capture first-person perspectives of cycle rides. Portable cameras have also been used to capture unique aviation perspectives, record races, and record routine automotive driving. Portable cameras used by athletes, musicians, and spectators often capture first-person viewpoints of sporting events and concerts. Portable cameras lend themselves, through long battery life and ample storage space, to spectator recording events. For example parents record their children playing youth sports, celebrating birthdays, or being active at home; spectators of a race or a game recording the event, and people recording their friends in social activities. As the convenience and capability of portable cameras improve, increasingly unique and intimate perspectives are being captured.

Similarly, wearable technology has enabled the proliferation of telemetry recorders. Fitness tracking, GPS, biometric information, and the like enable the incorporation of technology to acquire data on aspects of a person's daily life (e.g., quantified self).

In many situations, however, the length of recordings (i.e., time and/or data, also referred to in the film era as “footage” or “rough footages”) generated by portable cameras and/or sensors may be overwhelming. People who record an activity often find it difficult to edit long recordings or to find or highlight interesting or significant events. Moreover, people who are subjected to viewing such recordings find them to be tedious very quickly. For instance, a recording of a bike ride may involve depictions of long uneventful stretches of the road. The depictions may appear boring or repetitive and may not include the drama or action that characterizes more interesting parts of the ride. Similarly, a recording of a plane flight, a car ride, or a sporting event (such as a baseball game) may depict scenes that are boring or repetitive. Manually searching through long recordings for interesting events may require an editor to scan all of the footage for the few interesting events that are worthy of being shown to others or storing in an edited recording. A person faced with searching and editing footage of an activity may find the task difficult or tedious and may choose not to undertake the task at all. Some solutions for compressing the data, and in particular the time are being developed and offered from fast forwarding, selective compression, or timelapse technologies. However, in all of the above, the editing is linear in nature and does not offer an automatic means of generating the distilled video clip of an event based on external meta data and/or preferences. Moreover, the prior art process of generating a distilled video is fixed, not taking into account the viewer's preferences and or the system requirements allowing for multiple resulting outputs dynamically generated form a single source of recorded data.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A illustrates different elements that comprise a video creation process from the capture of raw video data to creation of a final-cut version.

FIG. 1B illustrates that multiple instantiations of both a rough-cut and a final-cut that may be generated based on multiple instantiations of a MHL and tagging systems.

FIG. 2 is a flow diagram of one embodiment of a process and various operators for creating a summary movie.

FIG. 3A is a flow diagram of another embodiment of a process for creating a summary movie.

FIG. 3B illustrates a session interpreter accessing previous highlight list data of an individual user to create movie compilations.

FIG. 4 is a flow diagram of another embodiment of a process for creating a summary movie.

FIG. 5A is a flow diagram of one embodiment of machine learning processes interacting with the processes for creating tags, highlights, clips, and final-cut movies.

FIG. 5B is a flow diagram of one embodiment of a video editing process.

FIG. 5C illustrates a block diagram of a video editing system that performs machine learning operations described herein.

FIG. 6 illustrates one embodiment of subsets of processes performed in creating a single summary movie.

FIGS. 7A-D illustrates the players, or stakeholders, in the real-time video capture, highlighting, editing, storage, sharing and viewing system that may control the data processing flows depicted in FIGS. 1A, 1B, and 2-6.

FIG. 7A illustrates one embodiment in which all three stakeholders can access or control a single editing process (or processor).

FIG. 7B illustrates another embodiment in which each of the individual stakeholders can interact with a set of instructions unique to that stakeholder.

FIG. 7C illustrates yet another embodiment in which each of the stakeholders in order can either fix or provide a predetermined range of instructions and/or rough-cut media for the succeeding stakeholders to manipulate.

FIG. 7D illustrates the originator takes a video, an intermediary makes preliminary edits and a viewer views the video.

FIG. 7E is a flow diagram of one embodiment of a video editing process.

FIG. 7F is another flow diagram of one embodiment of a video editing process.

FIG. 7G is another flow diagram of one embodiment of a video editing process.

FIG. 7H is another flow diagram of one embodiment of a video editing process.

FIG. 7I illustrates a block diagram of a video editing system that performs multi-stakeholder operations described herein.

FIG. 8A illustrates embodiments of the process for creating a summary movie that involves participant sharing.

FIG. 8B is a flow diagram of one embodiment of a process for creating video clips regarding an activity using information of another participant in the activity.

FIG. 8C illustrates a block diagram of a video editing system that performs participant sharing operations described herein.

FIG. 9 is a block diagram of one embodiment of a smart phone device.

FIG. 10 shows a number of computing and memory devices.

FIG. 11 shows a single device with multiple functions.

FIG. 12 shows one embodiment where the signals are captured by a smart phone device, the media data is captured by a media capture device, and the processing is performed by cloud computing.

FIG. 13A shows a different embodiment that uses a smart phone device to capture the signals; a media capture device; cloud computing to perform the signal processing and highlight creation; and a client computer to extract clips and create summary movie creation.

FIG. 13B is a flow diagram of another embodiment of a video editing process.

FIG. 13C is a flow diagram of one embodiment of a process for processing captured video data.

FIG. 13D illustrates a block diagram of a video editing system that performs distributed computing operations described herein.

FIG. 14 illustrates information on a single video segment according to one embodiment.

FIG. 15 illustrates an exemplary video editing process.

FIG. 16 illustrates another version of the editing process in which raw video is subjected to an MHL.

FIG. 17 illustrates an example of a thumb (or finger) tagging language.

FIG. 18 depicts a block diagram of a storage system server.

FIG. 19 is a block diagram of a portion of the system that implements a user interface (UI).

FIG. 20A is a flow diagram of one embodiment of a process for tagging a real-time stream.

FIG. 20B is another embodiment of the real-time capture implementation of the system.

FIG. 21 shows the user preview of a movie capture.

FIG. 22 shows one embodiment of the pixels or samples of the image created by projecting the image on the smart phone's video sensor.

FIG. 23 shows a different embodiment pixels or samples of the image created by projecting the image on the smart phone's video sensor.

FIG. 24 shows data flow for Portscape™ embodiments.

FIG. 25 illustrates one embodiment of an instrumented movie player.

FIG. 26 shows the difference between a timeline and a highlight line for navigating the movie playback.

FIGS. 27A and 27B show a visual page containing highlights that can be included.

FIGS. 28A and 28B illustrate a visual page containing both highlights that are included in the movie and highlights that can be included.

FIG. 29 is a flow diagram of one embodiment of a process for processing captured video data.

FIG. 30 is a flow diagram of one embodiment of a process for processing captured video data.

FIG. 31 is a flow diagram of one embodiment of a process for using gestures while recording a stream to perform tagging.

FIG. 32 is a flow diagram of one embodiment of a process for using gestures during play back of a media stream.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

The description may use the phrases “in one embodiment,” or “in embodiments,” which may each refer to one or more of the same or different embodiments. Furthermore, the terms “comprising,” “including,” “having,” and the like, as used with respect to embodiments of the present disclosure, are synonymous.

### Overview

A video capture, highlighting, editing, storage, sharing and viewing system is described. The system records or otherwise captures and/or receives from one or more other capture devices raw video and generates or receives metadata or signal information associated with the video and or certain portions thereof. The system then, via adaptable editing, generates one or several versions of videos (e.g., movies), which may include one or several variant versions of the rough-cut of the raw video data and one or several versions variants of the final-cut. The process of determining the rough-cut and or the final-cut is based on the metadata generated.

There are three roles (“stakeholders”) in the process: (a) the originator(s) such as the videographer, director, photographer or source integrator, who captures the video(s); (b) the intermediary, also referred to as the editors(s) who creates the rough or final cut(s); and (c) the viewer(s), also referred to the consumer, who consumes or views the final cut. Specifically, the system's flexibility allows different individuals or automated systems or predefined role of the editor(s).

In one embodiment, the rough-cut is an intermediate state in which some or most of the data that was gathered and stored in the raw stage is discarded. The rough-cut can refer to extracted rough-cut media clips, a rough-cut highlight list, and/or a rough-cut version of a summary movie. In one embodiment, the final-cut is defined as an edited version of the rough-cut, ready for viewing by the consumers. The final-cut can refer to extracted final-cut media clips, a final-cut highlight list, and/or a final-cut version of a summary movie.

A variety of rough-cut or final-cut video versions may be generated based on different interpretation of the signal data by different stakeholders, systems or people. That is, the system allows different editors to create and ultimately view different, personalized versions of a movie. Therefore, when a video recording is made, the different versions ultimately generated from the video recording are not limited to a fixed result, but a dynamically malleable “movie” that can be modified based on the interpretation of the meta data using the preferences of different users.

As will be described below in more details, some embodiments of the system have one or more key characteristics including, but not limited to:
a. temporal tokenization of an experience, by allowing editing of “moments” captured in video, which is in tune with the typical human experience;
b. malleability which enables the originator, the intermediary, and/or viewer to create, edit, and consume the video content differently;
c. automatic gathering and encoding of signal data information;
d. manual insertion of signal information;
e. automation of operations like editing, storage, upload, sharing, and compilations;
f. learning (e.g., machine learning) capabilities to empower the automation;
g. interactive user models that allow individual users to affect the outcome of different stages of the data processing while reducing friction and distraction;
h. mashup capabilities allowing automatic or manual incorporation of videos snippets captured by different devices and people;
i. search, browse, and other discovery tools that facilitate locating specific moments;
j. compilation creation that blend highlights from past activities into summary movies (e.g., best-of, same activity year over year);
k. commercialization system that calculates monetary values according to various rules relating to the use of the system; and
l. commercialization system that defines the usage or subscription of the originators, editors and viewers.

### Overview of the System

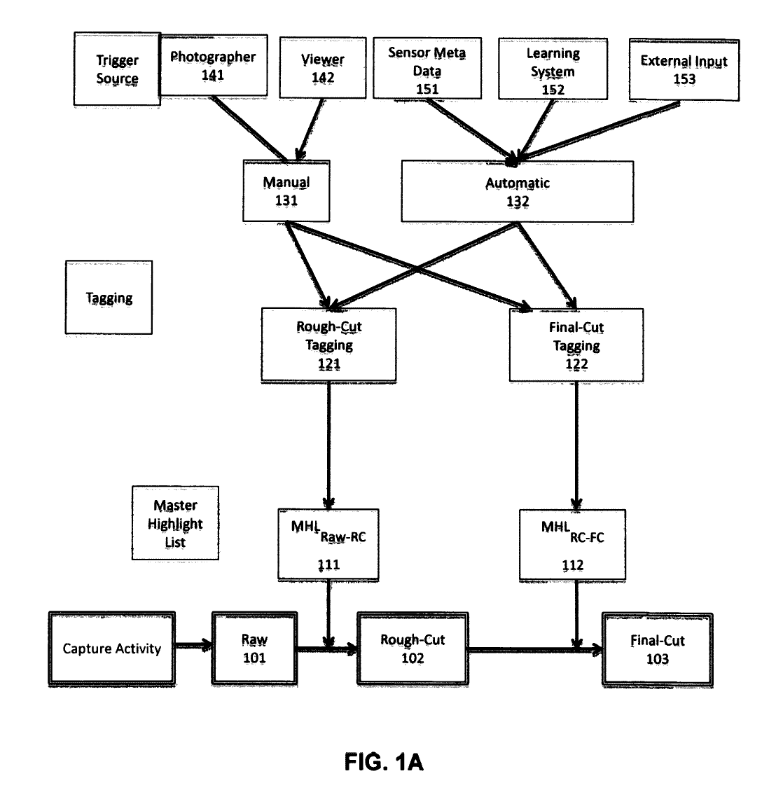

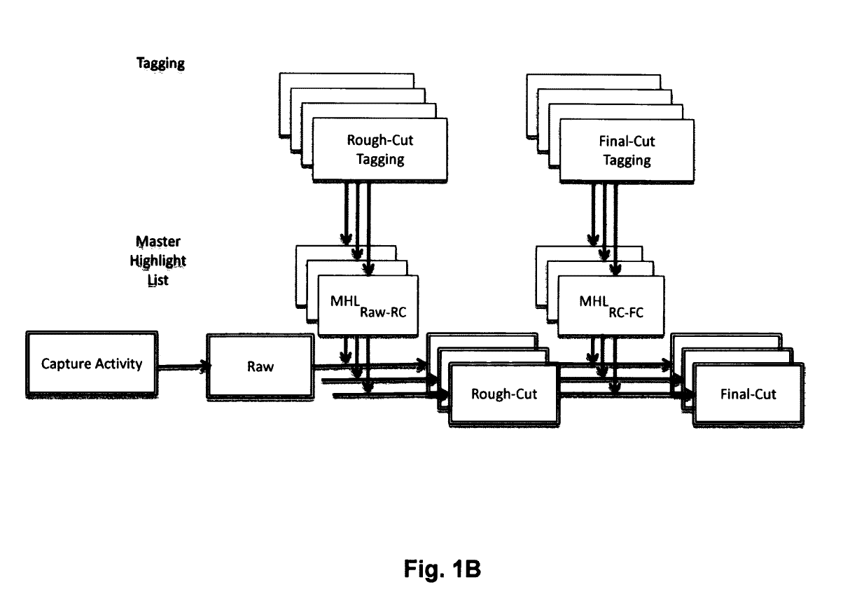

FIG. 1A illustrates different elements that comprise the video creation process from the capture of raw video data to creation of a final-cut version. Referring to FIG. 1A, there are three elements: video (101,102,103), tagging (121, 122) and editing instructions known as Master Highlight Lists (111,112). Specifically, a system captures data to create raw video 101. Such capture can be continuous (meaning a continuous video recording) or can be manually controlled (either by pausing or concatenation of a selection of video segments) or triggered by external sensors (such as motion sensors, location sensors etc.). A rough-cut version of the data is generated and stored as rough-cut 102 and a final-cut is generated and potentially stored or viewed as final-cut 103.

The transformation instructions between the different stages are referred to as Master Highlight Lists (also referred to as “MHL”). The transformation instructions between raw (101) and rough-cut (102) are referred to as MHL_{Raw-RC} (111). The transformation between rough-cut (102) and final-cut (103) are referred to as MHL_{RC-FC} (112). The metadata (or otherwise referred to as signal data) is stored as tags. The tagging of the raw images which are used to generate the rough-cut are depicted in 112 and the tagging that is generated to create the Master Highlight List that generates the final-cut from the rough-cut are depicted in 122.

### Video

In one embodiment, the video capture device is a video camera. In yet another embodiment, the video capture device is a smart phone. In still another embodiment, the video capture device is an action camera. In yet another embodiment, the video capture device is a wearable device. In principal, that any device having a camera capable of capturing an activity on video may be used.

The capturing, meaning storage of the raw video into a temporary buffer, and the recording, meaning the storing of the data into persistent memory, are two different activities. In one embodiment, the capture of an activity is performed continuously, and only portions of the raw video are recorded. In one embodiment, the capture device does not need to use an on/off button. Instead, the video capture occurs as soon as an application is started on the capture device. Alternatively, the capturing starts as soon as the user performs a gesture with the capture device (e.g., moving the device in a particular manner). In yet another embodiment, the capture device begins recording according to a specific command (e.g., pressing a button). In yet another embodiment, the capture device begins and stops recording according to a specific command (e.g., pressing a button). In yet another embodiment, the capture device may pause according to a specific command (e.g., pressing a button) and resume according to a specific command. In such cases, the raw data may continuously store the various segments as a single instantiation of the raw data clip.

In some devices, the settings for the capture of video (e.g., resolution, frame rate, bitrate) are different for the captured frames, the preview screen that is presented to the user in real-time, and the encoding and storage of the raw video. In some embodiments, the frame image is capture at a high resolution and quality (bitrate) and is then saved as a still image at high resolution and quality and also as a video frame at a lower resolution and bitrate.

In one embodiment, raw video 101 is stored permanently to enable access the new video data in the future. In yet another embodiment, only the rough cut is being permanently stored. One may consider the stored raw video as an extreme version of the rough-cut that was not trimmed. The storage may be part of the capture device or at another device and/or location. In one embodiment, such a location can be a remote server, also referred to as cloud storage.

Raw video 101 is edited by an editing system to create rough-cut video 102. In one embodiment, rough-cut video 102 is generated from raw video 101 on the fly. In one embodiment, raw video 101 is temporarily stored and is discarded after editing into rough-cut video 102. The editing system may be part of the capture device or may be a device coupled to the capture device or remote from the capture device (e.g., a remote server or cloud storage).

Subsequently, rough-cut video 102 is further edited to create final-cut video 103. In one embodiment, final-cut video 103 is generated on the fly. Note that in one embodiment, final-cut video 103 is generated from raw video 101.

Each version of the video (e.g., the raw video, rough-cut video, and final-cut video) may be associated and or generated by the same or different party (e.g., a photographer, a viewer, a system).

### Tagging

MHL 111 of rough-cut video 102 and MHL 112 of final-cut video 103 are generated in response to tagging. For example, MHL 111 is generated in response to rough-cut tagging 121. Similarly, MHL 112 is generated in response to final-cut tagging 122. Tagging is an indication provided to the capture system (or other system performing video and editing) indicating that a segment of video should be retained or otherwise marked for inclusion into another version of the video.

Tagging may be performed manually (131) or automatically (132) and occurs in response to a trigger source. In the case of manual tagging 131, the trigger source is an individual. In one embodiment, the individual is the photographer of the activity (i.e., the capture device operator or originator). In another embodiment, the individual providing the manual trigger is a viewer of raw video 101 and/or rough-cut video 102. In another embodiment, the individual is a human editor (e.g., intermediary). The individual viewing raw video 101 may view it after viewing rough-cut video 102 and/or final-cut video 103 in order to gain access to the original raw video.

In the case of automated tagging, the trigger source is an input from a plugged device. With respect to automatic tagging 132, the trigger sources may include one or more of sensor metadata whether in the devices 151 or external to the device 153 or have a sensor or machine learning system 152. In one embodiment, machine learning systems 152 aggregates individual experiences from one or more client devices and uses algorithms that act upon that information to predict triggers. The individual experiences may be associated with the same or similar activities or from the same or other individuals. Sensor devices 151 and 153 may include either exact data points, relative data points or change in data points. Exact data may include GPS data, sound, temperature, heart rate, and/or respiratory rate. Relative data may include one or many as linear acceleration, angular accelerating, a change in the exact data triggered either by a relative, or as an absolute threshold values (e.g. G-Force, change in heart rate, change in respiratory rate, etc.). Other sensor types include accelerometer, gyro, magnetometer, biometric (e.g., heart rate, skin conductivity, blood oxidization, pupil dilation, wearable ECG sensor), other telemetry (e.g., RPM, temperature, wind direction, pressure, depth, distance, light sensor, movement sensor, radiation level, etc.).

Note that automatic tagging and manual tagging can occur in conjunction with each other, can augment each other (increasing the score and/or altering start and end times), or can override each other. In such a case, the interpreter (described below) determines and/or selects which tags control the rough-cut and/or final cut creation.

### Master Highlight List (“MHL”)

The master highlight list or a collection of lists is a list of one or more segments (or highlights) of the captured activity. In some embodiments, the individual highlights in the master highlight list include the start time, the end time and/or duration, and one or more score(s). The scores are assigned by the analyzer process and/or the interpreter process (see description below). These scores can be used in many different ways, described below. In some embodiments, the description of the highlight also indicates pointers to media data that is relevant to that highlight (e.g., video, annotation, audio that occurs at the time of the highlight). There can be many sources of media for one highlight.

In one embodiment, rough-cut video 102 and final-cut video 103, including any and all different versions of the two, are generated based on a single master highlight list (“MHL”). The MHL is generated from the tags based on the signal data. The signal data (meta data) are either generated automatically or manually. In one embodiment, these segments are the segments having content of interest, at least potentially, to the originator (e.g., a photographer, a director, etc.), the intermediary, or another viewer. More specifically, rough-cut video 102 is created from raw video 101 based on a master highlight list 111. Similarly, final-cut video 103 is a subset of the rough-cut, generated from rough-cut video 102 in response to master highlight list 112. In some embodiments, the final-cut master highlight list (sometimes called a movie highlight list) is a processed subset of the rough-cut master highlight list. Movie and Master highlight lists 111 and 112 can have several instantiations such that there are numerous different versions of rough-cut video 102 and many different versions of final-cut video 103. These different instantiations may be different because a different party is generating different tags. For example, when the master highlight list is generated by the photographer (or capture device operator) the highlight list may be different than when it's generated by a system or a viewer of the video (e.g., a viewer of raw video 101, a viewer of rough-cut video 102). The highlight list may be different still from the highlights generated by an editor (a person or a computer program accessing the captured data after the capture has taken place and before the viewing).

Thus, when editing the captured raw video 101 into rough-cut video 102 and final-cut video 103 to include their respective lists of highlights, the editing is controlled via tagging which may be controlled by the capture device operator (e.g., photographer), a system, or a separate individual viewer.

FIG. 1B illustrates that multiple instantiations of both the rough-cut (102) and the final-cut (103) may be generated based on multiple instantiations of the MHL (111,112) and the tagging systems (121,122) respectively. More specifically, according to one embodiment, and as depicted in FIG. 1B, video 101 may be edited in a number of different ways to create a number of different rough-cut versions of raw video 101. Similarly, the rough-cut video 102 may be edited in a number of different ways, thereby creating a number of different final-cut versions of raw video 101 (and a number of different versions of rough-cut video 102).

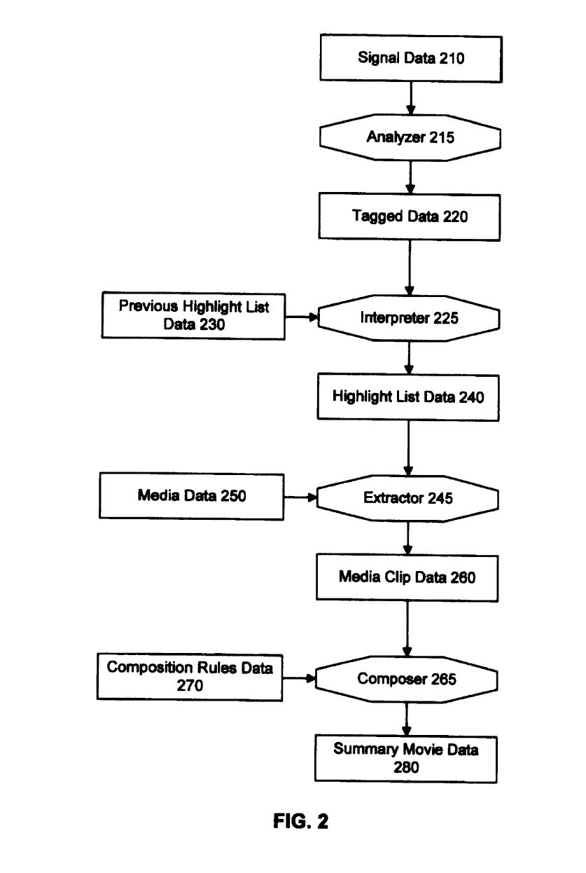

FIG. 2 is a flow diagram of one embodiment of a process and the various operators for creating a summary movie. The summary movie may comprise one of the rough-cut versions or one of the final-cut versions described above with respect to FIGS. 1A and 1B. The process is performed by processing logic that may comprise hardware (circuitry, dedicated logic, etc.), software (such as is run on a general purpose computer system or a dedicated machine), firmware, or a combination of the three. Furthermore, in some embodiments, all of the processes in FIG. 2 are performed on the same machine (e.g., a local client smart phone, a Personal Computer (PC), remote cloud computing, etc.). In other embodiments, the processes and the data can be distributed between two or more machines.

Referring to FIG. 2, the process obtains signal data 210. Signal data 210 is the raw data, and may include, for example, audio stream(s), video(s), sensor(s) data, or global positioning system (GPS) data, manual user input, etc. In one embodiment, any data that is separately captured is signal data 210. In one embodiment, signal data 210 comprises media data.

In one embodiment, signal data 210 includes all the physical, manual, and implied source of data. This data can be captured before, during and/or after some real-time activity and is used to aid in the determination of highlights in time.

In one embodiment, media data 250 includes all of the resources (raw, rough-cut and/or final-cut clips and/or summary movies) used to compile a presentation or summary video. Media data 250 can include video, audio, images, text (e.g., documents, texts, emails), maps, graphics, biometrics, annotation, etc. While video and movies are discussed most frequently with reference to the term media data 250 herein, the techniques disclosed herein are not limited to those two forms of media.

The difference between signal data 210 and media data 250 is how they are used in the processing described herein. In some embodiments, some data is used for both signal data 210 and media data 250. For example, in some embodiments, the audio track is used both as a signal for determining tags and as media for creating rough-cut and final-cut movies.

### Sensors

Sensor data may include any relevant data that can correspond with the captured video. Example of such sensors include, but are not limited to: chronographic e.g. clock, stopwatch, chronograph; acoustic sound; vibration; geophone; hydrophone; microphone; motion; speed e.g. to dometer, used measure the instantaneous speed of a land vehicle; speed sensor, used to detect the speed of an object; throttle position sensor used to monitor the position of the throttle in an internal combustion or an electric engine; fuel mixture sensor such as AFR or O2 sensor; tire-pressure monitoring sensor used to monitor the air pressure inside the tires; torque sensor or torque transducer or torque meter used to measure torque (twisting force) on a rotating system; vehicle speed sensor (VSS) used to measure the speed of the vehicle; water sensor or water-in-fuel sensor, used to indicate the presence of water in fuel; wheel speed sensor, used for reading the speed of a vehicle's wheel rotation; navigation instruments e.g. GPS, direction; true airspeed; ground speed; G-force; altimeter; attitude indicator; rate of climb; true and apparent wind direction; echosounder; depth gauge; fluxgate compass; gyroscope; inertial navigation system; inertial reference unit; magnetic compass; MHD sensor; ring laser gyroscope; Tturn coordinator; TiaLinx sensor; variometer; vibrating structure gyroscope; yaw rate sensor; position, angle, displacement, distance, speed, acceleration; auxanometer; capacitive displacement sensor; capacitive sensing; free fall sensor; gravimeter; gyroscopic sensor; impact sensor; inclinometer; integrated circuit piezoelectric sensor; laser rangefinder; laser surface velocimeter; LIDAR; linear encoder; linear variable differential transformer (LVDT); liquid capacitive inclinometers; odometer; photoelectric sensor; piezoelectric accelerometer; position sensor; rate sensor; rotary encoder; rotary variable differential transformer; Selsyn; shock detector; shock data logger; tilt sensor; tachometer; ultrasonic thickness gauge; variable reluctance sensor; velocity receiver; force, density, level; Bhangmeter; hydrometer; force gauge and force sensor; level sensor; load cell; magnetic level gauge; nuclear density gauge; Geiger counter; piezoelectric sensor; strain gauge; torque sensor; viscometer; proximity, presence meters; alarm sensor; Doppler radar; motion detector; occupancy sensor; proximity sensor; passive infrared sensor; Reed switch; stud finder; heart monitor; blood oxidization sensor; respiratory rate monitor; brain activity sensor; blood glucose sensor; skin conductance sensor; eye tracker; pupil dilation monitor; triangulation sensor; touch switch; wired glove; radar; sonar; and video sensor; and any and all collections of sensor data used to determine the motion, impact, and failure in vehicles (e.g., sensors that deploy airbags in cars, sensors associated with “black boxes” in aircraft).

### Analyzer

Analyzer 215 receives signal data 210 and creates tag data 220. In essence, the analyzer 215 process defines points in time with respect to signal data 210. For example, analyzer 215 may tag a point in a video capture, thereby creating tag data 220 that specifies a portion of the video that has a predetermined length (which can be provided per activity or adjusted by the user as a, e.g., 6 seconds for a basketball game or 30 seconds for a soccer game etc.). In one embodiment, analyzer 215 tags multiple portions of signal data 210 so that tag data 220 specifies multiple pieces of signal data 210. In one embodiment, analyzer 215 incorporates machine vision, statistical analysis, artificial intelligence and machine learning. In some embodiments, the analyzer 215 creates one or more scores for each tag.

### Interpreter

Interpreter 225 receives tagged data 220 and creates highlight list data 240. In one embodiment, each of the highlights in highlight list data 240 includes a beginning of the highlight, an ending of the highlight, and a score. Interpreter 225 generates the score for each highlight.

In one embodiment, interpreter 225 generates highlight list data 240 in response to inputs that control its operation. In one embodiment, those inputs include previous highlight list data 230, which include data corresponding to a previously generated list of highlights. Such sets of previous highlights are useful when going from a raw cut to multiple final-cuts or from a rough-cut to multiple final-cuts. In this manner, highlight list data 240 provides a context to the system when making rough-cuts or final-cuts. For example, see Galant et al., U.S. Patent Application Publication No. 2014/0334796, filed Feb. 25, 2014.

### Extractor

After highlight list data 240 has been created, extractor 245 uses highlight list data 240 to extract media clips from signal data 210 to create media clip data 260. In one embodiment, extractor 245 performs the extraction based on media data 250. Media data 250 can be raw video, rough-cut video, or both.

### Composer

Composer 265 receives media clip data 260 and creates summary movie data 280 therefrom in response to composition rules data 270. Media clip data 210 can be rough-cut clips, final-cut clips, or both. Composition rules data 270 includes one or more rules for compositing summary movie data 280 from media clip data 260. In one embodiment, composition rules data 270 specifies a limit on the length of time that summary movie data 280 takes when playing. In another embodiment, composition rules data 270 specifies one or more of the following examples: length of a highlight, number of highlights, min/max frequency of highlights in the movie (e.g., how to fill the story with representative clips), whether to include highlights from other participants MHL, whether to include media from other participants, relative weightings of the types of highlights give the signal sources and strengths, movie resolution, movie bitrate, movie frame rate, movie color quality, special movie effects (e.g., sepia tone, slow motion, time lapse), transitions (e.g., crossfade, fade in fade out, wipes of all sorts, Ken Burns effect), and many other common editing techniques and effects.

In some embodiments, all or part of the flow of FIG. 2 is run twice, first for the rough-cut and secondly for the final-cut. The first pass includes all signal data 210, processed by analyzer 215 to create tagged data 220. Tagged data 220 is processed by interpreter 225 to create a rough-cut highlight list data 240 for a rough-cut version. Media data 230 is the raw media. Extractor 245 uses highlight list data 240 and media data 250 to create rough-cut media clip data 260. In some embodiments, rough-cut media clip data 260 is used by composer 265 to create a rough-cut summary movie.

During the second pass, interpreter 225 uses rough-cut highlight list data 240 from the first pass as previous highlight list data 230. Interpreter 225 may or may not use the tagged data 220 from the first pass. Interpreter 225 then creates a final-cut highlight list data 240. Extractor 245 uses final-cut highlight list data 240 and rough cut media data 250, that is rough-cut media clip data 260 from the first pass, to create final-cut media clip data 260. Using final-cut media clip data 260 and composition rules data 270, composter 265 creates final-cut summary movie data 280.

In some embodiments, interpreter 225 is aware of whether there is media data 250 that covers the time for a given tag in tagged data 220. In some embodiments, this is achieved by iterating between interpreter 225 creating highlight data 240 and using another process (not shown) to compare the highlights with media data 250 to determine if there is media for a given highlight. This result is then used as previous highlight list data 230 and interpreter 225 is run again. New highlight list data 240 may be different than the first one given that some highlights do not have media coverage and are, therefore, given a lower weighing or discarded entirely. This embodiment can be used for the first and/or second passes described above.

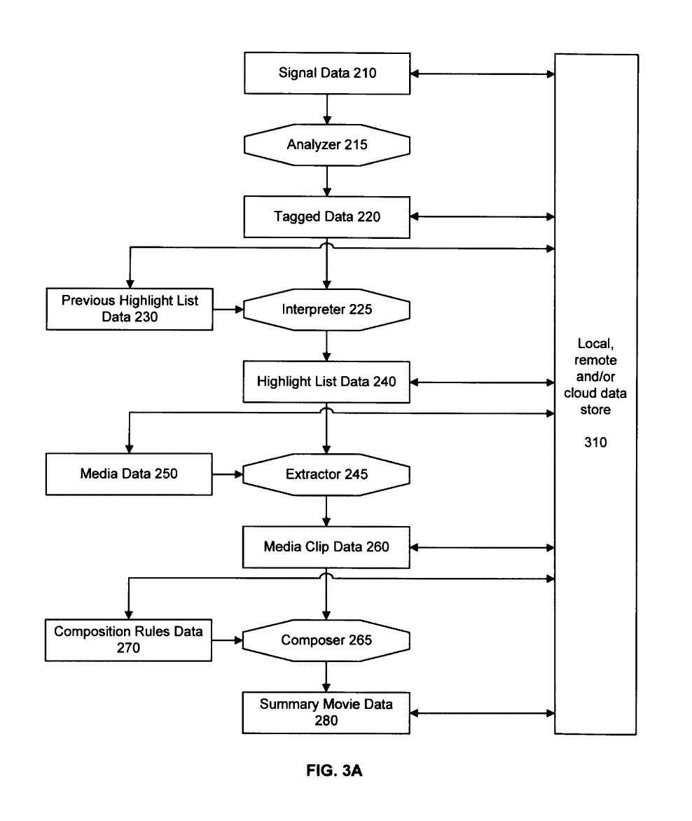

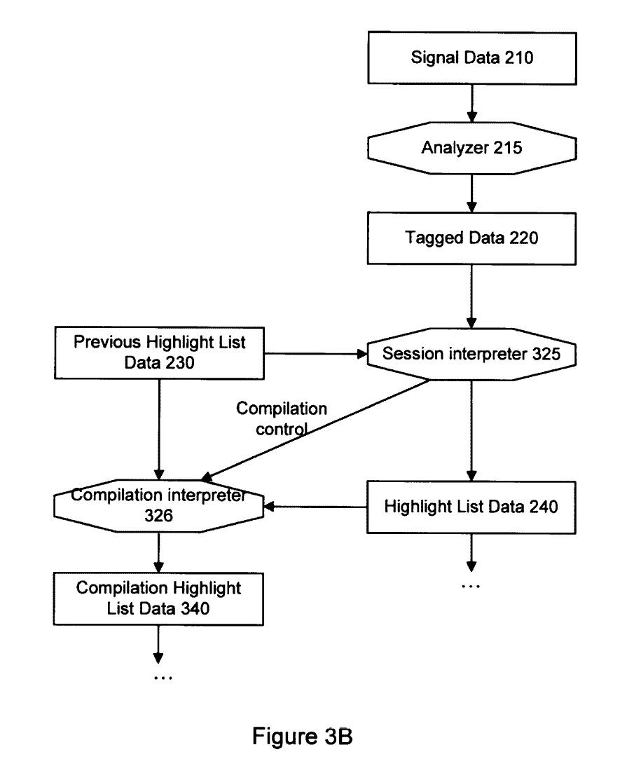

In one embodiment, all of the data used in the process is sourced and saved from one or more storage locations. FIG. 3A is a flow diagram of such an embodiment of the process for creating a summary movie. The process is performed by processing logic that may comprise hardware (circuitry, dedicated logic, etc.), software (such as is run on a general purpose computer system or a dedicated machine), firmware, or a combination of the three.

The data processing and flow of FIG. 3A are the same as that of FIG. 2, with the addition of data store 310, the location of the storage for the various operations in the data flow. Such data store 310 includes local, remote, and/or cloud data store. Referring to FIG. 3A, signal data 210, tagged data 220, previous highlight list data 230, highlight list data 240, media data 250, media clip data 260, composition rules data 270, and summary movie data 280 may be obtained from or stored to local, remote, and/or cloud data store 310. In one embodiment, the local, remote, and/or cloud data store 310 includes a single memory (e.g., RAM, Flash, magnetic, etc.) that stores and retrieves all of the data in the system (e.g., signal, tagged, highlight lists, media, clips, and composition rules). In another embodiment, the local, remote, and/or cloud data store 310 includes one or more memory devices at one or more places in the system (e.g., a local client, a peer client, cloud, removable storage). In one embodiment, long-term storage of media, signals, and highlights using cloud storage compensates for the limited and/or expensive storage on local client devices.

In one embodiment, signal data 210, tagged data 220, and/or highlight list data 240 is stored in one or more databases for random and relational searching. In one embodiment, these databases are located in local, remote, and/or cloud data storage 310.

In one embodiment, each iteration through the data processing flow exploits all of the data to which the flow has access. In one embodiment, there are multiple sources of data. In yet another embodiment, some of the processes are specific to the data type and/or source. In one embodiment, some of the processes, whether specific to the data, can be duplicated and can effectively run in parallel.

A given activity may cover more than one capture session of signal and video capture. The photographer may stop or pause the capture. If the movie capture is performed on a smart phone, there may be interruptions with phone calls and other functions. Furthermore, it may be desirable to offer summary movies that cover a number of activities over a time period, say a day or a month or a year. Finally, summary movies may cover a particular activity, grouping of people, locations or other common theme. To achieve compilations of sessions the system is able to create theme compilations of master highlight lists, rough-cut and/or final-cut clips, and make compilation summary movies to express the desired theme.

In FIG. 3B, session interpreter 325 has access to the some or all of the previous highlight list data 230 of an individual user. Session interpreter 325 determines if a session should be members of a given theme. In one embodiment, session interpreter 325 directly creates the theme master highlight list. In another embodiment, session interpreter 325 starts one or more runs of a compilation interpreter 326 to create theme compilation master highlight list 340. In some embodiments, both session master highlight list 240 and theme compilation master highlights lists 340 are created. In some embodiments, only theme compilation master highlights lists 340 are created.

The determination of which sessions are relevant and involved in a compilation is a function of the theme of the compilation. For example, in one embodiment, where multiple sessions are determined to be the same activity, the time between sessions is the most relevant parameter. Looking at all sessions over a period of time (e.g. a day, a week) the time gap between sessions is calculated. Those adjacent sessions that are closer in time based on some statistic (e.g., average, sigma of the normal distribution) are considered the same activity.

In some embodiments, there is a period of time (e.g., today, this week, this month) that determines which sessions to include.

In some embodiments, there is a particular type of activity or specific theme (other than one activity or period of time) that suggest which sessions to include. Compilation interpreter 326 relies on context descriptors that can be from the signals. For example, if the theme is all sessions (and previous compilations) that show a girl's soccer matches, compilation interpreter 326 might rely on detected activity type information to select soccer games (e.g., detected by their GPS coordinates mapping to a confined area around soccer fields, their originator movement is limited to that same area, their audio signals show typical patterns like crowd cheering, referee whistle, etc., and that are of duration that's typical to soccer games such as 60 or 9 minutes). Any sessions that fit those descriptors are classified as relevant for the compilation of all girls soccer matches. In such a case, it may be possible to request the system to create, for example, a best-of soccer moments compilation for a given year.

For another example, if the theme is road biking in the Santa Cruz Mountains then the descriptors might include GPS in the Santa Cruz Mountains, 5-12 MPH up hill, 25-40 MPH downhill, constant routing, proximity to Points of Interest created by bicyclists, certain patterns in the accelerometer data, etc.

As another example, it is possible to request a compilation of the best moments spent skiing with a specific person (who is also a user of the system) during a week long ski vacation, e.g. by selecting times in the given week where the originator was in close proximity to the given person and the signal data was typical to skiing (occurred on ski runs, altimeter data spanning specific ranges, etc.)

In another example, it is possible to request an all times “best-of” compilation of “wipeout” while skiing by limiting to moment from the relevant activity type as demonstrated above, and choosing the highest scoring among those which exhibit accelerometer patterns indicative of a fall.

Descriptors that can be combined and weighted to determine the context that maps to a theme may include, but are not limited to, the following: activity type (e.g. deduced by learned “fingerprints” such as traveling on a trail that is usually only used for mountain biking or hiking at a speed that is too high for walking); roaming (whether the originator's movement is confined to a relatively small area, such as a playing field, or covers a larger area such as a bike ride); originator is an actor in the activity (versus a spectator deduced by means of the signals, signal amplitude/energy, etc.; “goal-oriented” activity (i.e. an activity that involves scoring goals, baskets, hits, etc. like soccer, baseball, basketball, football, water polo, etc. which may be deduced by location, voice signals, pixel histograms, etc.); indoors versus outdoors (deduced by location, voice signals, pixel histograms, etc.); location names and location type (using a GPS and a geographic database resource such as Google Places); time of day (accurate and/or binned: sunrise, morning, evening, sunset); brightness (bright/dark); contrast; color ranking (similar pixel color distribution); duration category (e.g., whether the activity performed is relatively short (<10 sec), medium (30 sec), long (>min)); moving (e.g., whether the sensor is on the originator or is stationary); recurring patterns in various sensor data, such as similarity in velocity distribution, locations traversed, etc.; shapes, objects; affordances (e.g., obtained using affordance analysis on video frames); group activity (proximity in time and location of other system users).

In one embodiment, all compilations, the highlights of the individual sessions are ranked by score, tagged by type, and selected by compilation interpreter 326. There are rules that can be set by a stakeholder (originator, intermediary, viewer) and enforced by compilation interpreter 326 that might alter the contents in the compilation highlight list. In some embodiments there are rules enforced that require representative highlights from each session be in the compilation. In other embodiments, the best highlights of sessions that would otherwise have no highlights in the compilation have their scores boosted so as to have a better chance of making the compilation. In other embodiments, there are rules that required or influence the inclusion of highlights at a representative frequency in time. For example, there might be a requirement that there be at least one highlight every five minutes. Thus, if there is a five minute period with no highlight in the compilation, compilation interpreter 326 would choose the best highlight that fulfills the requirement.

In some embodiments, the theme compilation master highlights lists are used by extractor 245 to create media clip data 260 which is in turn used by composter 265 to create summary movie data 280. In some embodiments, all the stakeholders (originator, intermediary, and viewer) can cause the creation of compilation and/or control the theme of the compilation. These compilations movies are presented to the viewer either in addition to or instead of the session movies. The embodiment of one user interface has a function that relates the sessions that contribute to the compilation associated with compilation, enabling the viewer to view some or all of the session movies as well.

If the settings and data access allow, compilations can include highlight lists and media from co-participants (see description below).

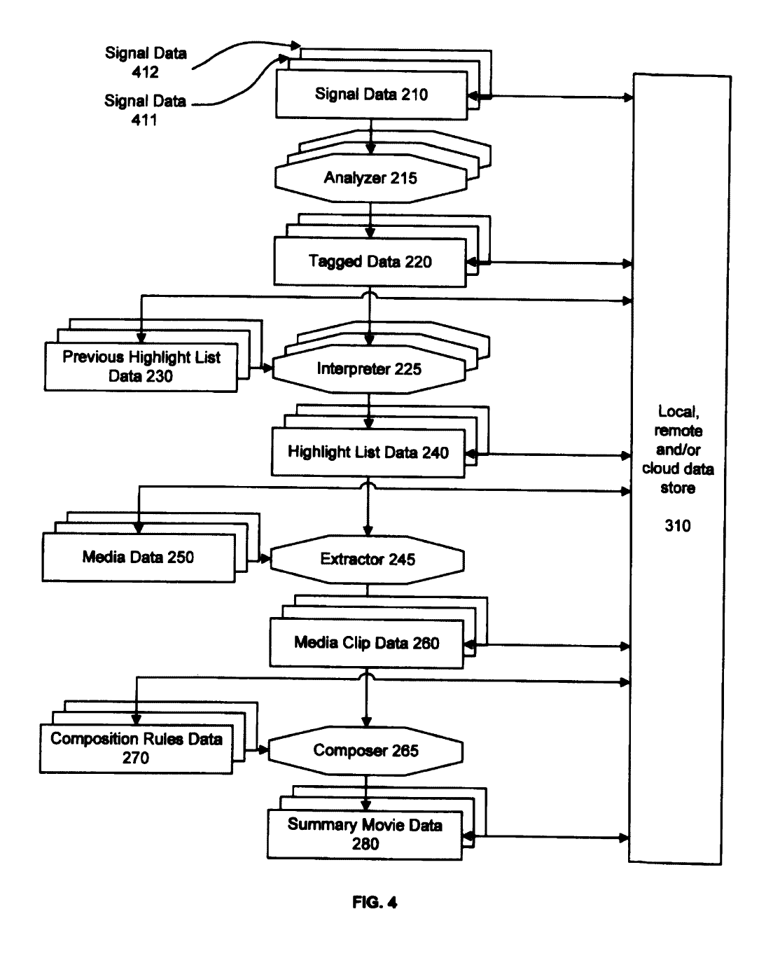

FIG. 4 is a flow diagram of such an embodiment of the process for creating a summary movie, a final-cut movie, or a compilation movie. The process is performed by processing logic that may comprise hardware (circuitry, dedicated logic, etc.), software (such as is run on a general purpose computer system or a dedicated machine), firmware, or a combination of the three.

Referring to FIG. 4, the processing flow uses multiple data sources for one, some, or all of the data that is used in the process of FIG. 2. For example, there may be multiple sources of signal data, including signal data 210, signal data 411, and signal data 412. In such a case, each set of signal data 210 has an analyzer 215 to generate tagged data 220 therefrom. Thus, multiple analyzers 215 are used in such cases.

Similarly, in one embodiment, multiple interpreters 225 generate multiple sets of highlight list data 240 based on multiple sets of previous highlight list data 230, extractor 245 extracts one or more sets of media clip data 260 from multiple sets of media data 250, and composer 265 generates multiple sets of summary movie data 280 from the multiple sets of media clip data 260 based on the multiple sets of composition rules data 270. Note that in this embodiment there is only one instance of extractor 245 and composer 265. In an alternative embodiment, there may be more than one instance of extractor 245 and/or composer 265.

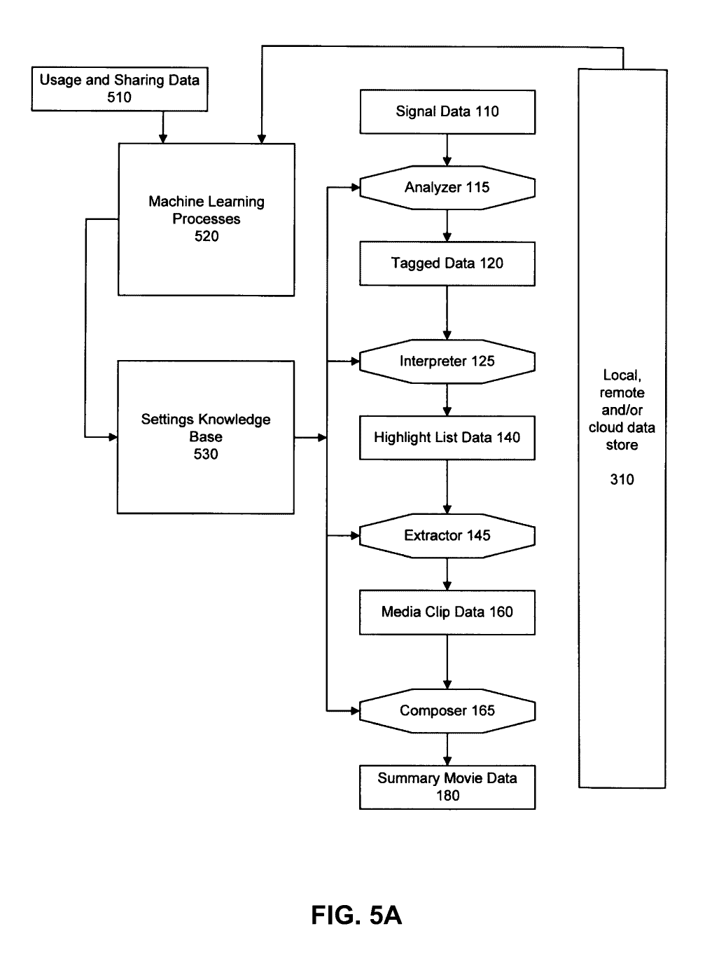

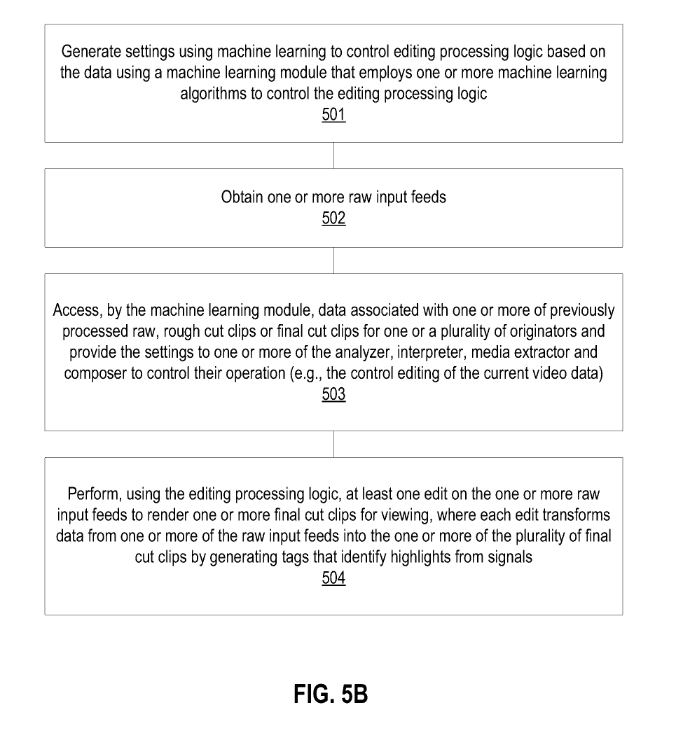

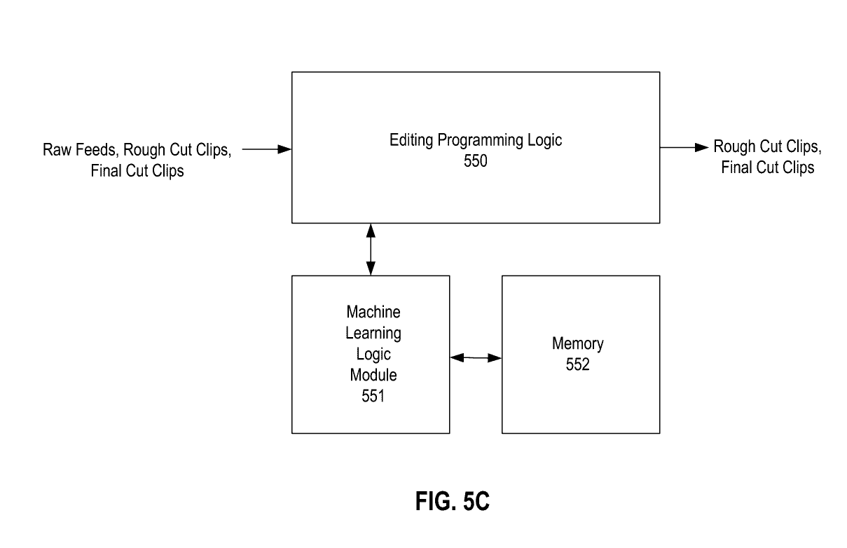

In many embodiments, the data processing is controlled, at least in part, by parameters that are derived from machine learning processes. FIG. 5A is a flow diagram showing an embodiment of machine learning processes interacting with the processes for creating tags, highlights, clips, and final-cut movies. The machine learning process is performed by processing logic that may comprise hardware (circuitry, dedicated logic, etc.), software (such as is run on a general purpose computer system or a dedicated machine), firmware, or a combination of the three.

The data processing and flow of FIG. 5 are the same as that of FIG. 3 and FIG. 4, except FIG. 5A includes machine learning (ML) 510 that has access to the data and provides controls (e.g., control signals) for one or more parts of the processing flow (runtime processes), such as, for example, analyzer 215, interpreter 225, extractor 245, and composer 265. Note that the data to data store connections and the multiplicity of data and processes are not shown for simplicity. Furthermore, in one embodiment, the data collected by the above processes includes usage and sharing data 510 which captures and stores analytical data such as, for example, manual tag signals, editing choices (see descriptions below), playback choices (e.g., number of times, frequency, how far into the movie, etc.), movie sharing (e.g., with whom, what was the receivers usage, etc.), and other data from the interaction with all the stakeholders (originator, intermediary, viewer) described below.

The role of the ML 520 is to assist the automated system in the processing of a single instance based on the learning that is accumulated from multiple prior instances.

Referring to FIG. 5A, ML 520 has access to all the data from the local, remote and/or cloud data store 310 for all users and data received from usage and sharing data 510 for all users. In one embodiment, usage and sharing data 510 includes information such as how the user viewed the data (e.g., number of times, frequency, how far into the movie, etc.) and information about the sharing of a movie (e.g., with whom, what was the receivers usage, etc.). ML 520 runs various machine learning processes on the data and creates settings, reference data, and other data that alter and bias the other processes (called runtime processes, see below). These settings and other data are stored in settings knowledge base 530. This is, a local, remote, and/or cloud database and/or file system that can be accessed by the runtime processes.

In one embodiment, the operation of ML 520 processes is run asynchronous to that of the other runtime processes. ML 520 processes run on data from more than one execution of any part of the runtime process pipeline. In certain embodiments, the machine learning operates using the data from many sets of signals, many master highlights lists, many rough-cut clips, and many final-cut movies. The settings from ML 520 processes update settings knowledge base 530 asynchronously with respect to the other runtime processes. In one embodiment, the Machine Learning process runs on one day's worth of data at night when the usage of the system (and all the client applications) is low. In some embodiments, ML 520 processes are run on a cloud computing resource with access to the data from usage and sharing data 510 and local, remote, and/or cloud data store 210 that has been uploaded from the local or remote memory to the cloud data store 210 at the time ML 520 runs.

Settings knowledge base 530 is a data repository for all the settings from ML 520. In one embodiment, settings knowledge base 530 is implemented as a database with an access Application Programmer's Interface (API) for the runtime processes to access the data. In one embodiment, settings knowledge base 530 is implemented in a file system to which the client processes have access. In one embodiment, settings knowledge base 530 is a mix of databases and files. Settings knowledge base 530 can be in a cloud resource, local (to the client) memory, and/or remote memory.

The runtime processes have routines for accessing settings knowledge base 530 periodically to acquire the appropriate settings. In one embodiment, the runtime processes access the settings knowledge base 530 before every run. In another embodiment, the runtime processes access settings knowledge base 530 every time the application is activated (e.g., when an app is launched). In one embodiment, the runtime processes have a caching scheme that allows the settings from settings knowledge base 530 to be acquired periodically and updated incrementally. The runtime processes can use different settings acquisition methods.

Settings knowledge base 530 are organized by individual, context, and group as well as global settings. That is, runtime processes can access the settings appropriate for a given individual user, a given user and a given activity type, or a given grouping of users and/or activity types. For example, an individual user processing a specific activity such as a bike ride in a certain place can benefit from settings based on that user's previous bike ride activity's in that place, from group's of other bicyclists in that place, from other bike ride activities in general of that user, from other bike ride activities in general, and all prior activities. The runtime processes can access the data and determine the priority and mixing of settings that are appropriate for the current activity run.

In many embodiments the individual settings are different for given stakeholders (originator, intermediary, viewer). Thus, with the same activity, signals, and media the final-cut movies can be different for the different stakeholders.

There are many types of settings affecting different functions and different processes. For example, in one embodiment, analyzer 115 process acquires settings that indicate locations that are points of interest on the earth (for specific user, a specific activity, a group of users, or all points of interest). Given these settings, analyzer 115 can determine from GPS data whether or not the activity was close to the point of interest and when. Analyzer 115 would create a tag and place it in tagged data 120. In another embodiment, analyzer 115 process acquires settings that indicate the preferred threshold for testing accelerometer signals to determine if there is a tag to create.

In another embodiment, interpreter 125 acquires settings that indicate what the time duration and offset of a highlight should be given a specific tag. For example, if an individual has shown a preference (via manual editing, multiple manual tagging, preferred watching or sharing of videos) for having a longer highlight that starts a little early when capturing a girl's soccer match. ML 520 has access to this data and, after running the machine learning processes, determines that this individual prefers a setting that dictates an 11 second highlight that starts eight seconds before the tag time. (In one embodiment, this same machine learning process will bias the settings of all girls' soccer highlights, groups of users which include this user, and the global settings.)

In another embodiment, extractor 145 acquires settings that indicate the resolution and/or bitrate and/or frame rate of the video clips to extract and transcode.

In another embodiment, composer 165 acquires settings that indicate which viewpoints (if multiple media and/or annotation exists) to use in making the final-cut movie. In another embodiment, composer 165 acquires settings that indicate which types of transitions and other animation or other editing to use when making the final-cut movie.

FIG. 5B is a flow diagram of one embodiment of a video editing process. The process is performed by processing logic that may comprise hardware (circuitry, dedicated logic, etc.), software (such as is run on a general purpose computer system or a dedicated machine), firmware, or a combination of these three.

Referring to FIG. 5B, the process begins by processing logic generating settings using machine learning to control editing processing logic based on the data using a machine learning module that employs one or more machine learning algorithms to control the editing processing logic (processing block 501). In one embodiment, the editing processing logic comprises one or more of: an analyzer to perform a signal processing process to tag portions of video data in response to signal processing, an interpreter to perform a highlight creation process to create a highlight list in response to the portions identified in the signal processing process, a media extractor to perform a media extraction process to extract media clip data from video data based on the highlight list from the highlight creation process, a composer to perform a movie creation process to create a final cut clip in response to extracted media clip data from the media extraction process.

In one embodiment, generating settings using machine learning to control editing processing logic comprises generating, using the machine learning module, at least one of the settings to the analyzer based on applying at least one of the one or more machine learning algorithms to signal data associated with an originator. In one embodiment, the signal data comprises data corresponding to at least one manual gesture of the originator.

In one embodiment, generating settings using machine learning to control editing processing logic comprises generating, using the machine learning module, at least one of the settings to the interpreter based on applying at least one of the one or more machine learning algorithms to data collected regarding previous edits made by one or more selected from a group consisting of an originator, an intermediary, and a viewer.

In one embodiment, generating settings using machine learning to control editing processing logic comprises generating, using the machine learning module, at least one of the settings to the interpreter based on applying at least one of the one or more machine learning algorithms to data collected regarding viewing information associated with viewing performed on raw, rough cut clips or final cut clips. In one embodiment, the viewing information includes at least one of data associated with an identity of one or individuals to raw, rough cut clips or final cut clips are shared and how far the video is viewed.

Processing logic obtains one or more raw input feeds (processing block 502)

In one embodiment, processing logic access, by the machine learning module, data associated with one or more of previously processed raw, rough cut clips or final cut clips for one or a plurality of originators and provides the settings to one or more of the analyzer, interpreter, media extractor and composer to control their operation (e.g., the control editing of the current video data) (processing block 503). In one embodiment, processing logic providing settings comprises communicating, by the machine learning module, settings to one or more distributed processes that include a signal processing process to tag portions of video data in response to signal processing, a highlight creation process to create a highlight list in response to the portions identified in the signal processing process, a media extraction process to extract media clip data from video data based on the highlight list from the highlight creation process, a movie creation process to create a final cut clip in response to extracted media clip data from the media extraction process.

Using the settings, processing logic performs, using the editing processing logic, at least one edit on the one or more raw input feeds to render one or more final cut clips for viewing, each edit to transform data from one or more of the raw input feeds into the one or more of the plurality of final cut clips by generating tags that identify highlights from signals (processing block 504).

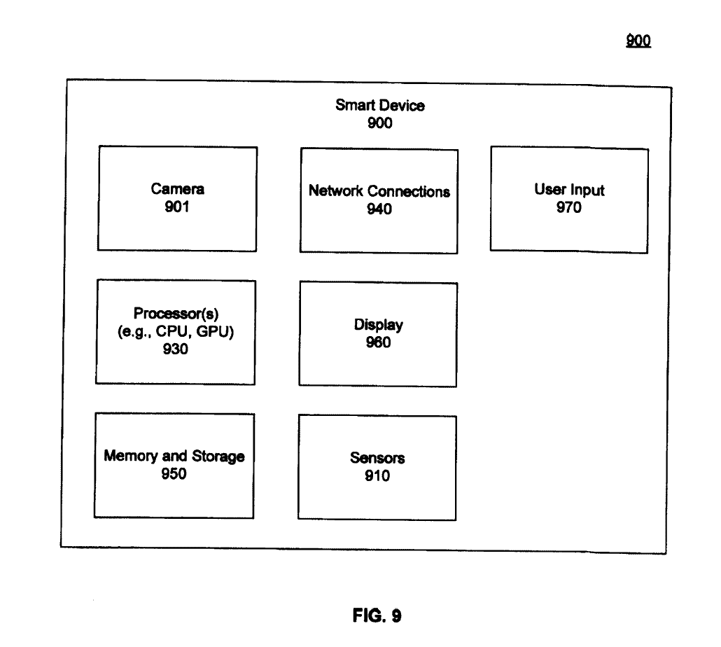

In one embodiment, machine learning method and operations described above are performed by a devices and systems, such as, for example, devices of FIGS. 9-12 and 18. FIG. 5C illustrates a block diagram of a video editing system that performs machine learning operations described herein. The blocks comprise hardware (circuitry, dedicated logic, etc.), software (such as is run on a general purpose computer system or a dedicated machine), firmware, or a combination of these three. Referring to FIG. 5C, the video editing system comprises editing processing logic 550 controllable to perform at least one edit on one or more raw input feeds to render one or more final cut clips for viewing, where each edit transforms data from one or more of the raw input feeds into the one or more of the plurality of final cut clips by generating tags that identify highlights from signals. The video editing system also comprises a machine learning logic module 551 that accesses data from memory 552 and generates settings to control the editing processing logic based on the data using one or more machine learning algorithms to control the editing processing logic.

In one embodiment, editing processing logic 550 comprises one or more of an analyzer to perform a signal processing process to tag portions of video data in response to signal processing, an interpreter to perform a highlight creation process to create a highlight list in response to the portions identified in the signal processing process, a media extractor to perform a media extraction process to extract media clip data from video data based on the highlight list from the highlight creation process, a composer to perform a movie creation process to create a final cut clip in response to extracted media clip data from the media extraction process, such as those described above; and machine learning logic 551 provides the settings to one or more of the analyzer, interpreter, media extractor and composer to control their operation. In one embodiment, memory 552 is local or remote with respect to the editing processing logic.

In one embodiment, machine learning logic 551 generates at least one of the settings to the analyzer based on applying at least one of the one or more machine learning algorithms to signal data associated with an originator. In another embodiment, machine learning logic 551 generates at least one of the settings to the interpreter based on applying at least one of the one or more machine learning algorithms to data collected regarding previous edits made by one or more selected from a group consisting of an originator, an intermediary, and a viewer. In yet another embodiment, machine learning logic 551 generates at least one of the settings to the interpreter based on applying at least one of the one or more machine learning algorithms to data collected regarding viewing information associated with viewing performed on raw, rough cut clips or final cut clips.

In one embodiment, the viewing information includes at least one of data associated with an identity of one or individuals to raw, rough cut clips or final cut clips are shared and how far the video is viewed.

In one embodiment, machine learning logic 551 accesses data associated with one or more of previously processed raw, rough cut clips or final cut clips for an originator and to generate settings to one or more of the analyzer, interpreter, media extractor and the composer to control editing of current video data. In one embodiment, machine learning logic 551 accesses data associated with one or more of previously processed raw, rough cut clips or final cut clips for a plurality of originators and to generate settings to one or more of the analyzer, interpreter, media extractor and the composer to control editing of current video data.

In one embodiment, machine learning logic 551 communicates settings to one or more distributed processes that include a signal processing process to tag portions of video data in response to signal processing, a highlight creation process to create a highlight list in response to the portions identified in the signal processing process, a media extraction process to extract media clip data from video data based on the highlight list from the highlight creation process, a movie creation process to create a final cut clip in response to extracted media clip data from the media extraction process.

In one embodiment, the signal data comprises data corresponding to at least one manual gesture of the originator.

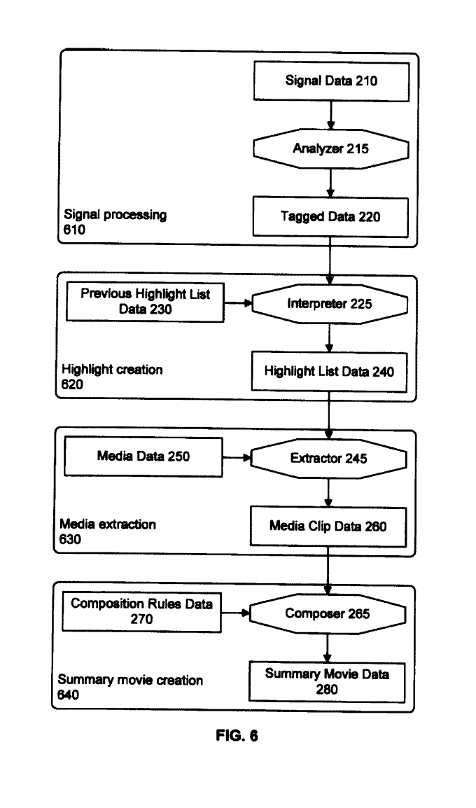

FIG. 6 illustrates subsets of processes performed in creating a single summary movie. Each may be run independently and one or more of the subsets (less than all) may be run together. Referring to FIG. 6, one subset of the processes is signal processing process 610, which includes analyzer 215 operating on signal data 210 to generated tagged data 220. Another subset of the processes is highlight creation process 620, which includes interpreter 225 operating on tagged data 220 based on previous highlight list data 230 to create highlight list data 240. Another subset of the processes includes media extraction process 630, which include extractor 245 operating based on highlight list data 240 to extract media data from media data 250 to create media clip data 260. Another subset of the processes includes summary movie creation process 640, which includes composer 265 operating on media clip data 260 based on composition rules data 270 to create summary movie data 280. As stated above, signal processing process 610, highlight creation process 620, media extraction process 630, and summary movie creation process 640 operate together to perform the entire processing flow from signal data processing to summary movie creation.

In one embodiment, signal processing process 610 and highlight creation process 620 operate together to generate highlights from signal data (without the other processes of FIG. 6). In another embodiment, highlight creation process 620 is run by itself (without the other processes of FIG. 6). For example, highlight creation process 620 may be run in the cloud to create highlights from multiple previous highlight lists. In another embodiment, highlight creation process 620 and media extraction process 630 operate together (without the other processes of FIG. 6). For example, highlight creation process 620 and media extraction process 630 may run as part of an application on an end user device (e.g., a smart phone) to create media clips from tagged data. In another embodiment, the highlight creation process 620 and media extraction process 630 operate together and are run twice: first to create rough-cut media clip data 260 and a second time to create final-cut media clip data 260. In another embodiment, media extraction process 630 operates by itself (without the other processes of FIG. 6). For example, media extraction process 630 may run on a client PC to extract media clips from media data based on highlight list data. In another embodiment, summary movie creation process 640 is run by itself (without the other processes of FIG. 6). For example, summary movie creation process 640 may compose a summary movie from media clips and a highlight list on a client PC.

Also, any of the processes 610, 620, 630, and 640, or subsets of these processes, can be performed on the client device that captures the signals or the media (e.g., a smart phone), client personal computer, and/or at a remote location (e.g., in the cloud). These processes can be distributed across a these devices and computers.

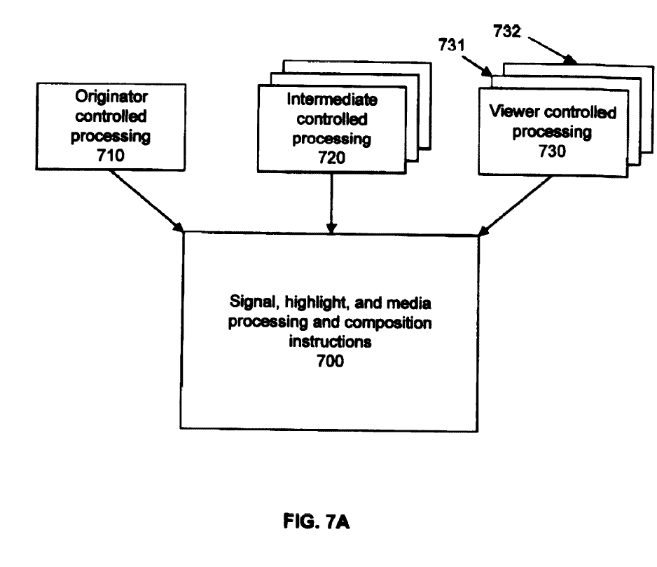

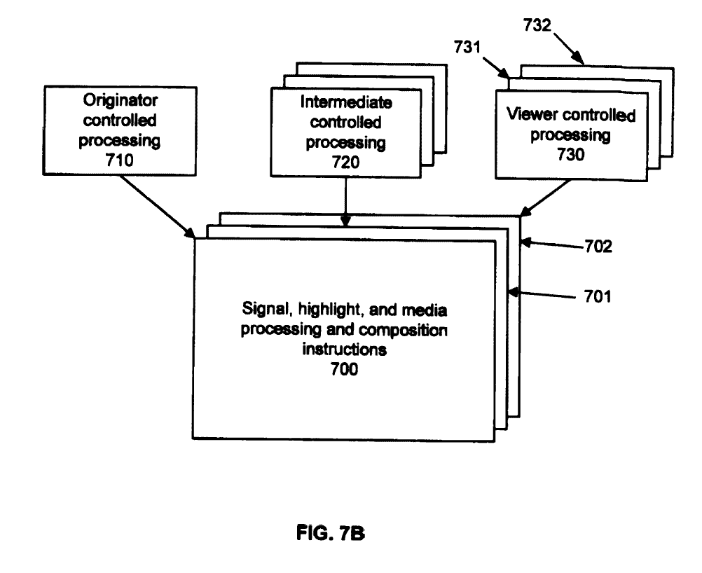

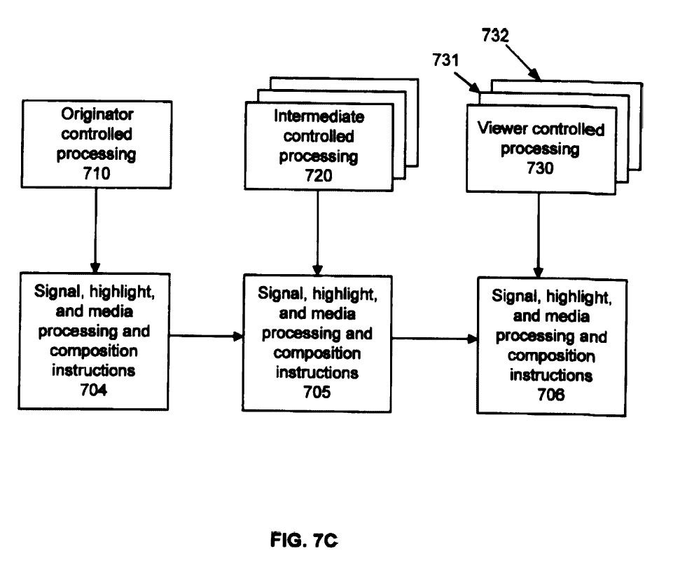

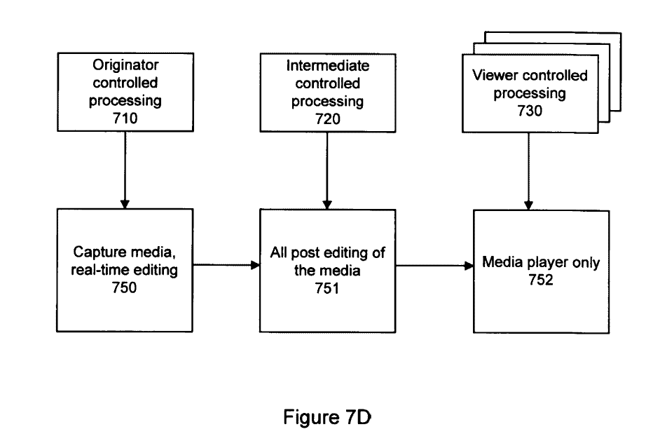

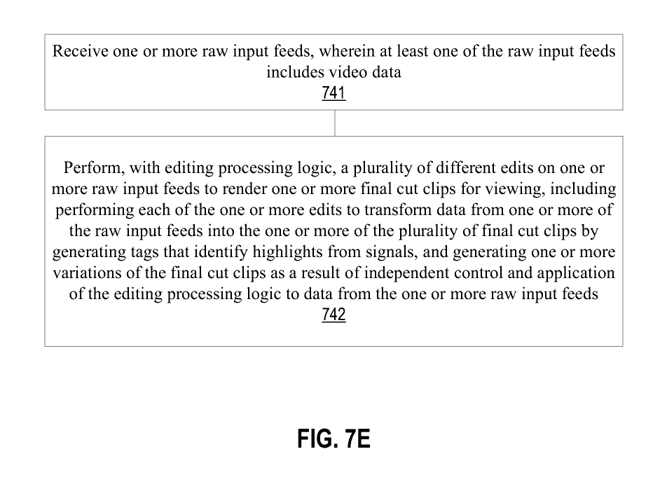

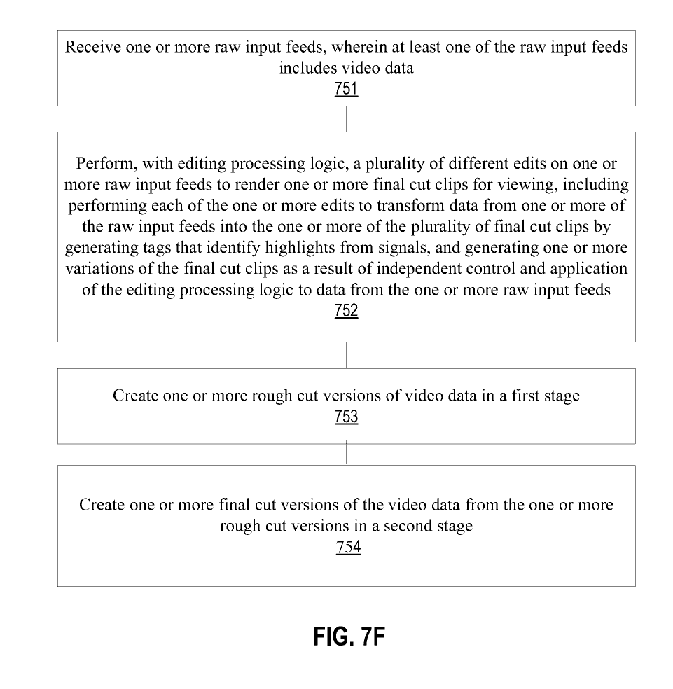

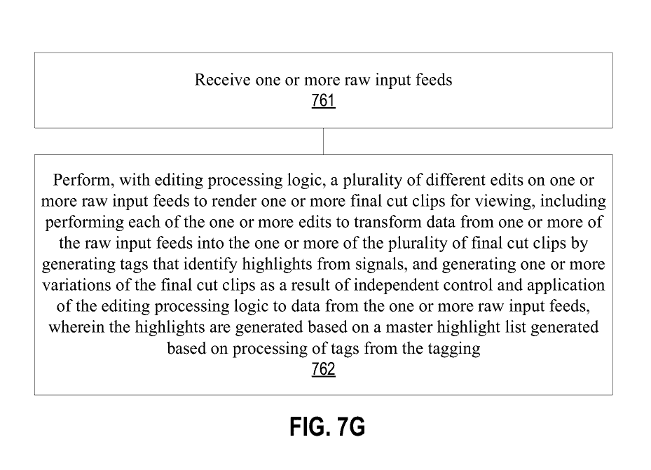

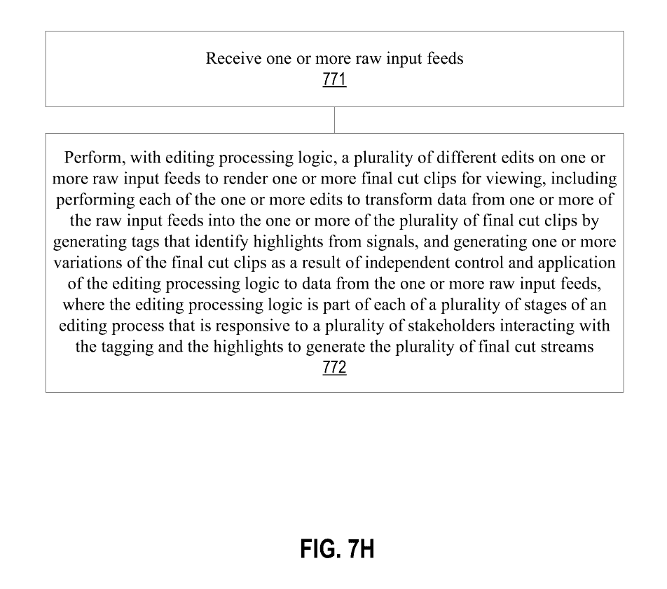

FIGS. 7A-D illustrates the players, or stakeholders, in the real-time video capture, highlighting, editing, storage, sharing and viewing system that may control the data processing flows depicted in FIGS. 1A, 1B, and 2-6.

Referring to FIG. 7A, there are three stakeholders in the process of transforming the raw image into the final-cut: originator 710 (e.g., the photographer or the director), intermediary 720 (e.g., editor, systematic editor such as, for example, a cloud sharing site, media provider), and viewer 730. In current art, as depicted in FIG. 7D, originator 710 shoots the video, intermediary 720 edits the video, and viewer 730 views the video. This is true for commercial theatre movies to movies uploaded to social media and video sharing sites. Existing art generates a monolithic static video, which does not take into consideration the various possible viewers and their preferences, or provides the ability for intermediary 720 to provide data according to a variety of criteria. According to one embodiment, each of the three stakeholders can assume the three roles, and in particular the role of the editor. Note that an individual (or system element) can behave as more than one stakeholder. For example, the originator can also perform as the intermediary and the viewer of a movie.

In one embodiment, each of these stakeholders controls processing (700) of signals, highlights, and media using composition instructions. This processing includes the editing process. According to one embodiment, all three stakeholders, originator 710, intermediate 720 and viewer 730, can each determine the parameters (700) in which the video will be edited to generate either the rough-cut (first pass editing or accumulation of clips from the raw video) or the final-cut (creation of the movie to be viewed from either the raw or rough-cut video). By allowing this open system architecture, it is possible for multiple final-cut videos to be generated from a single rough-cut according to the needs and preferences of the three stakeholders.

FIG. 7A illustrates one embodiment in which all three stakeholders can access or control a single editing process (or processor) 700. Referring to FIG. 7A, in this embodiment, the stakeholders interact with a single set of instructions that control the editing process 700 all the way from raw data to final-cut. There could be one or more sets of resources (e.g., processors, storage, network, UI, etc.) that execute the editing process and these resources can be collocated or distributed.

FIG. 7B illustrates another embodiment in which each of the individual stakeholders can interact with a set of instructions unique to that stakeholder. Each of these stakeholders could potentially produce one or more unique final-cut movies. In another embodiment, the above embodiments are combined by having some stakeholders share an instruction set and another or a group of others having their own.

FIG. 7C illustrates yet another embodiment in which each of the stakeholders in order can either fix or provide a predetermined range of instructions and/or rough-cut media for the succeeding stakeholders to manipulate. This limits, but does not prohibit, successive stakeholders editing possibilities.

Based on the above, not only the originator or the intermediary determines the final-cut but also the viewer. Moreover, by doing so, the same rough-cut provided by the originator or the intermediary can generate different final-cut for different users (e.g., users 730, 731, and 732), or even different final cuts based on different time, or even dynamic final cuts that may change randomly.

In one example, the stakeholders can determine the length of the video, or select other criteria such as specific content, people, time of the event, or type of activity. By doing so, the same rough-cut media provided by the originator or the intermediary can generate different final-cut for different users 730, 731, and 732. Such decisions can be done either offline or even on-the-fly by the viewer using an interactive interface and a real-time interpreter or transcoder of the instruction set.

In another embodiment, one or some of the stakeholders can lock specific segments, or parts of the editing process, that viewers may not modify, or can only modify within a pre-determined range. For example, there may be a fixed overall length that the movie cannot be less (or greater than). This may be an example of a paid system where free use will be limited to certain length of clips while a paid subscription will be unrestricted. In yet another example, there may be specific events, locations, or time that must be included in the final-cut. This may be used to lock in commercial (e.g., an advertisement) time into video clips, or specific messaging that the service may want to maintain. By doing so, the originator or the editor can “lock” some of the parameters while allowing others to be determined later on by the intermediate, and consequently, the intermediate can lock other parameters and allow the viewer.

As an example, the originator can commit changes that generate a rough-cut from the raw-image as described in FIG. 1A. By committing, it is to the originator's discretion whether the information excluded between the raw and the rough-cut will be permanently discarded or not. Similarly, the originator can also limit the total size of the rough-cut, or select only areas of specific interest, reformat the video, or resample it. The decision as to whether such restrictions are permanent or not can be determined by the system. In yet another embodiment, the originator may provide a complimentary “preview” and allow for more time if the viewer pays.

In yet another example, different users may become intermediaries and offer their “edit list” to others. For example, user 730 may generate a final-cut commands 703 which can be then used as a rough-cut for user 731 that may generate her own editing list.

In yet another embodiment, the intermediate or the viewer can include information onto the list that may be derived from external sources such as other users, to create its unique editing list 710 and 720 correspondingly. For example, certain viewers may belong to a group in which other users may allow the usage of videos (participant sharing). For example, a group of people all participating in the same sporting events may share such data between them. That is, the signal data, highlight data, and media data is sourced from many places where, for example, an activity is recorded by two separate participants, each generating signals, highlights, and media. The system can be instructed to combine these sources, either explicitly by one of the originators or other stakeholders or via an automated system that detects the relevance.

In one embodiment, portions or all of the video taken by one user (e.g., raw video, a rough-cut video, a final-cut video) may be combined with portions or all of a second (or more videos (e.g., raw video, a rough-cut video, a final-cut video). The second video is generated by another participant capturing the same activity. In another example, the second video may be generated by capturing another activity, such as, an activity that shows a similar location to one in the first movie, or an activity that is thematically related to the first one. Use of content from other participants' video may be useful to augment the stakeholders' video. This may be the case in situations in which one or more other participants capture a better view of an activity. For example, while a first individual may not be part of the video they are creating (because they are not in their camera's view), a second individual recording the same activity may record the first individual during the activity. This second video could alternatively be a different version of the raw or rough-cut video associated with the video of the first individual. For example, the second video may be a video created by a different viewer of the first video that tagged the video in a different way.

In one embodiment, the stakeholder's editing and processing of a video is controlled and influenced by the machine learning knowledge bases of FIG. 5. In one embodiment, these settings alone create results that differ between the stakeholders.

FIG. 7E is a flow diagram of one embodiment of a video editing process. The process is performed by processing logic that may comprise hardware (circuitry, dedicated logic, etc.), software (such as is run on a general purpose computer system or a dedicated machine), firmware, or a combination of these three.

Referring to FIG. 7E, the process begins by processing logic receiving one or more raw input feeds, wherein at least one of the raw input feeds includes video data (processing block 741).

Using the one or more raw input feeds, processing logic performs, with editing processing logic, a plurality of different edits on one or more raw input feeds to render one or more final cut clips for viewing, including performing each of the one or more edits to transform data from one or more of the raw input feeds into the one or more of the plurality of final cut clips by generating tags that identify highlights from signals, and generating one or more variations of the final cut clips as a result of independent control and application of the editing processing logic to data from the one or more raw input feeds (processing block 742).

In one embodiment, performing the plurality of edits with the editing processing logic is non-destructive to the raw input feeds. In one embodiment, the highlights are based on a highlight list. In one embodiment, the independent control and application of the editing processing logic is responsive to access of the editing processing logic by one or more stakeholders.

In one embodiment, generating tags comprises tagging portions of video data in response to signal processing. In one embodiment, performing each of the one or more edits to transform data from one or more of the raw input feeds into the one or more of the plurality of final cut clips includes creating a highlight list. In one embodiment, performing each of the one or more edits to transform data from one or more of the raw input feeds into the one or more of the plurality of final cut clips extracting media clip data from video data based on the highlight list from the highlight creation stage and creating a final cut clip in response to extracted media clip data.

In one embodiment, generating tags comprises automatically generating at least a portion of the tagging using sensors. In one embodiment, generating tags comprises generating the tagging in a video capture device as part of recording the raw material. In another embodiment, generating tags comprises generating the tagging in an external device that is synchronized with the video capture device and stored with the raw material.

In one embodiment, at least a portion of the tagging is manually generated by one or more stakeholders. In one embodiment, the tagging includes a plurality of tags having different priorities with respect to editing based on editing settings associated with stakeholders that created at least one of the plurality of tags. In one embodiment, at least a portion of the tagging is based on machine learning. In one embodiment, at least a portion of the tagging is based on habit learning.

FIG. 7F is a flow diagram of one embodiment of a video editing process. The process is performed by processing logic that may comprise hardware (circuitry, dedicated logic, etc.), software (such as is run on a general purpose computer system or a dedicated machine), firmware, or a combination of these three.

Referring to FIG. 7F, the process begins by processing logic receiving one or more raw input feeds, wherein at least one of the raw input feeds includes video data (processing block 751).

Using the one or more raw input feeds, processing logic performs, with editing processing logic, a plurality of different edits on one or more raw input feeds to render one or more final cut clips for viewing, including performing each of the one or more edits to transform data from one or more of the raw input feeds into the one or more of the plurality of final cut clips by generating tags that identify highlights from signals, and generating one or more variations of the final cut clips as a result of independent control and application of the editing processing logic to data from the one or more raw input feeds (processing block 752).

In response to the plurality of different edits, processing logic creates one or more rough cut versions of video data in a first stage (processing block 753) and creates one or more final cut versions of the video data from the one or more rough cut versions in a second stage (processing block 754).

In one embodiment, tags and a master highlight list are associated with at least one rough cut version.

In one embodiment, at least one of the one or more rough-cut versions is created from raw video data based on one version of a highlight list and one set of editing parameters from interaction by at least one stakeholder. In another embodiment, at least one of the one or more final-cut versions is created from raw video data based on one version of a highlight list and one set of editing parameters from interaction by at least one stakeholder. In another embodiment, at least one of the one or more final-cut versions is created from one rough-cut version based on one version of a highlight list and one set of editing parameters from interaction by at least one stakeholder.

In one embodiment, the edits generate multiple instantiations of both rough cut versions and final cut versions of the video data based on multiple instantiations of a highlight list generated via tagging. In one embodiment, the edits generate multiple final cut versions from a single rough-cut version according to preferences of different stakeholders. In another embodiment, the edits generate multiple final cut versions from a signal rough-cut version according to a combination of preferences of two or more stakeholders.

FIG. 7G is a flow diagram of one embodiment of a video editing process. The process is performed by processing logic that may comprise hardware (circuitry, dedicated logic, etc.), software (such as is run on a general purpose computer system or a dedicated machine), firmware, or a combination of these three.

Referring to FIG. 7G, the process begins by processing logic receiving one or more raw input feeds (processing block 761).

Using the one or more raw input feeds, processing logic performs, with editing processing logic, a plurality of different edits on one or more raw input feeds to render one or more final cut clips for viewing, including performing each of the one or more edits to transform data from one or more of the raw input feeds into the one or more of the plurality of final cut clips by generating tags that identify highlights from signals, and generating one or more variations of the final cut clips as a result of independent control and application of the editing processing logic to data from the one or more raw input feeds, wherein the highlights are generated based on a master highlight list generated based on processing of tags from the tagging (processing block 762).

In one embodiment, the master highlight list is generated by analyzing the tags and creating a correspondence between each of the tags and a portion of a raw input stream. In one embodiment, the master highlight list is generated by defining a beginning and an end of a highlight given a point in time and context of a tag, and creating a list of highlights for use in editing raw or rough input streams in non-real-time. In one embodiment, the master highlight list is generated based on results from a machine learning system. In one embodiment, the master highlight list is generated based on stakeholder preferences. In one embodiment, the master highlight list is generated based on analysis of a contextual environment in which a video was tagged.

FIG. 7H is a flow diagram of one embodiment of a video editing process. The process is performed by processing logic that may comprise hardware (circuitry, dedicated logic, etc.), software (such as is run on a general purpose computer system or a dedicated machine), firmware, or a combination of these three.

Referring to FIG. 7H, the process begins by processing logic receiving one or more raw input feeds (processing block 771).

Using the one or more raw input feeds, processing logic performs, with editing processing logic, a plurality of different edits on one or more raw input feeds to render one or more final cut clips for viewing, including performing each of the one or more edits to transform data from one or more of the raw input feeds into the one or more of the plurality of final cut clips by generating tags that identify highlights from signals, and generating one or more variations of the final cut clips as a result of independent control and application of the editing processing logic to data from the one or more raw input feeds, where the editing processing logic is part of each of a plurality of stages of an editing process that is responsive to a plurality of stakeholders interacting with the tagging and the highlights to generate the plurality of final cut streams (processing block 772).

In one embodiment, at least one of the stakeholders in the plurality of stakeholders has one or more roles including an originator associated with capture of the raw video data, an intermediary that creates one or more of rough cut and final cut versions, and a viewer that views at least one version of the video data. In one embodiment, one of the plurality of stakeholders has more than one of the roles. In one embodiment, at least one stakeholder interacts with the editing process as an originator, an intermediary and a viewer. In one embodiment, all stakeholders in the plurality of stakeholders interact with a single set of instructions to specify a single set of edit parameters to that control an editing process performed at least in part by the editing processing logic from raw video data to one final cut version.

In one embodiment, each stakeholder in the plurality of stakeholders interacts with the instructions separately to specify different edit parameters for each stakeholder to that control an editing process performed at least in part by the editing processing logic to generate different multiple final cut versions from the raw video data. In one embodiment, each stakeholder in the plurality of stakeholders interacts with the instructions in a cascaded manner to affect edit parameters to control an editing process performed at least in part by the editing processing logic to transform raw video data to at least one final cut version.

In one embodiment, one or more of the stakeholders generate instructions that cannot be overridden by another stakeholder. In one embodiment, the instructions specify length, resolution, quality, individual segments, order of a final cut clip.

In one embodiment, video editing process of FIGS. 7E-7H and their associated operations described above are performed by a devices and systems, such as, for example, devices of FIGS. 7A-C and 18. FIG. 7I illustrates a block diagram of a video editing system that performs multi-stakeholder operations described herein. The blocks comprise hardware (circuitry, dedicated logic, etc.), software (such as is run on a general purpose computer system or a dedicated machine), firmware, or a combination of these three.

Referring to FIG. 7I, the video editing system comprises editing processing logic 780 controllable to perform at least one edit on one or more raw input feeds to render one or more final cut clips for viewing, where each edit transforms data from one or more of the raw input feeds into the one or more of the plurality of final cut clips by generating tags that identify highlights from signals and generating one or more variations of the final cut clips as a result of independent control and application of the editing processing logic to data from the one or more raw input feeds.

In one embodiment, the application of the editing processing logic is non-destructive to the raw input feeds. In another embodiment, the application of the editing processing logic is altered and executed a plurality of times to create the plurality of final cut clips.

In one embodiment, the independent control and application of the editing processing logic is responsive to access of the editing processing logic by one or more stakeholders. In another embodiment, the editing processing logic allows each of a plurality of stakeholders to perform one or more of creating, editing and viewing of video data, or one or more rough cut and final cut versions thereof.

In one embodiment, the editing processing logic comprises a plurality of stages. In one such embodiment, at least one of the plurality of stages includes a signal processing process to tag portions of video data in response to signal processing. In another such embodiment, at least one of the plurality of stages includes a highlight creation process to create a highlight list in response to the portions identified in the signal processing stage. In yet another such embodiment, at least one of the plurality of stages includes a media extraction process to extract media clip data from video data based on the highlight list from the highlight creation stage and a movie creation process to create a final cut clip in response to extracted media clip data from the media extraction stage.

In one embodiment, at least a portion of the tagging is automatically generated using sensors. In one such embodiment, the tagging is generated in a video capture device as part of recording the raw material. In another such embodiment, the tagging is generated in an external device that is synchronized with the video capture device and stored with the raw material. In yet another embodiment, at least a portion of the tagging is manually generated by one or more stakeholders.

In one embodiment, the tagging includes a plurality of tags having different priorities with respect to editing based on editing settings associated with stakeholders that created at least one of the plurality of tags. In one embodiment, at least a portion of the tagging is based on machine learning. In one embodiment, at least a portion of the tagging is based on habit learning.

In one embodiment, the highlights are based on a highlight list.

In one embodiment, at least one of the raw input feeds includes video data and the editing processing logic comprises a plurality of stages, and further wherein the plurality of stages includes a first stage to create one or more rough cut versions of video data and a second stage to create one or more final cut versions of the video data from the one or more rough cut versions. In one embodiment, the plurality of stages further includes an intermediary rough cut stage that assembles video data segments associated with highlights into a continuous clip. In such a case, in one embodiment, material included in the raw cut and that is not part of the rough cut version is permanently discarded. In one embodiment, tags and a master highlight list are associated with at least one rough cut version. In one embodiment, at least one of the one or more rough-cut versions is created from raw video data based on one version of a highlight list and one set of editing parameters from interaction by at least one stakeholder.

In one embodiment, at least one of the one or more final-cut versions is created from raw video data based on one version of a highlight list and one set of editing parameters from interaction by at least one stakeholder. In one embodiment, at least one of the one or more final-cut versions is created from one rough-cut version based on one version of a highlight list and one set of editing parameters from interaction by at least one stakeholder.

In one embodiment, the editing process generates multiple instantiations of both rough cut versions and final cut versions of the video data based on multiple instantiations of a highlight list generated via tagging. In one embodiment, the editing process generates multiple final cut versions from a single rough-cut version according to preferences of different stakeholders. In one embodiment, the editing process generates multiple final cut versions from a signal rough-cut version according to a combination of preferences of two or more stakeholders.

In one embodiment, the highlights are generated based on a master highlight list generated based on processing of tags from the tagging. In one embodiment, the master highlight list is generated by analyzing the tags and creating a correspondence between each of the tags and a portion of a raw input stream. In another embodiment, the master highlight list is generated by defining a beginning and an end of a highlight given a point in time and context of a tag, and creating a list of highlights for use in editing raw or rough input streams in non-real-time. In other embodiments, the master highlight list is generated based on results from a machine learning system, is generated based on stakeholder preferences, and/or based on analysis of a contextual environment in which a video was tagged.

In one embodiment, the editing processing logic is part of each of a plurality of stages of an editing process that is responsive to a plurality of stakeholders interacting with the tagging and the highlights to generate the plurality of final cut streams. In one embodiment, at least one of the stakeholders in the plurality of stakeholders has one or more roles including an originator associated with capture of the raw video data, an intermediary that creates one or more of rough cut and final cut versions, and a viewer that views at least one version of the video data. In one embodiment, one of the plurality of stakeholders has more than one of the roles. In one embodiment, at least one stakeholder interacts with the editing process as an originator, an intermediary and a viewer. In one embodiment, all stakeholders in the plurality of stakeholders interact with a single set of instructions to specify a single set of edit parameters to that control an editing process performed at least in part by the editing processing logic from raw video data to one final cut version. Each stakeholder in the plurality of stakeholders may interacts with the instructions separately to specify different edit parameters for each stakeholder to that control an editing process performed at least in part by the editing processing logic to generate different multiple final cut versions from the raw video data. Alternatively, each stakeholder in the plurality of stakeholders may interact with the instructions in a cascaded manner to affect edit parameters to control an editing process performed at least in part by the editing processing logic to transform raw video data to at least one final cut version. In one embodiment, one or more of the stakeholders generate instructions that cannot be overridden by another stakeholder. In such a case, in one embodiment, the instructions specify length, resolution, quality, individual segments, and/or order of a final cut clip.

### Participant Sharing

Participant sharing enables the use of media and signals from multiple sources (e.g., other originators, cameras, sensors from different vantage points, etc.). In some embodiments, the integration and use of participant media and signals is automatic. In other embodiments, the use is directed by stakeholder's editing instructions.

There are several ways that the existence of participant media and signals are determined. In some embodiments, the time and GPS location signals of the originator and many potential participants are compared. Participants (or co-participants) are determined based on the relative proximity in both time and location in general for an activity. In one embodiment, further refinement is achieved by considering the time and location of potential participants relative to specific identified highlights from the originator's signals.

Additionally, in some embodiments, other signals and contexts are used to create descriptors of activities and highlights, and these descriptors are compared to determine who is also a participant. Thus, participants can be coincident in time and/or location and/or coincident in activity.

In one embodiment the determination of who is a participant is based on social network proximity, both formal, e.g. Facebook friends, and informal, e.g. users who have previously shared final cut movies or participant content previously. In some embodiments, other contextual data is used list address books of the user, calendar information, and so on.

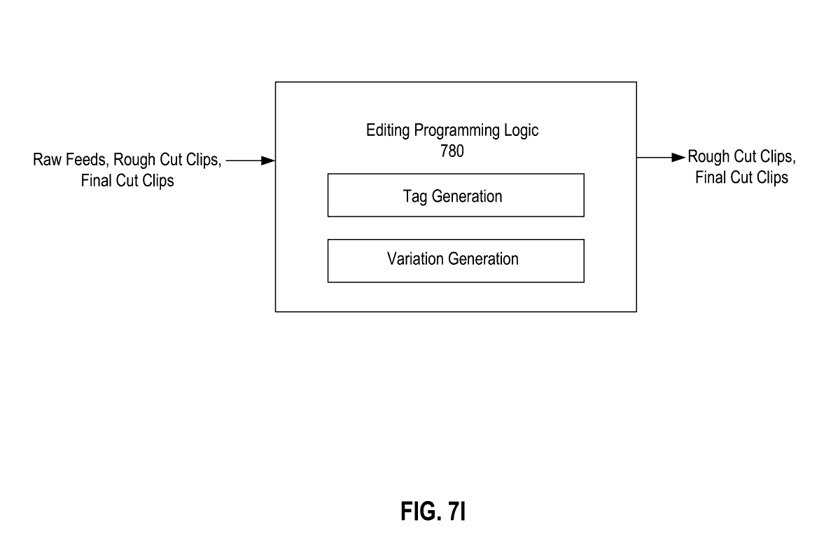

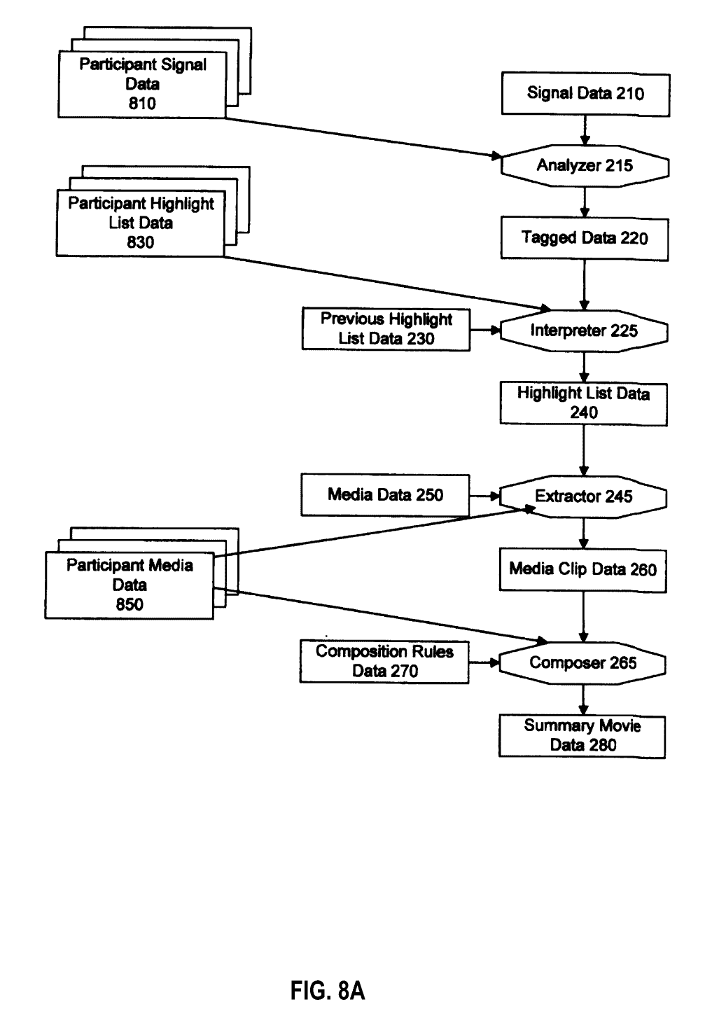

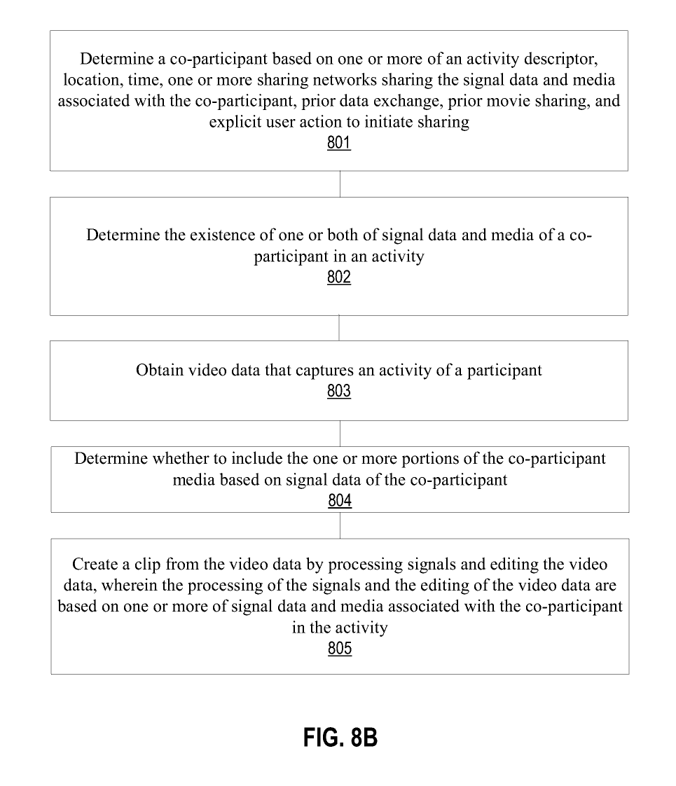

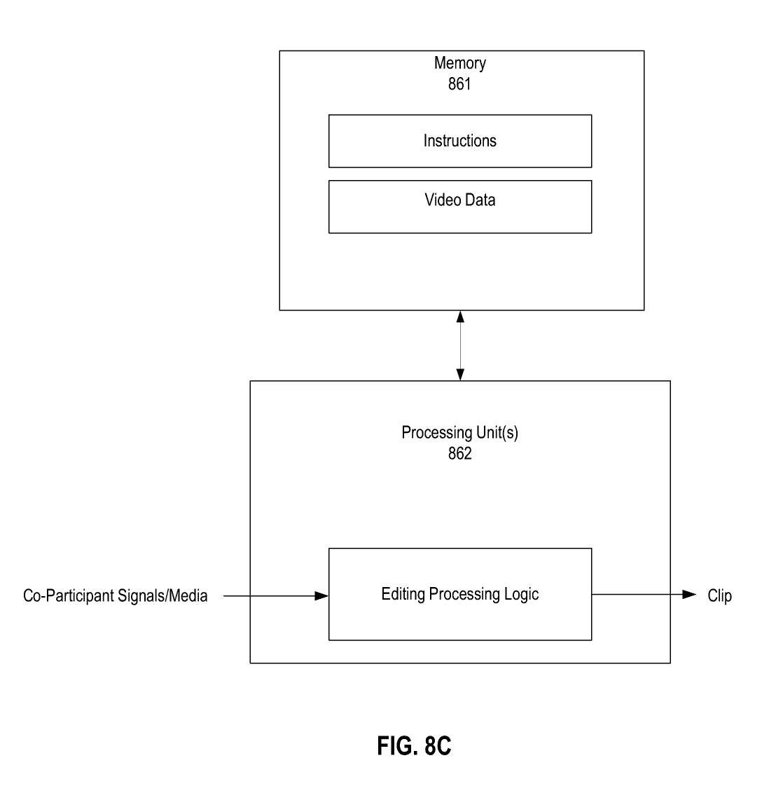

Once the participants are identified, there are several different ways of how the signals and media are used. FIG. 8A illustrates embodiments of the process for creating a summary movie with the previously described system and apparatus that involves participant sharing. The process is performed by processing logic that may comprise hardware (circuitry, dedicated logic, etc.), software (such as is run on a general purpose computer system or a dedicated machine), firmware, or a combination of the three.

The data processing and flow of FIG. 8A are the same as that of FIG. 2, except FIG. 8 includes multiple sets of participant data being used to control one or more of the processing functions of analyzer 115, interpreter 125, extractor 145, and composer 165.

Specifically, referring to FIG. 8, analyzer 115 can process the signals from originator 110 as well as signals from other relevant participants 810. Independently, interpreter 125 can process tagged data 120 from analyzer 115 as well as previous highlights 130 and other relevant participant highlights 830. In one embodiment, the highlights of other relevant participants 310 are additive to the highlights of originator 100. And, once again independently of the above processes, extractor 145 and/or composer 165 can access media data 150 and media clip data 160 as well as participant media data 850.

In one embodiment, once a participant has been identified, only the media is used to supplement the stakeholder's final cut. Using the highlights determined with only the originator's signals, clips are extracted from the participant's media and used in the final cut. In one embodiment, participant signals are used to determine whether the participant media is worthy of inclusion. In one embodiment, the participant signals determine the camera orientation suggesting whether or not the right scene was captured. For example, if the originator were snowboarding together, did the participant's camera capture the originator performing that amazing trick? In some embodiments, the participant signals determine whether the media is of sufficient quality, or better than the originator's media, for a highlight. For example, was the image stable (rather than shaky)? Is the contrast correct? Is the audio usable? Is the focus stable? The signals can be used to make the determination.

In one embodiment, only the participant's signals are used to supplement the stakeholder's movie. In some embodiments, the signals are used as “tie-breakers.” If the originator's signal or combination of signals are ambiguous or near the threshold of creating a highlight, the participant's signals are used to determine whether the tag is above or below threshold. In such an embodiment, select signals from the participant are used only around the times and/or locations of a potential tag that has been identified (marginally) by the originator's signals. For example, two bicyclists descend down a mountain pass. Both are recording acceleration in the turns that suggest potential highlights. One bicyclist (the originator for this example) goes slower than the other and the acceleration in one major turn is marginal. However, the faster bicyclist (the participant or co-participant in this example) nails the turn creating unambiguous acceleration signals. The originator's system uses the participant's signals to determine that the turn in question is above threshold and is a highlight.

In one embodiment, the participant's signals are used to create different highlights than those created by the originator's signals. The signals are processed in the same way and the resulting highlights are included in the master highlight list. The highlights include a score just like the originator's highlights. These highlights also include data that indicates the origin (participant) of the signals. There are many different embodiments for using these highlights. In one embodiment, the participant highlights are used just like originator's highlights. In one embodiment, the participant highlights have to score higher to be included. In one embodiment, the participant highlights are used if they contribute to better story telling (e.g. supplement beginning, end, or filler of a story that would be arbitrarily picked otherwise). In one embodiment, the participant highlights are used to include media from the originator. In one embodiment, the participant highlights are used to include media from the participant.

In one embodiment, participant signals are used to ensure the quality and accuracy of the media selected. As mentioned above, participant signals are used to determine if the stability, exposure, focus, etc. of the participant media is acceptable. In one embodiment, the participant signals are used to align the direction of the composed frames, timing of the transitions and cuts, and precise location of the media capture.

In many embodiments, both participant signals and media are used.

In one embodiment, the stakeholder's editing and processing of a video is influenced by a co-participant signal and media data. In one embodiment, the different relationship and access between specific stakeholders and co-participants and co-participant data can create results that differ between the stakeholders. Thus, a final-cut summary movie can be made by a stakeholder using participant sharing. A participant can be an originator for his or her own movies and can be an intermediary and/or viewer for a fellow participant's movie.

In one embodiment, participant sharing can be a paid feature of the system.

In yet another embodiment, the originator may license stock videos that may be incorporated by the viewers either as complimentary or for a fee.

Thus, in various embodiments, the originator (e.g., photographer), an intermediary system (e.g., an editor), and/or the viewer are able to access different versions of the video and create new versions of the video. These new versions may be stored and/or shared for subsequent viewing and/or editing.

Sharing and gaining access to other videos may be useful to include video content from systems that capture paid shots or to replace clips in highlight reels with higher definition video clips from other sources. This is also useful for proximity and direction based integration. This occurs when two participants “see” each other, and the video stream tags this information. For example, if the originator crosses the finish line in a century ride, the system may offer a video segment captured by bystander that is also a user of the system standing by the finish line at the time the originator was crossing it, and who's camera was oriented such that it may have captured the originator crossing. As another example, in case of a home run in a baseball game, the system may select video from multiple cameras used by multiple people based on their location and orientation to create a “bullet time” like effect around the moment of the hit. When video is subsequently edited, the segments with the other participant are saved even if not used in the final video. The saved segments are uploaded (as a separate stream or as part of the same stream to another storage system. On the storage system, such collaboration between videos can be made to create a multi-view image.

Note that these other video sources may be used to enable access to multiple sources of video during editing. For example, these video sources can be used to obtain content of a particular individual when making a personal (e.g., vanity) video or a video in which that individual is surrounded by others.

In one embodiment, the initiator's system can use any participant signals and media that are made available to it. Embodiments employ these signals and systems in different ways. However, in one embodiment, the initiator (and other stakeholders) can limit the distribution of the final cut movie (and other artifacts) via secure sharing for each movie, default and or profile settings, and other methods known in the art.

Likewise, a potential participant can limit access to any and all signals and media via secure sharing for each movie, default and or profile settings, and other method known in the art.

FIG. 8B is a flow diagram of one embodiment of a process for creating video clips regarding an activity using information of another participant in the activity. The process is performed by processing logic that may comprise hardware (circuitry, dedicated logic, etc.), software (such as is run on a general purpose computer system or a dedicated machine), firmware, or a combination of these three.

Referring to FIG. 8B, the process begins by determining a co-participant based on one or more of an activity descriptor, location, time, one or more sharing networks sharing the signal data and media associated with the co-participant, prior data exchange, prior movie sharing, and explicit user action to initiate sharing (processing block 801). In one embodiment, automatically determining the co-participant based on one or more sharing networks is based, at least in part, on degrees of separation between each sharing network and an originator of the video data. Note that more than one participant can be identified.

Alternatively, the co-participant is not determined automatically and an indication of a co-participant may be provided to the system.

After an indication that one or more co-participants exist, processing logic determines the existence of one or both of signal data and media of a co-participant in an activity (processing block 802).

Also, processing logic obtains video data that captures an activity of a participant (processing block 803). The video data may be captured prior to processing the video. In another embodiment, the video is captured while co-participant determination is being made.

In one embodiment, the process also includes determining whether to include the one or more portions of the co-participant media based on signal data of the co-participant (processing block 804). In one embodiment, at least one signal of the signal data of the co-participant indicates quality of the media, and wherein determining whether to include the one or more portions based on signal data of the co-participant includes determining whether the media is of sufficient quality to include in the new video based on the at least one signal.

After a co-participant has been identified and their signal and/or media data is identified and/or made available, processing logic creates a clip from the video data by processing signals and editing the video data, wherein the processing of the signals and the editing of the video data are based on one or more of signal data and media associated with the co-participant in the activity (processing block 805). In one embodiment, creating the clip from the video data comprises extracting one or more portions from the media of the co-participant and including the one or more clips in the new video. In one embodiment, creating the clip comprises creating highlights from the video data based on the signal data of the co-participant. In another embodiment, creating the clip comprises using the signal data of the co-participant to determine whether portions of the video data already identified for potential inclusion in the clip are included or not in the clip. In yet another embodiment, creating the clip comprises using the signal data of the co-participant to ensure one or both of quality and accuracy of portions of video data selected for inclusion in the clip. In still yet another embodiment, creating the clip comprises tagging portions of video data capturing an activity, wherein the tagging occurs in response to processing of the signal data associated with the participant and the co-participant. In a further embodiment, creating the clip comprises tagging portions of video data capturing an activity, wherein the tagging occurs in response to processing of the signal data only associated with the co-participant. In still a further embodiment, creating the clip comprises extracting media clip data for inclusion in the clip, the media clip data from the video data based on one or more highlights identified from signals and from the media associated with the co-participant.

In another further embodiment, creating the clip comprises creating a highlight list used to create the final cut clip, wherein the highlight list is augmented based on highlight list data associated with the participant and the co-participant. In one embodiment, the highlight list data associated with the co-participant causes one or more additional highlights to be included in the highlight list. In one embodiment, the highlight list data associated with the co-participant impacts whether individual highlights are included in the clip.

In one embodiment, participant method and operations described above are performed by a devices and systems, such as, for example, devices of FIGS. 8A, 9-12 and 18. FIG. 8C illustrates a block diagram of a video editing system that performs participant sharing operations described herein. The blocks comprise hardware (circuitry, dedicated logic, etc.), software (such as is run on a general purpose computer system or a dedicated machine), firmware, or a combination of these three.

Referring to FIG. 8C, the video editing system comprises a memory 861 and one or more processing units 862 (e.g., processors, CPUs, processing cores, etc.). Memory 861 stores instructions and video data that captures an activity of a participant. Memory 861 may be one or more memories, which may be local or remotely located with respect to each other. Processing unit(s) 862 are coupled to the memory and execute the instructions to determine the existence signal data and/or media of a co-participant in the activity. In one embodiment, processing units 862 implement editing processing logic, by executing instructions, to create a clip from the video data by processing signals and editing the video data, where the processing of the signals and the editing of the video data are based on one or more of signal data and media associated with the co-participant in the activity.

In one embodiment, the editing processing logic comprises a plurality of stages. In one embodiment, at least one of the plurality of stages includes: a signal processing process to tag portions of video data in response to signal processing; a highlight creation process to create a highlight list in response to the portions identified in the signal processing stage; a media extraction process to extract media clip data from video data based on the highlight list from the highlight creation stage; and a movie creation process to create a final cut clip in response to extracted media clip data from the media extraction stage. In one embodiment, these stages perform functions as described herein.

In one embodiment, the editing processing logic creates the clip from the video data by extracting one or more portions from the media of the co-participant and including the one or more clips in the new video. In another embodiment, the editing processing logic creates the clip by creating highlights from the video data based on the signal data of the co-participant. In yet another embodiment, the editing processing logic creates the clip by using the signal data of the co-participant to determine whether portions of the video data already identified for potential inclusion in the clip are included or not in the clip. In still another embodiment, the editing processing logic creates the clip by using the signal data of the co-participant to ensure one or both of quality and accuracy of portions of video data selected for inclusion in the clip.

In one embodiment, the editing processing logic determines whether to include the one or more portions of the co-participant media based on signal data of the co-participant. In another embodiment, at least one signal of the signal data of the co-participant indicates quality of the media, and wherein determining whether to include the one or more portions based on signal data of the co-participant includes determining whether the media is of sufficient quality to include in the new video based on the at least one signal.

In one embodiment, the highlight list data associated with the co-participant causes one or more additional highlights to be included in the highlight list. In another embodiment, the highlight list data associated with the co-participant impacts whether individual highlights are included in the final cut clip.

In one embodiment, the editing processing logic creates the final cut clip by tagging portions of video data capturing an activity, wherein the tagging occurs in response to processing of the signal data associated with the participant and the co-participant. In another embodiment, the editing processing logic creates the final cut clip by tagging portions of video data capturing an activity, wherein the tagging occurs in response to processing of the signal data only associated with the co-participant. In yet another embodiment, the editing processing logic creates the final cut clip by creating a highlight list used to create the final cut clip, wherein the highlight list is augmented based on highlight list data associated with the participant and the co-participant. In still yet another embodiment, the editing processing logic creates the final cut clip comprises extracting media clip data for inclusion in the final cut clip, the media clip data from the video data based on one or more highlights identified from signals and from the media associated with the co-participant.

In one embodiment, the highlight list data associated with the co-participant causes one or more additional highlights to be included in the highlight list. In another embodiment, the highlight list data associated with the co-participant impacts whether individual highlights are included in the final cut clip.

In one embodiment, the editing processing logic automatically determines the co-participant based on one or more of an activity descriptor, location, time, and one or more sharing networks sharing the signal data and media associated with the co-participant. In another embodiment, the editing processing logic automatically determines the co-participant based on one or more sharing networks is based, at least in part, on degrees of separation between each sharing network and an originator of the video data.

### Traditional Sharing Detection

In one embodiment, a stakeholder can manually share a movie by identifying the person or group with which to share it. In one embodiment, signals are used to detect individuals or groups that are candidates with which to share final-cut movies.

There are several ways that the existence of share candidates is determined. In one embodiment, the time and GPS location signals of the originator and many potential candidates are compared. Candidates are determined based on the relative proximity in both time and location in general for an activity. In one embodiment, further refinement is achieved by considering the time and/or location of potential candidates relative to specific identified highlights from the originator's signals.

Additionally, in one embodiment, other signals and contexts are used to create descriptors of activities and highlights, and these descriptors are compared to determine who is also a candidate. Thus, candidates can be coincident in time and/or location and/or coincident in activity.

In one embodiment, the determination of who is a candidate is based on social network proximity, both formal, e.g. Facebook friends, and informal, e.g. users who have previously shared final cut movies. In one embodiment, other contextual data is used list address books of the user, calendar information, and so on.

In one embodiment, share candidates could be detected before or during an event. In one embodiment, candidates are notified by some communication method (e.g. Twitter, text, email) of the availability of a movie.

### Detailed Embodiments of the Capture, Intermediary (Editor) and Viewer Systems

### Overview of the Capture System

In one embodiment, the capture system for capturing the raw video, such as raw video 101 of FIG. 1, is a smart phone device. FIG. 9 is a block diagram of one embodiment of a smart phone device. Referring to FIG. 9, the smart phone device 900 comprises camera 901 which is capable of capturing video. In one embodiment, the video is high definition (HD) video. Smart device 900 comprises processor 930 that may include the central processing unit and/or graphics processing unit. In one embodiment, processor 930 performs editing of captured video in response to received triggers (and tagging).

Smart device 900 also includes a network interface 940. In one embodiment, network interface 934 comprises wireless interface. In an alternative embodiment, network interface 940 includes a wired interface. Network interface 940 enables smart device 900 to communicate with a remote storage/server system, such as a system described above, that generates and/or makes available raw, rough-cut and/or final-cut video versions.

Smart phone device 900 further includes memory 950 for storing videos, one or more MHLs (optionally), an editing list or script associated with an edit of video data (optionally), etc.

Smart phone device 900 includes a display 960 for displaying video (e.g., raw video, rough-cut video, final-cut video) and a user input functionality 970 to enable a user to provide input (e.g., tagging indications) to smart phone device 900. Such user input can be the touch screen, sliders or buttons.

In some embodiments, summary videos are collected in the cloud and/or on client devices (e.g. smart phone, personal computer, tablet). These devices can play the movie for the viewer. In some embodiments, this player enables the viewer to manipulate the video creating new tags, deleting others, and reorganizing highlights (see the description below). In some embodiments, the originator of the summary video can share the video with one or more viewers via uploading to the cloud (or other remote storage) and enabling viewers to download from the cloud. Viewers can subsequently share the same way. In one embodiment, the cloud provides player and/or edit functions via a standard web browser. Permission to view and/or edit the video can be shared via URL and/or security credential exchange.

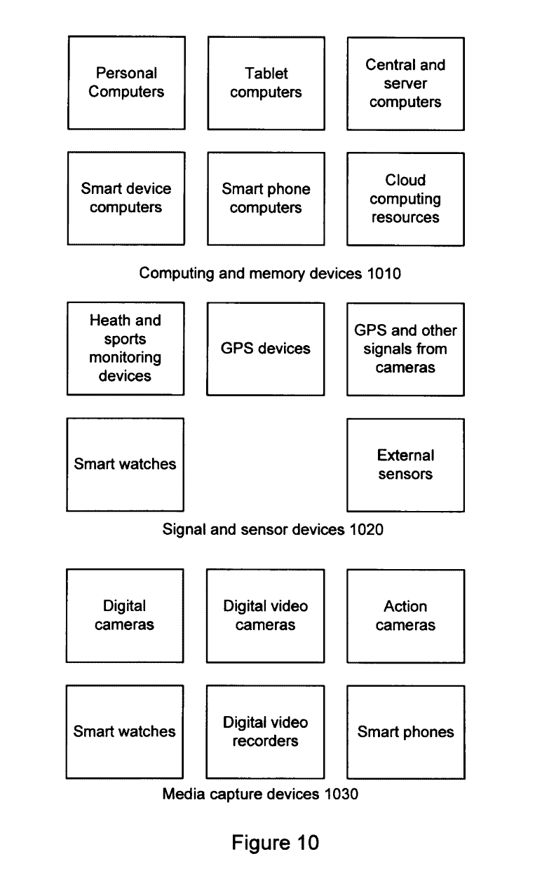

The overall system is made up of one or more devices capable of capturing signals, recording media, and computing processing and storage. FIG. 10 shows a number of computing and memory devices 1010 such as, for example, smart phones, tablets, personal computers, other smart devices, server computers, and cloud computing. A number of signal and sensor devices 1020 such as, for example, smart phones, GPS devices, smart watches, digital cameras, and health and fitness sensors can be used to acquire signals. Also, a number of media capture devices 1030 such as, for example, smart phones, action cameras, digital cameras, smart watches, digital video recorders, and digital video cameras can be used in the system. All of these can be integrated together via various forms of digital communication such as cellular networks, WiFi networks, Internet connections, USB connections, other wired connections and exchange of memory cards. The processing of a given activity can performed on any of the computing and memory devices 1010 using the signals and media that are accessible at the moment. Also, the processing can be opportunely distributed among devices to optimize (a) the locality of signals and media to avoid sending and receiving large amounts of data over limited bandwidth, (b) the computing resources available, (c) the memory and storage available, and (d) the access to participant data. Ideally, perhaps after final-cut movies are produced, the signal data, media data, and the MHL created at any point in the system would eventually be uploaded to a central location (e.g., cloud resources) so that machine learning and participant sharing can be facilitated.

In some embodiments, signal and sensor devices 1020 record audio to enable synchronization with media capture devices 1030. This is especially useful for cameras that are not otherwise synchronized with the signal and sensor devices 1020.

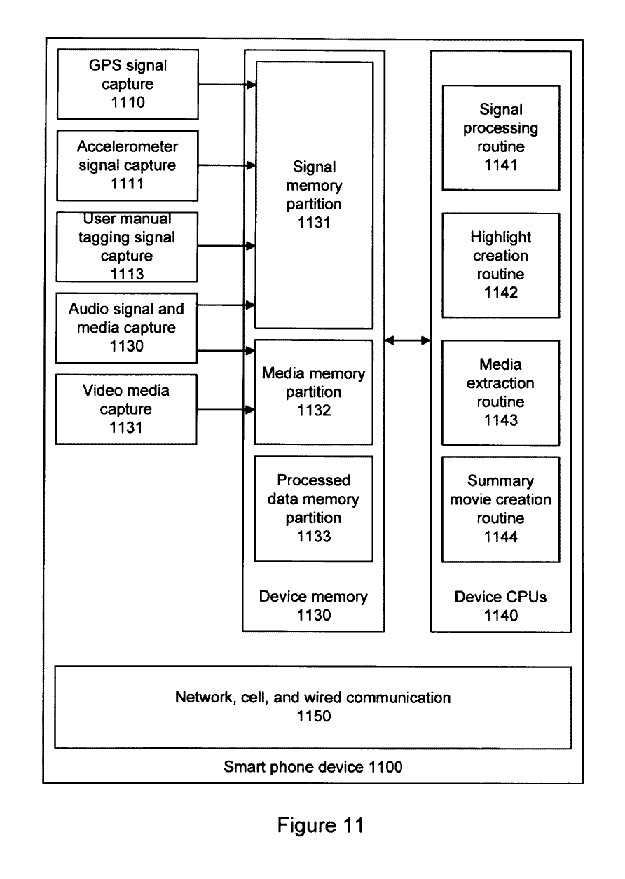

In some embodiments all of the signal capture, media capture, and processing are performed on one device, e.g. a smart phone. FIG. 11 shows a single device with all of these functions. A smart phone device 1100, such as the Apple iPhone, has dedicated hardware to capture signals such as GPS signal capture 1110, accelerometer signal capture 1111, and audio signal and media capture 1120. Using a combination of hardware and software, manual gestures (e.g. tags and swipes on the touch sensitive display, motion of the device) can be interpreted as user manual signal capture 1112. In one embodiment, smart phone device 1100 also has dedicated video media capture 1121 hardware as well as the audio signal and media capture 1120 hardware.

Using smart phone device 1100, device memory 1130, and device CPUs 1140 and network, cell, and wired communication 1150, the data and processing flow functions (shown in FIG. 6) can be performed. Note that some of these smart devices include several memories and/or CPUs to which the functions can be allocated by the implementer and/or the operating system of the device. Conceptually, the device memory might contain a signal memory partition 1131 (or several) that contains the raw signal data. There is a media memory partition 1132 that contains the raw (compressed) audio and video data. Also there is a processed data memory partition 1133 that contains the MHL instructions, rough-cut clips, and summary movies.

Using the device CPUs 1140, the necessary routines are run on smart phone device 1100. Signal processing routine 1141 performs the analyzer processing on the signal data and creates tagged data. The highlight creation routine 1142 performs interpreter processing on the tagged data and creates highlight data. The media extraction routine 1143 extracts clips from the media data. Summary movie creation routine 1144 uses the master highlight list and the media to create summary movies.

After processing the summary movie can be uploaded by the network, cell, and wired communication 1150 functions of smart phone device 1100 to a central cloud repository to facilitate sharing between other devices and other users. The signal data, media data, rough-cuts, and/or MHLs may also be uploaded to enable participant sharing of signals and media and machine learning to improve the processing.

In one embodiment, the signals and media data are captured during the activity. When the activity is over, the processing is triggered. In one embodiment, the signals and media are captured during the activity and at least signal processing routine 1141, highlight creation routine 1142, and media extraction routine 1143 integrate in near real-time. Summary movie creation routine 1144 is performed after the activity. See U.S. Provisional No. 62/098,173, entitled, “Constrained System Real-Time Editing of Long-Form Video,” filed on Dec. 30, 2014.

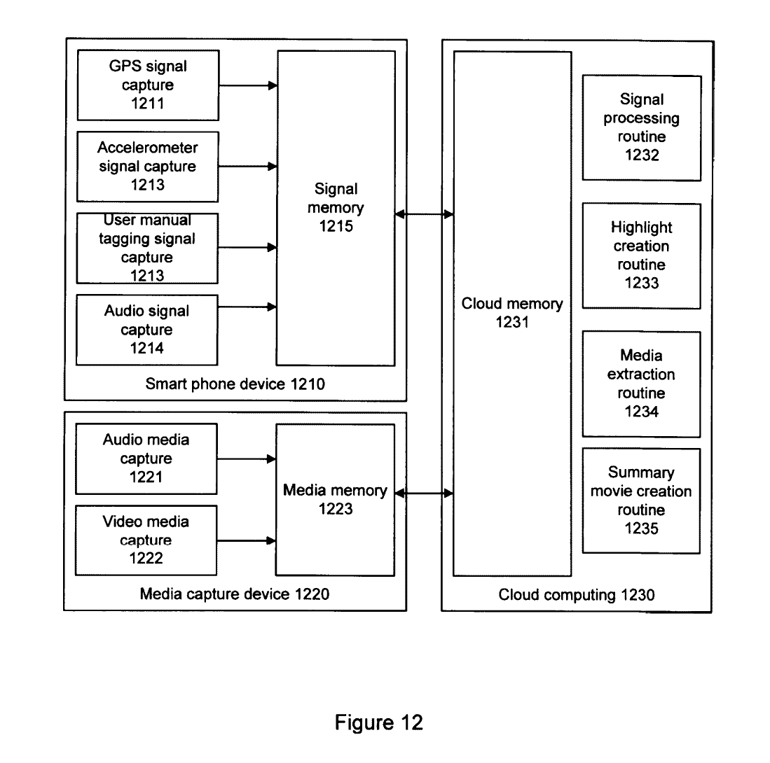

In one embodiment, the signals and/or media are captured by different device(s) than the processing. FIG. 12 shows one embodiment where the signals are captured by a smart phone device 1210 (e.g., an Apple iPhone), the media data is captured by a media capture device 1220 (e.g., a GoPro action camera), and the processing is performed by cloud computing 1230 (e.g., Amazon Web Services, Elastic Compute Cloud, etc.). If possible, the timing between smart phone device 1210 and media capture device 1220 is synchronized before recording the event. On smart phone device 1210, GPS signal capture 1211, accelerometer signal capture 1212, user manual tagging signal capture 1213, and audio signal capture 1214 are performed by dedicated hardware and the signals stored in signal memory 1215. At the end of the activity, the signals are uploaded to cloud memory 1231 of cloud computing 1230.

After the signals are uploaded to cloud memory 1231, signal processing routine 1232 and highlight creation routine 1233 can be executed.

Media capture device 1220 captures the movie data with audio media capture 1221 and video media capture 1222 and stores the media in the media memory 1223. At the end of the activity, the media are uploaded to cloud memory 1231 of cloud computing 1230.

After the signals and media are uploaded to cloud memory 1231 and signal processing routine 1232 and highlight creation routine 1233 are executed, media extraction routine 1234 and summary movie creation routine 1235 can be executed.

There are many embodiments possible for the arrangement of the processing. In one embodiment, a smart phone device captures the signals and the media; transfers the signals to the cloud; the cloud processes the signals and creates highlights; the cloud transfers the highlights back to the smart phone device; and the smart phone device uses the highlights and the media to extract clips and create a summary movie.

In another embodiment, a smart phone device captures the signals; a different media capture device captures the media; the smart phone devices transfers the signals to the cloud; the cloud processes the signals and creates highlights; the cloud transfers the highlights back to the smart phone device; the media capture device transfers the media to the smart phone; and the smart phone device uses the highlights and the media to extract clips and create a summary movie.

In one embodiment the highlight creation routine and media extraction routine are called twice. The first execution the highlight creation and media extraction routines are called to create rough-cut clips. The second execution the highlight creation and media extraction routines are called to create final-cut clips for the summary movie creation. The highlights used in the second execution are (most likely) a subset of the highlights and duration of the first execution.

### Any Camera Vieu™

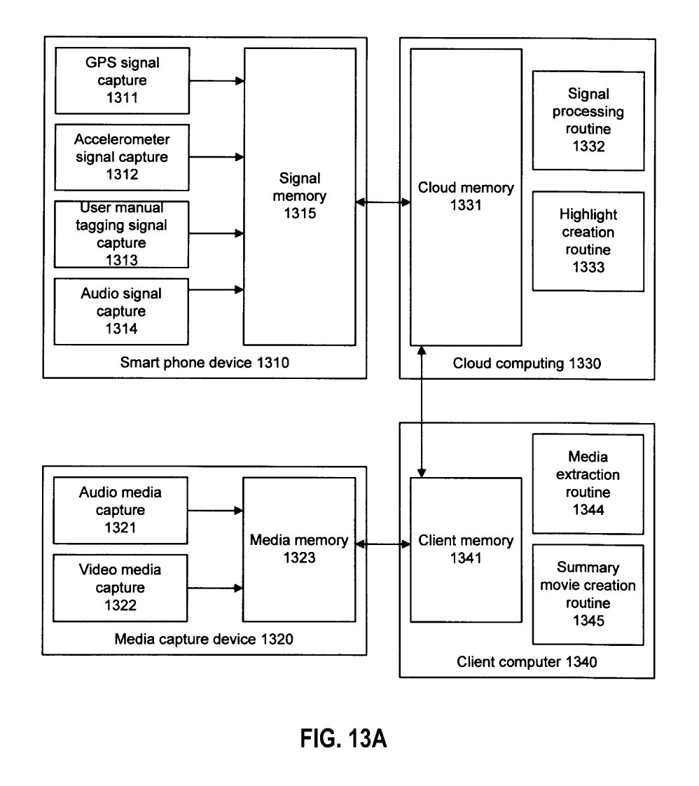

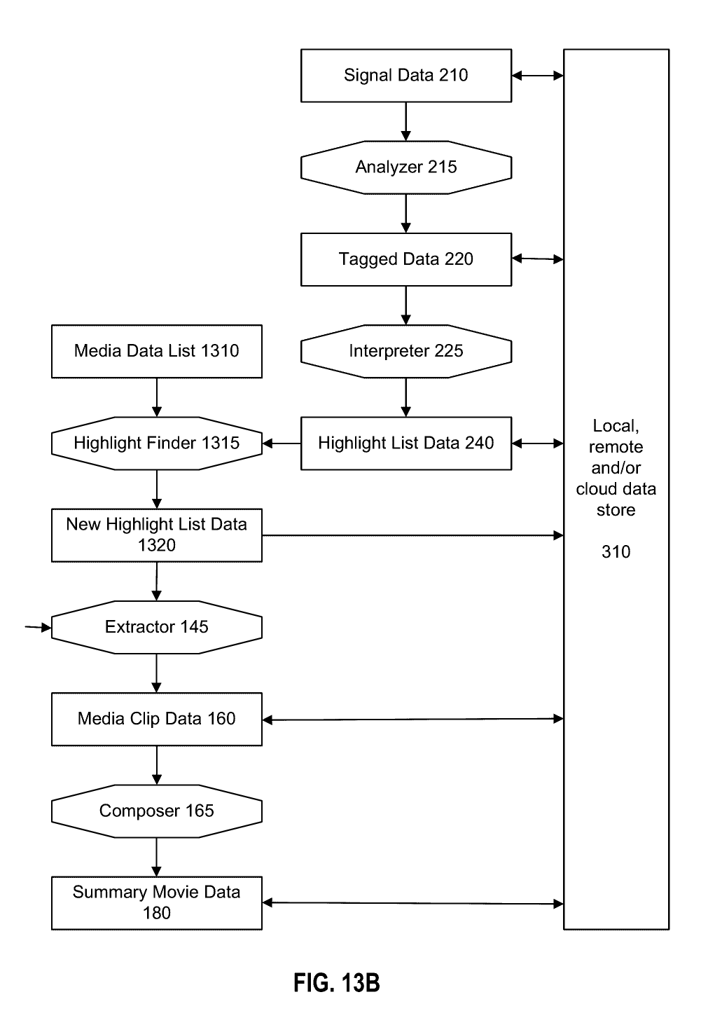

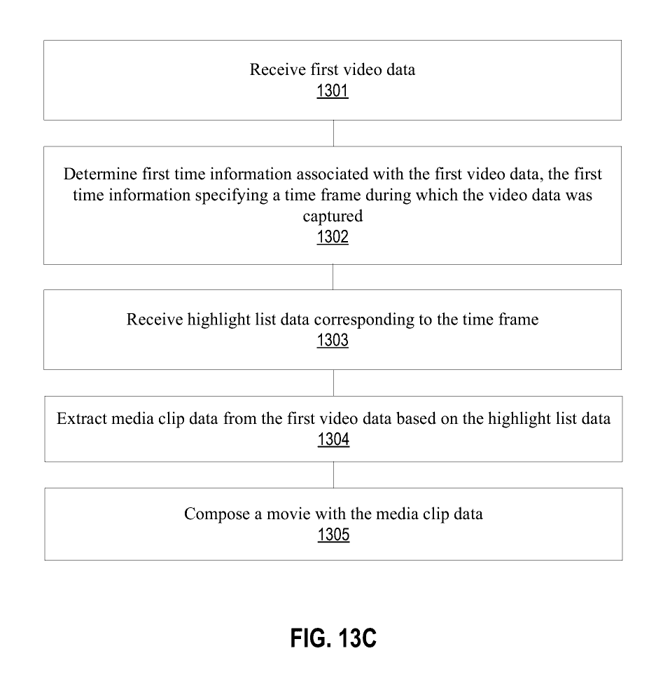

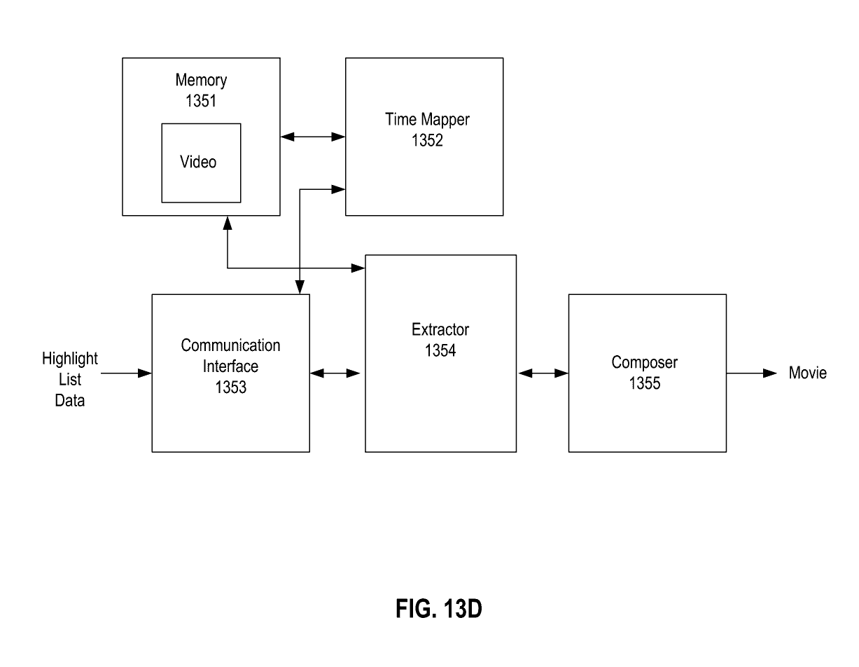

FIG. 13A shows a different embodiment that uses a smart phone device 1310 (e.g., Apple iPhone) to capture the signals; a media capture device 1320 (e.g., a GoPro action camera); cloud computing 1330 to perform the signal processing and highlight creation; and a client computer 1340 to extract clips and create summary movie creation. Using this configuration, the flow goes as follows smart phone device 1310 and media capture device 1320 are synchronized in time and the activity recording starts with smart phone device 1310 capturing signals and media capture device 1320 capturing media. When instructed to finish and/or transfer the signals data, smart phone device 1310 transfers the signals to cloud computing system 1330. Cloud computing system 1330 processes the signals and creates and stores highlights.

Independently and asynchronously, media capture device 1320 media memory 1323 is connected to client computer 1340. The connection could be wireless, e.g. WiFi or Bluetooth, via a wired cable, e.g. USB, or via inserting a removable memory card from media capture device 1320 into the client computer 1340. Client computer 1340 examines the media and creates a list of media and the beginning and ending times. The list of media is transferred from client computer 1340 to cloud computing system 1330. Cloud computing system 1330 determines which of the previously calculated highlights (see the above paragraph) are appropriate for the media. Cloud computing system 1330 creates one or more Master Highlights Lists and transfers these to the client computer. (One MHL maybe for the rough-cut clips and the other MHL(s) may be for summary movies.)

With the access to the MHL and media memory 1323, client computer 1340 extracts clips directly from media memory 1323. (Extracting clips using this direct access saves significant time, processing power, and bandwidth over copying the entire media. As an example, a two hour activity capture in high resolution could easily accumulate 10 to 15 gigabytes of data. The size of the extracted clips is a function of the MHL but might be significantly smaller, say less than a single gigabyte.) With the media clips and the MHLs client computer 1340 creates the summary movie.

FIG. 13B is a flow diagram of another embodiment of a video editing process.

FIG. 13C is a flow diagram of one embodiment of a process for processing captured video data. The process is performed by processing logic that may comprise hardware (circuitry, dedicated logic, etc.), software (such as is run on a general purpose computer system or a dedicated machine), firmware, or a combination of these three.

Referring to FIG. 13C, the process begins by processing logic receiving first video data (processing block 1301) and determining first time information associated with the first video data, the first time information specifying a time frame during which the video data was captured (processing block 1302).

Processing logic also receives highlight list data corresponding to the time frame (processing block 1303). In one embodiment, receiving the highlight list data is in response to sending the first time information to a first remote location to determine if highlights exist during the time frame. In one embodiment, the highlight list data comprises second time information that includes a time for each highlight specified in the highlight list. In one embodiment, the highlight list data is generated using an analyzer operable to perform signal processing to tag portions of the second video data and an interpreter operable to perform a highlight creation process to create one of more lists of highlights in response to the portions identified by the analyzer. In one embodiment, the analyzer and the interpreter are at a second remote location.

Using the highlight list data, processing logic extracts media clip data from the first video data based on the highlight list data (processing block 1304).

Using the extracted media clip data, processing logic composes a movie with the media clip data (processing block 1305). In one embodiment, the movie is a rough cut version of the first video data. In one embodiment, composing the movie with the media clip data comprises performing a movie creation process to create a summary movie that includes at least a portion of the rough cut version with media clips from a second video data.

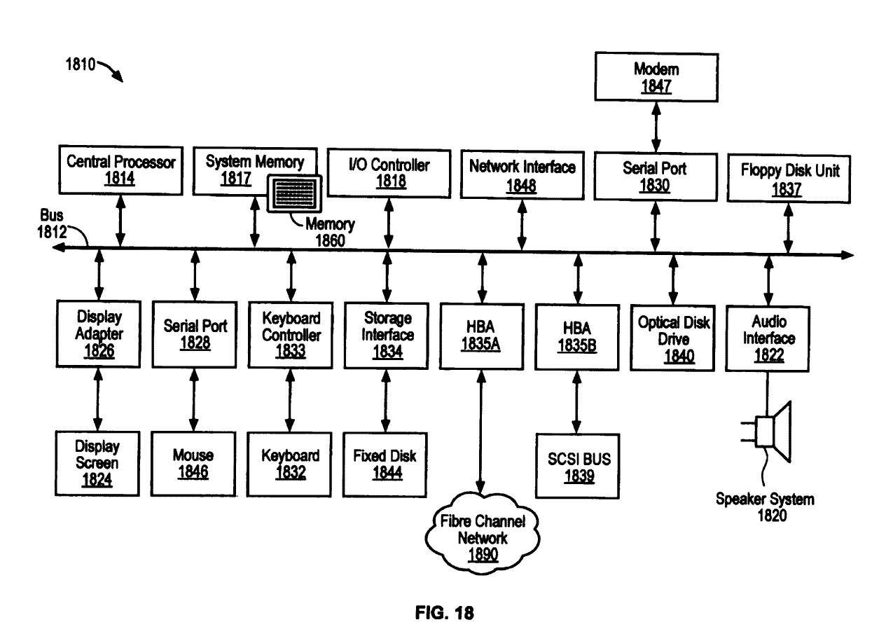

In one embodiment, the method and operations described above are performed by a devices and systems, such as, for example, devices of FIGS. 13A and 18. FIG. 13D illustrates a block diagram of a video editing system that performs distributed computing operations described herein. The blocks comprise hardware (circuitry, dedicated logic, etc.), software (such as is run on a general purpose computer system or a dedicated machine), firmware, or a combination of these three. Referring to FIG. 13D, the video editing system comprises a memory 1351 to store first video data; time mapper logic 1352 communicably coupled with memory 1351 to determine first time information associated with the first video data, where the first time information specifies a time frame during which the video data was captured; a communication interface 1353 communicably coupled to time mapper logic 1352 to receive highlight list data corresponding to the time frame (via, e.g., sending requests based on the time frame to remote storage or other locations); an extractor 1354 communicably coupled to memory 1351 and communication interface 1353 to extract media clip data from the first video data based on the highlight list data; and a composer 1355 to compose the movie with the media clip data. In one embodiment, extractor 1354 and composer 1355 perform other operations as described above.

In one embodiment, the highlight list data comprises second time information that includes a time for each highlight specified in the highlight list. In another embodiment, the highlight list data is received in response to the communication interface sending the first time information to a first remote location to determine if highlights exist during the time frame.

In one embodiment, the highlight list data is generated using an analyzer operable to perform signal processing to tag portions of the second video data, and an interpreter operable to perform a highlight creation process to create one of more lists of highlights in response to the portions identified by the analyzer. In one embodiment, the analyzer and the interpreter are at a second remote location. In one embodiment, the analyzer and/or interpreter are implemented and/or performs functions that as described above.

In one embodiment, the movie is a rough cut version of the first video data.

In one embodiment, composer 1355 performs a movie creation process to create a summary movie that includes at least a portion of the rough cut version with media clips from a second video data.

Tagging and the Video Editing Process

As discussed above, the result of interpreting (225) the performed tagging and editing, regardless of whether it is manually by a photographer (capture device operator) or a viewer or automatically by a system, is a master highlight list 240 (MHL).

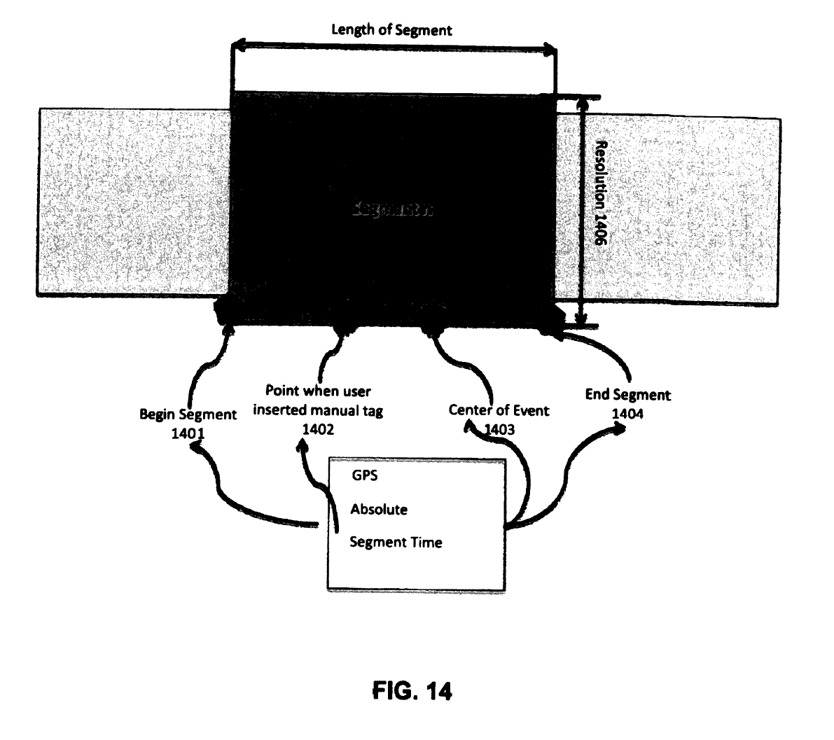

FIG. 14 illustrates information on a single video segment according to one embodiment. Referring to FIG. 14, a video segment is shown having a particular length 1405 and resolution 1406. The length of the segment is based on the beginning of the segment and the ending of the segment which are identified as the begin segment 1401 and the end segment 1404 identifiers, respectively. The segment also identifies a point where the user inserts manual tag 1402 as well as the center of the event 1403. In one embodiment, information is stored with each of begin segment 1401, the point when the user inserted manual tag 1402, the center of the event 1403 and the end segment 1404. In one embodiment, this information includes one or more of a segment time stamp, the absolute time, and/or GPS information. In one embodiment, any metadata that was captured or synthesized for the timeframe of the segment is available. In one embodiment, also available is any alternative viewpoint (e.g., video from other sources) that provides coverage for some or all the time of the segment.

In one embodiment, the system algorithmically applies good videography practices to improve viewing experience when adjusting segment start/end, viewpoints, etc. These practices might include, for example: 1) adjusting the start and end of a segment to make scene cuts when the camera is more stationary, or 2) omitting alternative viewpoints that cross the action line.

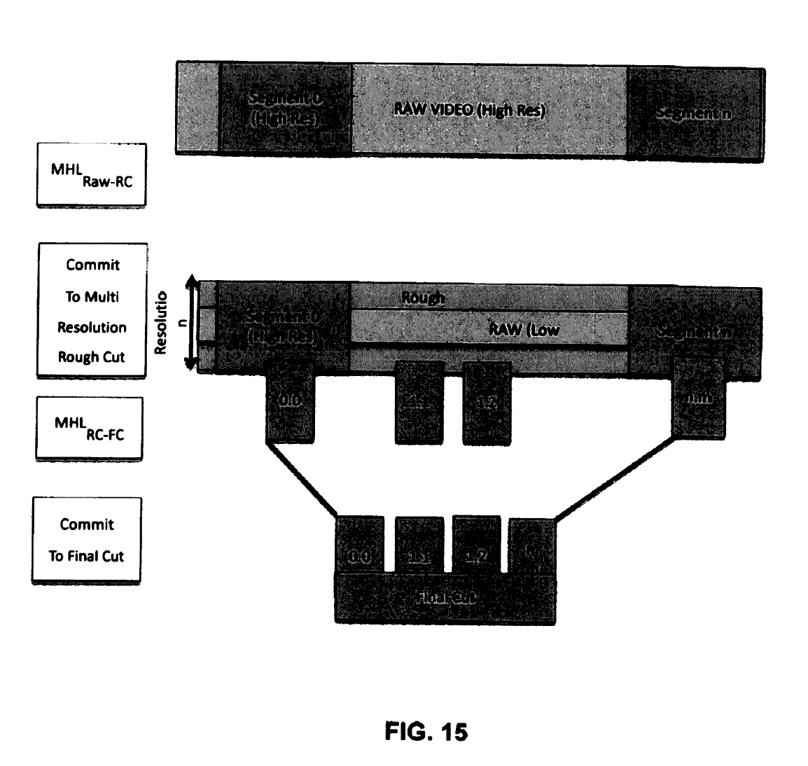

FIG. 15 illustrates an exemplary video editing process. FIG. 15 illustrates a video stream having segment zero at high resolution, having raw video at a high resolution. Referring to FIG. 15, Segment 0 though Segment n are shown. The master highlight list for converting the high-resolution raw video into a rough-cut is used which causes Segment 0 and Segment n to remain in high-resolution form. In one embodiment, the center portion of the video stream is reduced to low resolution. A number of segments from the video stream, labeled 0.0, 1.1, 1.2, and n.m are selected based on the MHL for the rough-cut to final-cut conversion and are included and committed into the final-cut video. The MHLs for the raw to rough-cut editing and the rough-cut to final-cut editing are based on tagging.

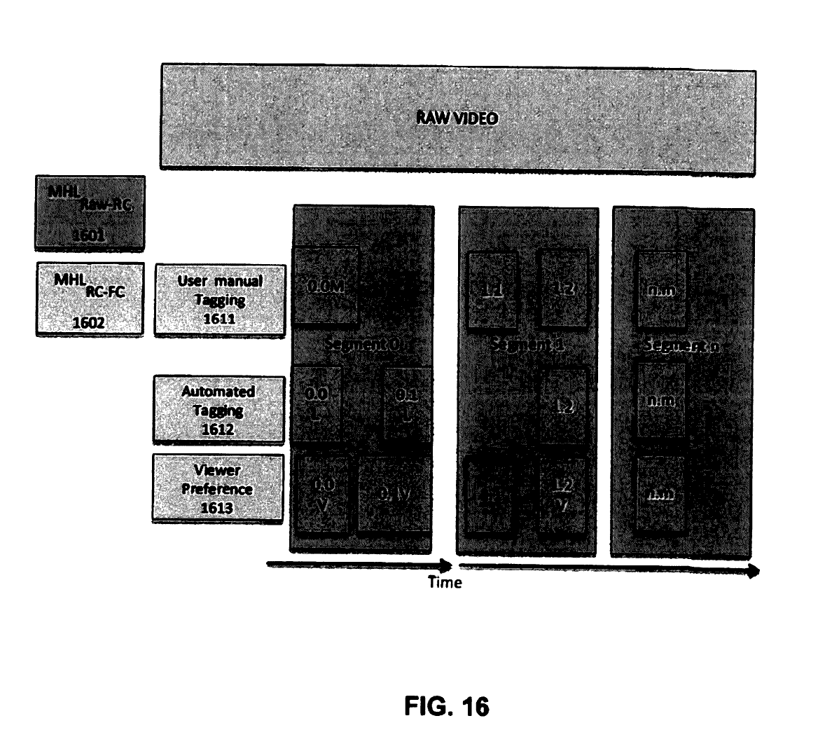

FIG. 16 illustrates another version of the editing process in which raw video is subjected to MHL 1601 which causes segments 0, 1 and n to be obtained from the raw video. The MHL 1602 used for converting the rough-cut to the final-cut is created by three forms of tagging, which include user manual tagging 1611, automated tagging 1612 and user preference tagging 1613. As shown, each of these forms of tagging identifies portions of Segments 0, 1 and n. For example, user-tagging 1611 is used to tag segment 0.0M of Segment 0, segments 1.1 and 1.2 in Segment 1 in Segment n.m in segment n. Similarly, automated tagging 1612 tags Segments 0.0L and 0.1L in Segment 0, Segment 1.2 in Segment 1 and Segment n.m in Segment n. Lastly, viewer preference tagging 1613 selects tags segments 0.0V and 0.1V in Segment 0, segments 1.1 and 1.2V in Segment 1 and segment n.m in Segment n.

Note that the automatic tagging 1612 extracted a smaller region 0.0L than the user manual tagging 1611 did when selecting 0.0M. Also, while the viewer preference tagging 1613 selected segment 0.0V in segment 0 based on user preference, the final clip segment was shorter than that selected by automatic tagging 1612. Note that sensors activated the automatic tag when selecting segment 0.1L. Furthermore, the viewer preference tagging 1613 specified extraction of a larger segment 0.1V than the automatic tagging 1612 did when selecting segment 0.1L.

In one embodiment, tagging is performed by a user based on a manual input or automatically by a system. In the case of manual tagging, a user interface is used for tagging. In one embodiment, the user interface may be used for capture, editing and/or viewing. The tagging may include tapping on the display of the capture device (e.g., smart phone) or performing a gesture with the capture device (e.g., rotating the capture device). It may also include “lightweight” means to trim length, include/exclude highlights, etc. directly from the video player. Ideally, the tagging should be performed in a way that can express a user's real-time with minimal distraction for the user. The user interface (e.g., gestures) may be context and/or activity dependent (e.g., may have a different meaning based on which version of video is being viewed).

In one embodiment, tagging occurs on the capture device (e.g., mobile device) based on learning previously done in the cloud.

### User Interface Gestures

As discussed above, operations are performed by a system in response to actions taken by a user via a user interface. In one embodiment, the actions are in the form of gestures performed by the user. Note that the gestures can be used at capture time, near capture time, playback, editing, and viewing. Moreover, such gestures may be incorporated as a uniform language so that when appropriate, not only can they be used in different stages of the process, but the actual gestures are similar for each corresponding action, regardless of the stage. The user performs one or more gestures that are recognized by the system, and in response thereto, the system performs one or more operations. The system may perform a number of operations including, but not limited to, tagging of media, removing previous tags, setting priority level of tags, specifying attributes of a highlight that may result from a tag (e.g., highlight duration, length of time before and after the tag point, transition before/after the highlight, type of highlight), editing of media, orienting of the media capture, zooming and cropping; controlling the capture device (e.g., pause, record, capture at a higher rate for slow motion); enable/disable meta data (signal) recoding, set recording parameters (such as volume, sensitivity, granularity, precision); add annotation to the media or create a side-band track; or controlling the display, which in some cases may include playback information and/or a more complex dashboard. These operations cause one or more effects to occur. The effect may be different when different gestures are used.

In one embodiment, effects of the gestures are adapted in real-time based on the context. That is, the effect that it is associated with each of the gestures may change based on what is currently happening with respect to the digital stream. For example, a gesture may cause a portion of a data stream to be tagged if the gesture occurs while the data stream is being recorded; however, the same gesture may cause a different viewing or editing effect to occur with respect to the data stream if such a gesture is performed on a media stream after it has already been captured.

With respect to tagging, the effect of the gesture may cause one or more of a number of effects. For example, a gesture may cause creation of a tag with a certain priority (e.g., high priority), a tag of arbitrary duration, a tag to a certain extent going backward, a tag to a certain extent going forward. A gesture(s) may cause other operations such as camera control operations (e.g., slow motion, a zoom operation) to occur, may cause a deletion of a most recent tag, may specify a beginning of a tag, may specify a transition between clips, an ordering of clips, or a multi-view point, and may specify whether a picture should be taken.

In one embodiment, the tagging controls the editing that is performed. That is, tags are included in the signal stream that leads to the creation of highlights. The user applies this type of tag during recording, or playback editing, to indicate many things. For example, an editing tag can be used to indicate a significant highlight (moment, location, event, . . . ). In some embodiments, additional or special gestures can add attributes to tags to increase the significance, indicate especially high significance, give guidance on the beginning and end of the significant highlight, indicate how to treat that significant highlight during editing (e.g., show in slow motion), alter the before and after time, and many more.

In another embodiment, the tagging controls the camera operation in real time (e.g., zoom, audio on, etc.).

The gesture language provides one or more gestures that can cause the effect that may include receiving feedback. These are discussed in more detail below

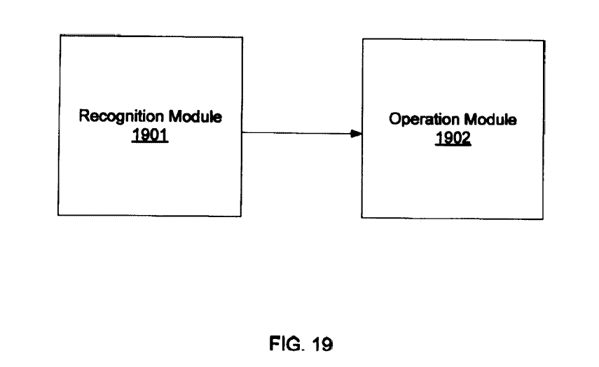

FIG. 19 is a block diagram of a portion of the system that implements a user interface (UI). The process is performed by processing logic that may comprise hardware (circuitry, dedicated logic, etc.), software (such as is run on a general purpose computer system or a dedicated machine), or a combination of both.

In one embodiment, the user interface is designed so that during an event being captured the user interface is designed to cause very little distraction. This is important because it is desirable for a participant to reduce their involvement while having the experience. In one embodiment, minimal distraction for the originator is achieved by having the application start and stop the event capture without needing specific user gesture. There is no start or stop button necessary. In one embodiment, there is no need for the user to watch the preview of the video on the screen. In one embodiment, all of the screen area is available for any gesture, and no precision by the user is required. In one embodiment, the majority of the screen is available for any gesture, and little precision by the user is required.

Referring to FIG. 19, the system includes a recognition module 1901 to perform gesture recognition to recognize one or more gestures made with respect to the system and an operation module 1902 to perform one or more operations in response to the gesture recognized by gesture recognition module 1901. In one embodiment, operation module 1902 includes a tagging module or a tagger that associates a tag in real-time with a portion of a data stream recorded by a media device, in response to recognition of the one or more gestures. In such a case, the tag may be used in subsequent creation of an edited version of the stream.

FIG. 20A is a flow diagram of one embodiment of a process for tagging a real-time stream. The process is performed by processing logic that may comprise hardware (circuitry, dedicated logic, etc.), software (such as is run on a general purpose computer system or a dedicated machine), or a combination of both.

FIG. 20A, is an embodiment of the real-time capture implementation of the system. The process begins by recording the stream with a capture device (e.g., smart phone, etc.) in real-time (processing block 2001). In one embodiment, the real-time stream is a video. In one embodiment, the media device records the real-time stream as soon as an application that controls the capture on the capture device has been launched. In one embodiment, the process further comprises stopping the real-time stream recording automatically without a user gesture (e.g., user places capture device down). In this manner, there is no gesture needed to start and stop the capture process (and optionally the initial editing process).

Next, processing logic recognizes a gesture made with respect to the system (e.g., capture device (e.g., smart phone) (processing block 2002). In one embodiment, at least one gesture is performed without requiring a user to view the screen of the capture device. In one embodiment, at least one gesture is performed using one hand. In one embodiment, at least one gesture is performed by pressing on the screen of the capture device and performing a single motion or multiple motions. In one embodiment, at least one gesture is captured, at least in part, by the display screen of the capture device.

The type of gestures available for a given embodiment is a function of the hardware, software, and operating system of the device. Note that a huge and growing variety of gestures can be recognized. A system that determines how hard the screen is pressed can represent different gestures. Certain devices have different sensors that can be held and/or optical sensors that recognize gestures. These types of gestures, and new gestures that emerge in the future, can be incorporated and mapped to functions in various embodiments of this system.

In one embodiment, the gesture comprises one selected from a group consisting of: a single tap on a portion of the system, a multi-tap on a portion of the system, touching a portion of the system for a period of time, touching a portion of the system and swiping left, touching a portion of the system and swiping right, swiping back and forth with respect to the system, moving at least two user digits in a pinching motion with respect to the screen of the system, moving an object along a path with respect to the screen of the system, shaking or tilting the system, covering a lens of the system, rotating the system, tapping on any part of the device, and controlling a switch of the system to change the system into an effect mode (e.g., silence mode). The system may also interpret each of the tap touch and swipe actions differently depending on whether a single finger, or multiple fingers are used simultaneously.

In one embodiment, at least one gesture enables a user to transition back in the data stream to add a tag while continuing to record the data stream. In one embodiment, at least one gesture recognized by the user interface causes a tag associated with the data stream to be deleted. In one embodiment, at least one gesture determines whether a tagged portion extends forward or backward from the tag. In one embodiment, at least one gesture recognized by the user interface causes a transition between different tagged portions of the data stream. In one embodiment, at least one gesture recognized by the user interface causes an ordering of different tagged portions of the data stream.

In one embodiment, at least one gesture recognized by the user interface causes an effect to occur while viewing the data stream. In one embodiment, at least one gesture recognized by the user interface causes a capture device operation (e.g., zoom, slow motion, etc.) to occur with respect to display of the data stream.

In one embodiment, processing logic optionally provides feedback to a user in response to each of the one or more gestures (processing block 2003). In one embodiment, the feedback occurs in real-time, i.e., there is a media feedback, to the user interface operator. In one embodiment, the feedback is in the form of displaying something on a screen (e.g., one or more banners) or other indications for the duration for the tag; displaying a timeline (e.g., a film strip that may show tagged duration (including backwards)), displaying a circle under a finger expressing a tag duration (including the pass), displaying vectors forward and backward indicating a number of seconds, displaying a timer showing a countdown, displaying one or more graphics, displaying screen flash, creating an overlay (e.g., dimming, brightening, color, etc.), causing a vibration of the capture device, generating audio, a visual presentation of a highlight, etc.

While recording, processing logic tags a portion of the stream in response to the system recognizing one or more gestures to cause a tag to be associated with the portion of the stream (processing block 2004). In one embodiment, the tag indicates a point of interest (e.g., a famous location) that appears in the video. In another embodiment, the tag indicates significance (e.g., forward, backward) with respect to the tagged portion of the data stream. In yet another embodiment, the tag indicates directionality of an action to take with the tagged portion of the data stream with respect to the tag location. The tag may specify that a portion of the stream is tagged from this point backward for a predetermined period.

In one embodiment, the capture device recording the streams could be different than a device recording the tags, or that the tags can be additive or subtractive from one stage to another. In one embodiment, where a single raw recording may generate multiple rough-cuts and final-cuts, the various tags generated by the various tagging devices associated with the various stages may generate multiple lists of corresponding tags.

In one embodiment, one of the tags signifies a tagged portion of the data stream is of greater significance than another of the tags. In one embodiment, the tag signifies a beginning of a tagged portion, wherein the tagged portion extends forward for a predetermined amount of time. In one embodiment, the tag signifies an endpoint of the tagged portion, wherein the tagged portion extends backward for a predetermined amount of time from when the tag occurred. In one embodiment, one or more gestures determine duration of the portion. In one embodiment, the tag signifies a midpoint within the portion of the data stream.

In another embodiment, tagging the stream comprises specifying an event that is to occur in the future, wherein specifying the event occurs prior to recording the data stream, and tagging the data stream while recording the data stream at the time of the event. In one embodiment, the event is based on time. In another embodiment, the event is based on global positioning system (GPS) information or location information associated with a map. In yet another embodiment, the event is based on measured data that is measured during recording of the data stream.

In one embodiment, tagging a portion of the stream occurs only after the one or more gestures and occurrence of one or more signals. In one embodiment, the one or more signals including one or more sensor related signals from sensors, such as those described above.

After tagging one or more portions of the stream, in one embodiment, processing logic performs editing of the real-time stream (processing block 2005). In one embodiment, the processing logic performs editing of the real-time stream while recording the real-time stream using tag information. In this manner, the tag is used for the subsequent creation of an edited version of the stream.

In one embodiment, the process further comprises logging information indicative of each gesture that is used (processing block 2006) and optionally performing analytics using the logged information (processing block 2007), optionally performing machine learning based on the logged information (processing block 2007), or optionally modifying a user interface for use in tagging the data stream based on the logged information.

The operations performed by a system may change based on the current context. For example, when tagging a data stream, a gesture may cause a particular operation to be performed. However, in the context of editing, that same gesture may cause the system to do a different operation or operations. Thus, in one embodiment, the process above includes adapting an effect of one or more gestures based on context. In one embodiment, the context is an event type. In one embodiment, adapting the effect comprises changing an amount of time associated with one or more tags associated with the data stream. In another embodiment, adapting the effect comprises changing an effect of one or more gestures with respect to a tag depending on whether the one or more gestures occurs during at least two of: recording, after recording but prior to viewing, during viewing, and during editing. In another embodiment, the process includes adapting an effect of one or more gestures based on a change in conditions. For example, a gesture made while the capture device is stationary may result in a highlight of certain duration while the same gesture made while the capture device is panning may cause a highlight of a different duration. As another example, a gesture made while watching a soccer game may result in a different highlight than the same gesture made while cycling.

In some embodiments, changes of context can happen within the recording of a session. For example, if a change in context is detected from walking to the ballpark to watching the game, the start time and length applied to tags may change, e.g. in baseball, extend the trailing time to allow tagging the batting moment, or extend the leading time to capture the play while tagging at the end of the play.

In one embodiment, the gestures can be used to pre-tag video based on sensor (e.g., GPS) or map data. For example, the user does not need to be involved in tagging if the system knows that it is near a “hot spot” and causes tagging to occur even without the user's input.

In one embodiment, the user interface described herein enables voice commands to be used.

FIG. 20B shows the same user interface gestures performed on a replay of the media after capture. Play back function 2010 replaces record function 2001. Also, there is no capability for editing the real-time stream of media 2005. And, using the player, the movie playback can be manipulated (e.g. fast-forward, fast-backward, scrub to a time) to get to the point of the movie where the user wants to apply new tagging. Otherwise, all the functionality for gesturing, effects, and user feedback are present.

Note that the play back may be on a different device than the original video or gesture capture. For example, if the gestures and the video are captured on a smart phone that is held in the users hand and has a touch screen. In one embodiment, the playback is on a personal computer, such as a laptop, without a touch screen. The gestures would then be different between the two. However, there is a logical and complete mapping of the gesture languages between the two devices.

The tagging device may be different than the device that is recording or processing the video. For example, the user may hold a remote control to perform the tagging. Such remote control may be a dedicated device (such as a camera remote trigger or a monitor or television remote) or a software connected device (such as a smart phone with an application to generate the gesture commands to be recorded alongside the capture or the viewing device)

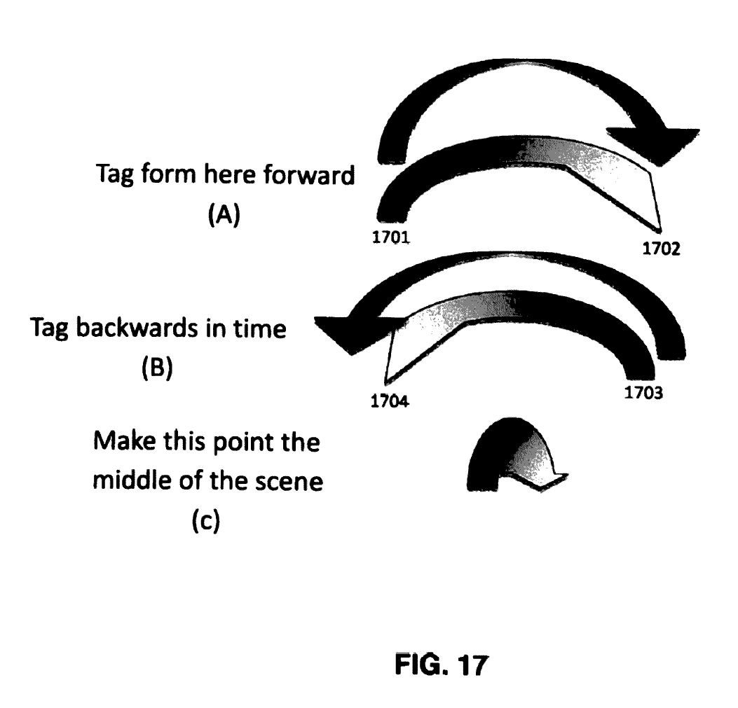

In one embodiment, user based manual input comprises the pressing of one or more buttons on the display screen to indicate a segment of interest to the user in the video stream. In one embodiment, the user based input for tagging comprises a user interface by which a user indicates the tagging location by pressing on the screen and performing simple motion. For example, the user may press a location on the screen indicating to the capture system (or viewing client) that a tagged event is occurring now, may press on the screen and drag their finger to the left to indicate to the capture system that a tagged event just ended, or may press the screen and draft their figure to the right to indicate to the capture system that a tagged event just started. Moreover, the relative length of the drag, and whether the user drags and lifts or drags and presses, may indicate to the system how long it should record such clip, FIG. 17 illustrates an example of thumb (or finger) tagging language. Referring to FIG. 17A, the user's thumb is pressed at point 1701 and moved forward to the right of location 1702 to indicate a particular segment being tagged where the segment starts where the thumb is initially pressed (or a predetermined amount before that location (e.g., 10 seconds of sides before that time) and the end of the tag going forward is at the point the thumb is lifted (or a predetermined amount of time (e.g., 10 seconds) after that point in the video segment. Similarly, in FIG. 17B, a user presses their thumb and moves it from point 1703 to the left to point 1704 to indicate that the segment to tag is from there back a certain amount of time (e.g., 20 seconds). Lastly, in FIG. 17C, a user presses their thumb on one point to indicate yet another tag in which the tagged segment extends both forward and backward from the point.

In one embodiment, tagging is performed automatically by a system. This may be based on external sensors, which include, but are not limited to: location; time; elevation (e.g., inflection point in elevation, inflection point in direction, etc.); G-Force; sound; an external beacon; proximity to another recording device; and a video sensor. The occurrence of each of these may cause content in the video to be tagged.

In another embodiment, the automated inputs create that tag events in the video stream capturing the activity are based on pre-calculated data. In one embodiment, the pre-calculated data is based on machine learning, other non-ML algorithms (e.g., heuristics), pre-defined scripts, a user's preference, a viewing preference, and/or group-based triggers. With respect to machine learning, manual inputs are applied based on previous behavior recorded into a machine learning system. These behaviors may be occurring during viewing and/or recording. With respect to pre-defined scripts defining pre-calculated data upon which to tag the video content, such scripts may come via importing (from others) or generating such scripts based on repeated actions (e.g., the same bike trip over and over again). Group-based trigger indicators are trigger indicators that are based on preferences of group (e.g., friends, family, like-minded users, location, age, gender, manual selection of user, manual selection of other users, analysis of other user's preference, “group leaders” and influencers, etc.), or trigger indicators that arise from relation between group members (e.g., two people coming close to one another may trigger a tag that will result in proximity-based highlight).

In one embodiment, tagging is performed based on adaptive and dynamic configuration of an auto-tagger. For example, the context is identified and thereafter a remote server (e.g., a cloud device) or other device configures the device dynamically.

In one embodiment, the user based manual inputs comprise of multiple types of inputs that function as a tagging language to identify segments of the video stream of interest to the user. In one embodiment, the multiple types of inputs include where the inputs can be more specific instructions, such as in cases, for example, a point of interest, directionality (e.g., the left side of me, the right side of me), importance (e.g., importance by levels, importance by ranking (e.g., a star system), etc.) and tagging someone else video (in case of multiple inputs). In another embodiment, the multiple types of inputs include where the input can be via several buttons (soft or hard) or a different sequence of pressing a single button (e.g., pressing a button a long time, pressing a button multiple times (e.g., twice)).

In one embodiment, the user input to cause tagging is an audio manual input. For example, the user may press a key to cause an audio input to be generated and that audio input causes content in the video to be tagged.

FIG. 31 is a flow diagram of one embodiment of a process for using gestures while recording a stream to perform tagging. The process is performed by processing logic that may comprise hardware (circuitry, dedicated logic, etc.), software (such as is run on a general purpose computer system or a dedicated machine), firmware, or a combination of these three.

Referring to FIG. 31, the process begins by processing logic recording the stream on a media device (processing block 3101). In one embodiment, recording the real-time stream with a media device comprises recording the real-time stream as soon as an application has been launched, the application for performing recognition of the one or more gestures or for associating tags with the real-time stream. In one embodiment, the real-time stream contains a video. In one embodiment, the device comprises a mobile phone.

While recording the stream, processing logic recognizes one or more gestures (processing block 3102). In one embodiment, the gestures may be made with respect to the media device playing back the stream, such as gestures made on or by a display screen of the media device. In another embodiment, the gestures are made and captured by a device separate from the media device playing back the video stream.

In one embodiment, at least one of the one or more gestures is performed by a user with one hand while holding the media device with the one hand. In one embodiment, at least one of the one or more gestures is performed without requiring a user to view the screen of the media device. In one embodiment, at least one of the one or more gestures is performed by in relation to the screen surface of the media device and performing a single motion.

In one embodiment, at least one of the one or more gestures comprises one selected from a group consisting of: a single tap on a portion of the media device, a multi-tap one a portion of the media device, performing a gesture near or on a screen of the media device for a period of time, performing a gesture near or on a screen of the media device and swiping left, right, up or down, swiping back and forth, moving at least two user digits in a pinching motion with respect to the screen of the media device, moving an object along a path with respect to the screen of the media device, other multi finger, tilting the media device, covering a lens of the media device, rotating the media device, controlling a switch of the media device to change the media device into a silence mode, shaking the media device, tapping different areas of a device, and using one or more voice commands. In another embodiment, one of the one or more gestures enables a user to transition back in the data stream to add a tag while continuing to record the data stream. In one embodiment, another gesture recognized by the user interface causes a tag associated with the data stream to be deleted. In one embodiment, the one or more gestures determines duration of the portion. In one embodiment, the one or more gestures determines whether the portion extends forward or backward from the tag. In one embodiment, another gesture recognized by the user interface causes a zoom operation to occur with respect to display of the data stream. In one embodiment, another gesture recognized by the user interface causes a transition between different tagged portions of the data stream. In one embodiment, another gesture recognized by the user interface causes an ordering of different tagged portions of the data stream. In one embodiment, another gesture recognized by the user interface cause an effect to occur while viewing the data stream.

In response to recognizing the one or more gestures, processing logic tags a portion of the stream to cause a tag to be associated with the portion of the stream, the tag for use in specifying an action associated with the stream (processing block 3103). In one embodiment, the tag identifies a physical point of interest, where the tag correlates to a point in the data stream. In one embodiment, the tag indicates significance of the portion of the data stream. In one embodiment, the tag indicates a direction to transition in time with respect to the data stream to enable an action to take place with the portion of the data stream. In one embodiment, one of the tags signifies a tagged portion of the data stream is of greater significance than another of the tags. In one embodiment, the tag signifies a beginning of the portion, wherein the portion extends forward for a predetermined amount of time. In one embodiment, the tag signifies an endpoint of the portion, wherein the portion extends backward for a predetermined amount of time from the tag. In one embodiment, the tag signifies a midpoint within the portion.

In one embodiment, tagging the stream comprises tagging the stream with a first tag while recording the stream and tagging the stream with a second tag while recording the stream, viewing a recorded version of the stream or while editing the stream. In another embodiment, tagging a portion of the stream occurs in response only after the one or more gestures and occurrence of one or more signals. In such a case, in one embodiment, the one or more signals includes one or more of: GPS, accelerometer data, time of day, barometer, heart monitor, and eye focus sensor.

In one embodiment, tagging the stream comprises specifying an event that is to occur in the future, where specifying the event occurs prior to recording the data stream, and tagging the data stream while recording the data stream at the time of the event. In such a case, in one embodiment, the event is based on time. In such a case, in another embodiment, the event is based on global positioning system (GPS) information or location information associated with a map. In such a case, in yet another embodiment, the event is based on measured data that is measured during recording of the data stream.

In one embodiment, processing logic also performs one or more actions or causes one or more effects based on the tag (processing block 3104). This is optional. The actions or effects may occur while recording or after recording the stream. In one embodiment, one additional action performed by the processing logic includes using tag information to access a previously captured portion of the real-time stream, perform editing on the previously captured portion of the real-time stream, remove a tag associated with the previously captured portion of the real-time stream, and interact with the previously captured portion of the real-time stream while recording the real-time stream. In such case, in one embodiment, the process further includes returning to viewing the real-time stream that is being currently captured after using the tag information. In one embodiment, one additional action performed by the processing logic includes logging information indicative of each gesture that is used. In one embodiment, one additional action performed by the processing logic includes performing analytics using the logged information. In one embodiment, one additional action performed by the processing logic includes performing machine learning based on the logged information. In one embodiment, one additional action performed by the processing logic includes modifying a user interface for use in tagging the data stream based on the logged information. In one embodiment, one additional action performed by the processing logic includes providing feedback to a user in response to each of the one or more gestures. In one embodiment, one additional action performed by the processing logic includes adapting an effect of one or more gestures based on a change in conditions.

In one embodiment, one additional action performed by the processing logic includes adapting an effect of one or more gestures based on context. In such a case, in one embodiment, the context is an event type. Alternatively, in such a case, in one embodiment, adapting the effect comprises changing an amount of time associated with one or more tags associated with the data stream. Alternatively, in such a case, in another embodiment, adapting the effect comprises changing an effect of one or more gestures with respect to a tag depending on whether the one or more gestures occurs during at least two of: recording, after recording but prior to viewing, during viewing, and during editing.

In one embodiment, one additional action performed by the processing logic includes stopping at least a part of the real-time stream recording in response to positioning of the media device in a first position.

### Additional Editing Operations

There are a number of alternative embodiments with respect to the editing that is performed on different video streams.

In one embodiment, editing comprises recording an “interest level” associated with each highlight. This is useful for a number of reasons. For example, if a video needs to be changed in size (e.g., reduced in size, increased in size), information regarding the interest level of different portions of the video may provide insight into which portions to add or remove or which portions to increase or reduce in size. That is, based on external criteria, the editing process is able to modify the video stream.

In one embodiment, editing comprises reducing a physical resolution of portions of the video stream that are not associated with tags. In one embodiment, editing comprises inserting tag points into the video stream. The tag points indicate a segment of the video that has been tagged, either manually or automatically.

In one embodiment, the editing includes combining multiple camera angles (multiple sources) into a single video stream. This editing may include automated video overlapping and synchronization of multiple events (e.g. same location, same time, same speed, etc.).

In one embodiment, editing comprises reordering highlights, including and excluding highlights, selecting and applying transitions between highlights, and/or applying NLE (Non Linear Editing) techniques to create edited video content.

In one embodiment, the editing includes overlaying information on the video (e.g., a type of viewpoint), such as, for example, speed, location, name, etc.

In one embodiment, the editing includes adding credits, branding, and other such information to a video version being generated.

### Human Moments and Highlights

Traditional movie editing is focused on time. The movie starts at some point and contains a collection of scenes that have an extent and order. Significant effort is required of the editor, even with state-of-the-art software, to select and trim the clips that go into a movie and to organize them seamlessly on a timeline. Given this effort, it is unusual for this movie to be edited more than once. Thus, in such cases, the viewer only watches the one edited final cut version of the movie.

Likewise, traditional movie playback is based on time. The viewer may navigate the movie by skipping forward or reverse in time, scrubbing in time, or fast-forward and reverse in time.

However, the human viewer and the human editor do not think in time. They think in memories, or moments, that they want to view or portray. The order of appearance of these moments is implied from the context or storyline, e.g. a chronological account of events may imply chronological ordering and a best-of compilation (such as 10 fastest ski runs) may imply ordering by some measurable quantity (such as speed). They may want to include these moments and navigate based on these moments. The embodiments of this system automatically create highlights that map to the moments or memories that people what to present and view. This automatic highlight generation combines a number of signals (described above) to better map the high points of a person's experience as opposed to time.

Libraries of highlights are created over time by an individual, a family, or an affinity group. Each highlight contains time, duration, and pointers to representative media (multiple viewpoints of video, audio, still imagery, annotation, graphics, etc.). More importantly, each highlight can have context created by signals and other content. For example, each highlight can have location, acceleration, velocity, and so on. Each highlight can have descriptors and other information that help organize them by context and theme.

Given these libraries of highlights, editing of a movie for a human becomes more of a search task than a temporal video editing task. For example, an editor (and more interestingly a viewer) can search for the highlights of an activity, or of a day, or a “best of” list for a type of activity (e.g. best snowboard jumps, best family moments), or any other of a number of searches. The results of these searches are collections of highlights or highlight lists.

Each highlight list can be presented as a “movie”. In one embodiment, the automated presentation of this highlight list includes a subset of the highlight list that fit in the target duration (set by, for example, the viewer or by algorithm) and “tell the best story” (with a beginning, middle, and end and highlights that show representative portions of the story).

Given that each “movie” is created by searching over the available highlights and other viewer selected parameters, it is appropriate to expand the concept of “final cut movie” to “viewer cut movie”. Each movie is potentially an ephemeral creation of the viewer interacting with the system at a given moment. Changes in search or other parameters potentially yield different movies. Below are descriptions of how a viewer can take advantage of the highlight based viewer cut movies for more intuitive and simplified navigation and editing.

In one embodiment, a viewer cut movie is a final cut movie automatically created by searching and collecting highlights and setting parameters on the movie viewing (e.g. target duration).

### Playback Navigation Operations

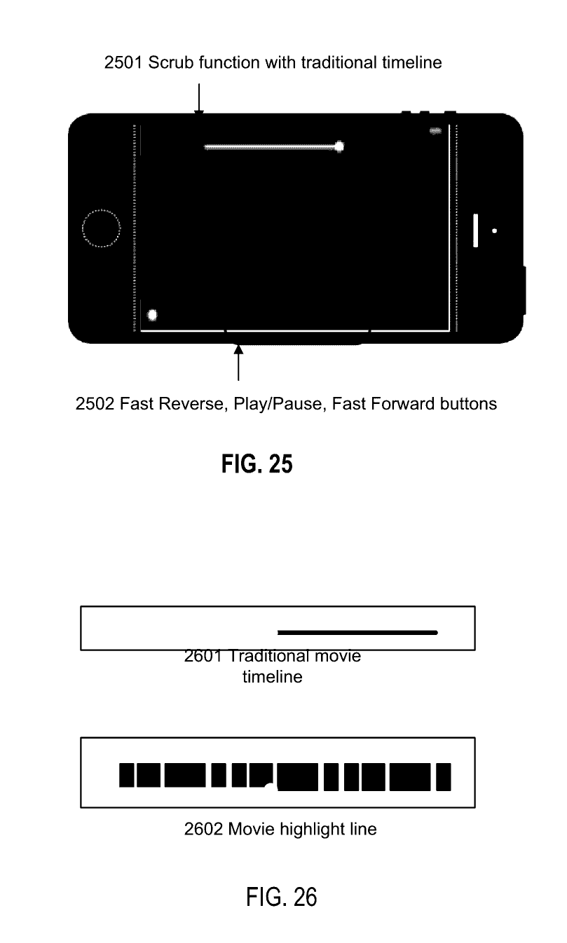

In traditional movie players (see FIG. 25) affordances are made for fast-forward (fast-reverse) with one or more speeds, or skip forward (skip reverse) by one or more time increments (e.g., 10 seconds, 30 seconds), or scrub forward (scrub reverse) along a timeline. This control is all linear-time-based with a single movie. In embodiments, the discrete nature of the highlights can be exploited for navigation. That is, the system has knowledge of the time extent of each individual highlight which creates the affordance of highlight-based navigation that better matches the recollection modality of the human being, which is much more anecdote-based than temporal. Essentially, the viewer cut movies are a sequence of highlights combined with appropriate transitions and annotation(s). Highlights are often of different durations. With the knowledge of the highlights, highlight order, and highlight duration, the system enables the user to navigate forward or reverse by one or more highlights.

In some embodiments, the fast-forward and reverse, skip-forward and reverse, and/or scrub functions cause fast, skip, and/or scrub across highlights rather than time. In some embodiments, a swipe to the left skips forward and starts playing the next highlight. Likewise, a swipe to the right skips reverse and starts playing the previous highlight. These functions work in the full screen player mode (where there are no markings over the video screen) as well as in the instrumented player mode (where affordances like, for example, the scrub timeline, play/pause button, and fast forward and fast reverse buttons are visible).

In one embodiment, a gesture such as double tap on the right side causes fast forward where only a few frames of each highlight is played before moving to the next. Double tap on the left side causes fast reverse where only a few frames of each highlight are played before moving to the previous highlight. These functions work in the full screen player mode (i.e. the movie takes the entire screen area of the device with no overlays) as well as in the instrumented player mode (i.e. where the movie has an overlay with control buttons and sliders and information). In some embodiments, the fast forward and fast reverse buttons in the instrumented mode forwards or reverses the movie by highlight increments, rather than time, displaying only a few, or no, frames per highlight before going to the next highlight.

FIG. 26 shows the traditional timeline 2601 that is commonly used for the traditional scrub function. Referring to FIG. 26, the highlight line 2602 shows a depiction of not only time but also individual highlights. In one embodiment, a common scrub gesture (holding down and moving along the highlight, not time, line) moves between highlights. In this case, the scrubbing position aligns the movie position to the beginning of a highlight. In one embodiment, this function requires the instrument mode with a representation of the movie indicating highlights.

A movie may be generated by re-encoding all the highlights, there creating a new single contiguous movie. Alternatively, a movie playback may actually be achieved by playing a number of movie clips (from raw, rough, or final cut) one after another. In either case, all of the above embodiments of navigational operations are employed.

In one embodiment, the user is presented the option of performing the fast forward and reverse, skip forward and reverse, and/or scrub functions along either the timeline or the highlight line. In one embodiment, the gestures for the timeline are different than the gestures for the highlight line. In one embodiment, the user selects which line (timeline or highlight line) to use either in profile presets or with a button selector.

In one embodiment, the difference between playback tagging and playback navigation is by user choice. In one embodiment, the user selects the instrumented for playback tagging and the normal viewing mode for navigation. In some embodiments, the gestures are specific for tagging or navigation. In one embodiment, the result of any tagging gesture causes some tagging feedback while the result of a navigation gesture is simply to navigate to that point.

In one embodiment, all of the navigational operations of the viewer (or stakeholder) are recorded as analytics and used by various machine learning algorithms to improve the automated presentation of viewer cut movies.

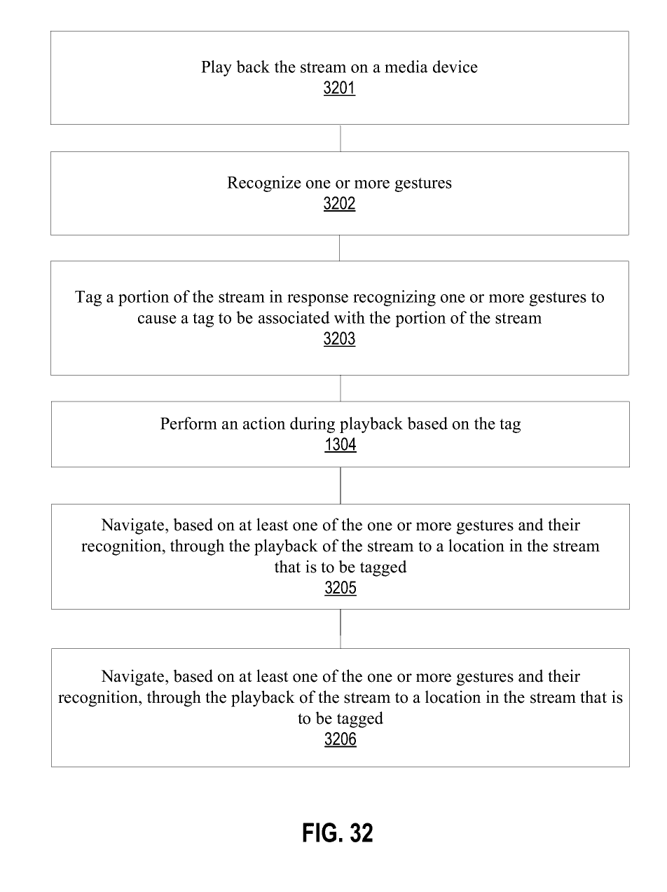

FIG. 32 is a flow diagram of one embodiment of a process for using gestures during play back of a media stream. The process is performed by processing logic that may comprise hardware (circuitry, dedicated logic, etc.), software (such as is run on a general purpose computer system or a dedicated machine), firmware, or a combination of these three.

Referring to FIG. 32, the process begins by processing logic playing back the stream on a media device (processing block 3201).

While playing back the stream, processing logic recognizes one or more gestures (processing block 3202). In one embodiment, the gestures may be made with respect to the media device playing back the media stream, such as gestures made on or by a display screen of the media device. In another embodiment, the gestures are made and captured by a device separate from the media device playing back the video stream.

In response to recognizing the one or more gestures, processing logic tags a portion of the stream in response recognizing one or more gestures to cause a tag to be associated with the portion of the stream (processing block 3203).

In one embodiment, processing logic also performs an action during playback based on the tag (processing block 3204). This is optional.

Also, in one embodiment, processing logic navigates, based on at least one of the one or more gestures and their recognition, through the playback of the stream to a location in the stream that is to be tagged (processing block 3205). This is also optional. In one embodiment, navigating through the playback of the stream, based on at least one of the one or more gestures, comprises performing one or more of fast forward or reverse, skip forward or reverse by one or more time increments, or scrub forward or reverse along a timeline.

In response to recognizing the one or more gestures, processing logic causes an effect to occur while viewing the stream (processing block 3206). This effect may be any number of effects, including, but not limited to, a camera effect, a visual effect, etc.

### Non-Temporal Editing

Traditional movie editing systems require the user to manually navigate the raw movie, determine the clips and the trim (beginning and end of the clips), arrange them temporally, and set the transitions between the clips. In one embodiment, the clips, trim, and transitions are automatically determined or are determined in response to simple manual tagging gestures.

In one embodiment, the viewer cut movies are generally time constrained. In one embodiment, time constraints such as desired duration, maximum duration, number of highlights, etc., are set by the stakeholder (e.g., originator, editor, viewer) as a default, for each movie, for different types of movie, per sharing outlet (e.g. 6 seconds Vine, 60 seconds Facebook), target viewer, etc. In some embodiments, the time constrains are machined-learned based on the viewing actions (e.g., how long before the viewer quits the movie) of the viewer.

In many cases, there are far more highlights detected that can fit within the time constraints. For example, there might be 120 seconds of highlights with a final cut movie might be limited to 30 seconds. In one embodiment, the existence of additional and/or alternate highlights is presented to the viewer, for example, with an on-screen icon.

In one embodiment, the user is given the affordance to remove (demote) highlights from the final cut. In one embodiment, a swipe up gesture signals the system that the current highlight is to be removed.

In one embodiment, the user is given the affordance to add (promote) highlights into the final cut. In one embodiment, a visual display of highlight thumbnails representing available, but not included, highlights is offered. The user selects the highlight(s) to be included in the final cut by touching the thumbnail.

In one embodiment, the highlight thumbnail is a still image from the highlight and one can play part or all of the highlight by interacting with the thumbnail (e.g. touching it briefly or swiping the finger across it). In some embodiments, the highlight thumbnail is a movie depiction of the highlight.

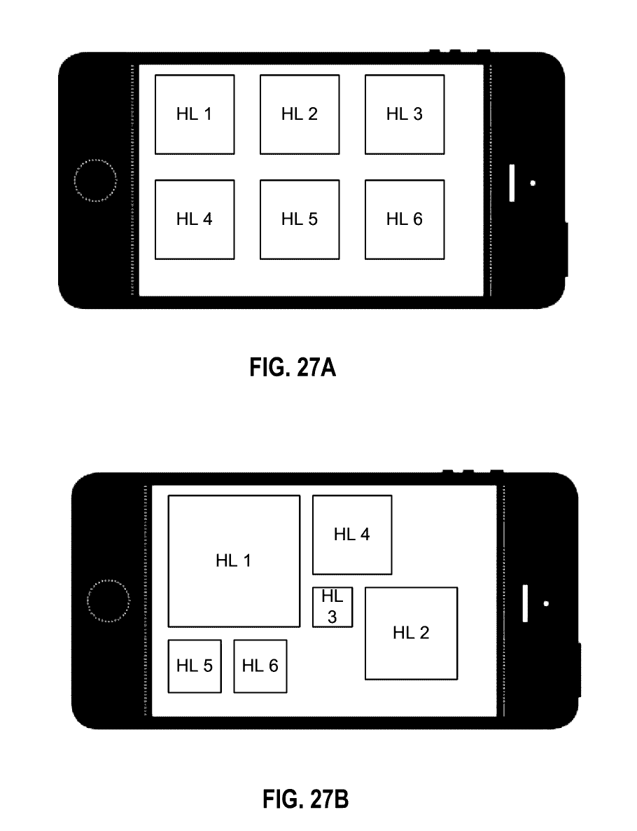

In one embodiment, the highlight thumbnails are arranged in a regular array as shown in FIG. 27A. In one embodiment, the highlight thumbnails are arranged in an irregular array and are different sizes. The differences in sizes are random in some embodiments while in another embodiment the larger size represents a more important (e.g., higher relative score). In one embodiment, the user can scroll through a number of highlights when there are too many to put on the screen.

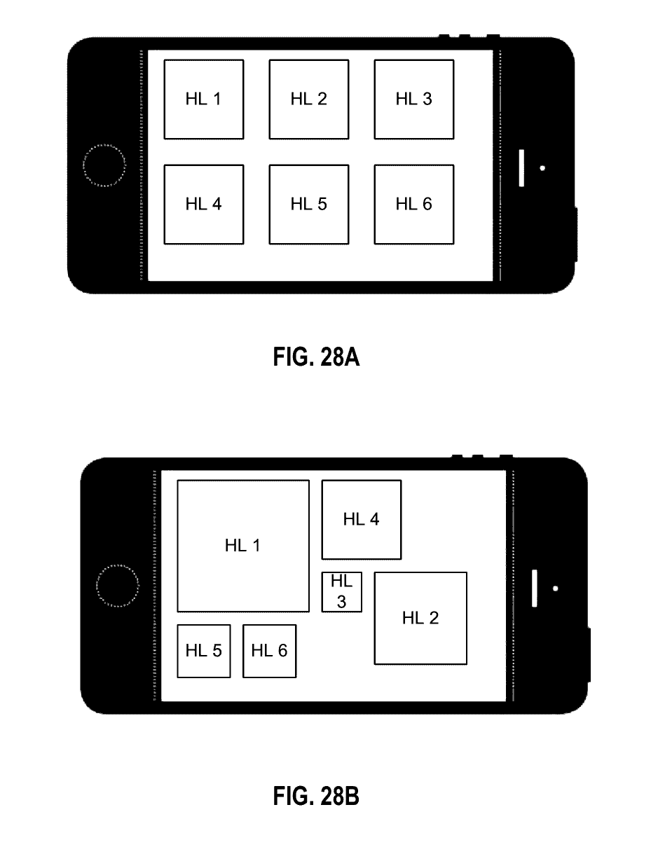

In one embodiment, both the “included” and the “available but not included” highlights are presented, as shown in FIGS. 28A and 28B. In one embodiment, the “included” highlights are slightly saturated in color (faded), grey level rather than color, surrounded in a boundary, and/or some other visually distinguishing characteristic. In other embodiments, it is the “available but not included” highlights that have the visually distinguishing characteristic. In one embodiment, the user can touch the highlight to change its status (i.e. included to not included or not included to included).

In one embodiment, a swipe down gesture during the playback of a movie launches the promotion (or promotion/demotion) page of highlights. In one embodiment, the page of highlights is presented at the conclusion of playing the movie.

In one embodiment, all of these operations of the viewer (or stakeholder) are recorded as analytics and used by various machine learning algorithms to improve the automated presentation of final cut movies.

### Portscape™

Embodiments below compensate for rotation of the capture device by using sensor data (of any kind) to continuously determine the device orientation and apply appropriate compensation to the recorded frames, saved frames, and/or preview. So for example, if the preferred orientation of the video is landscape right, regardless of whether a certain part of the video is filmed in landscape right, landscape left, portrait up or portrait down, the resulting video will show up in landscape right. The below embodiments employ different methods to compensate for differences in resolution and angle of view.

A well-known best-practice in movie capture is to compose the video with a landscape orientation (that is the long edge of the frame parallel with the horizon of the shot, usually the earth itself). An example of such is HD video where the ratio between the horizontal length and the vertical height 16 to nine. Another well-known aspect ratio for video capture devices is portrait orientation where the vertical is longer than the horizontal. Dedicated digital video cameras, like the film and tape cameras before them, are usually designed to be held and operated in landscape orientation. Many of these cameras were purposefully designed to be awkward to hold and operate in a portrait orientation. A smart phone device is not a dedicated video capture camera. Smartphones were designed primarily as phones and PDA (Personal Digital Assistance) devices, and as such are designed to be held comfortably in portrait orientation. Smart phones are capable of video capture in either portrait or landscape orientation and most video capture applications enable both options. However, the playback devices (e.g., computer screens, television screens, movie screens) are in many cases optimized to a single landscape orientation and thus the viewers will see a rotated video or a narrow vertical strip showing the video, surrounded by wide black margins. Both these outcomes are not desirable. To overcome this problem, there are some applications (e.g., YouTube Capture) that specifically detect the phone orientation and disallow capture while in portrait perspective.

In one embodiment, the ability to hold the phone in the different orientations is turned into a useful user interface, by mapping the pixels captured in landscape right, landscape left, portrait up, or portrait down orientation to a raw, rough, and/or final cut movie with one orientation, for example landscape right. The orientation and changes in orientation of the smart phone are detected by the embedded hardware and software interface. Therefore, regardless of whether the user holds the smart phone in any of the landscape or portrait orientations, a single orientation movie is captured as a result, using the preferred orientation (typically landscape but potentially portrait as well). Furthermore, the user can shift between the two orientations and the smart phone detects and compensates for the change. Finally, with the technique described herein, the preferred orientation is offered to the display as a preview of the movie capture.

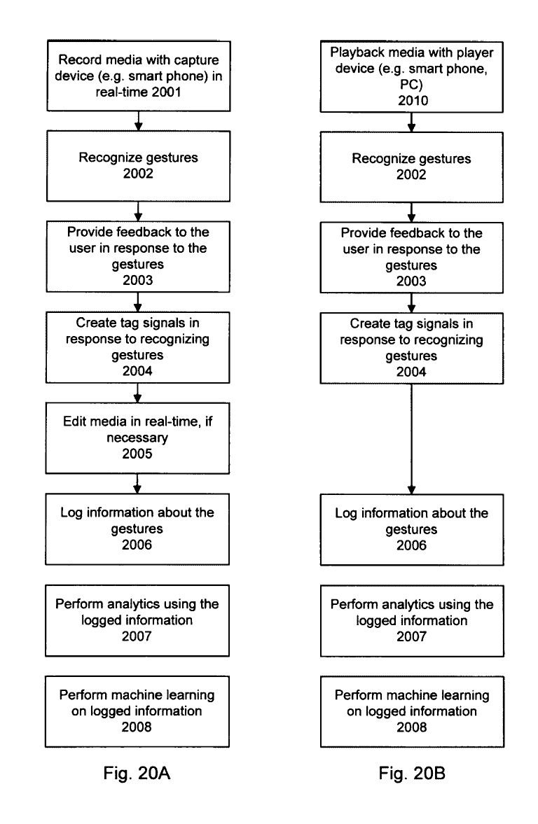

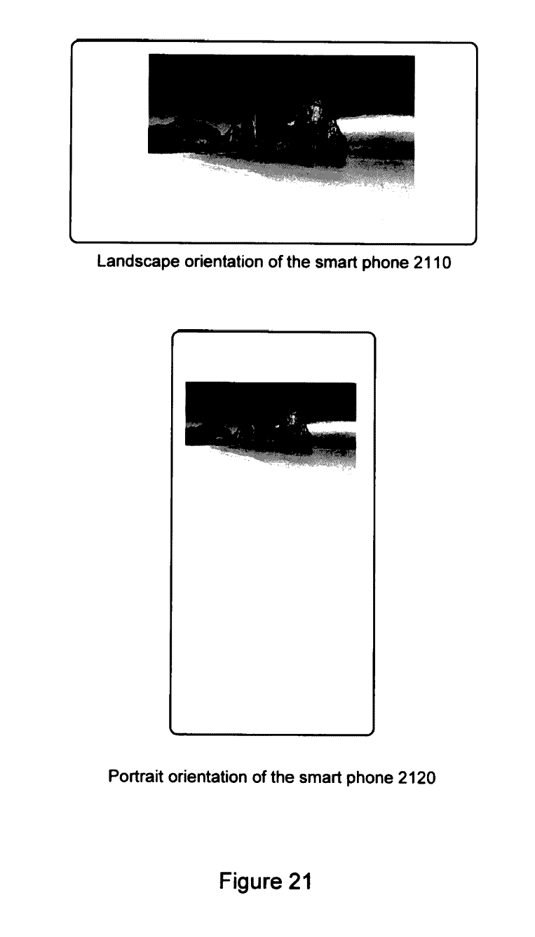

FIG. 21 shows the user preview of the movie capture. In some embodiments, when the phone is held in landscape orientation 2110 the video appears naturally, perhaps filling the entire screen. When the phone is held in (or rotated to) portrait orientation 2120, the preview appears right side up in landscape on a portion of the screen. This preview suggests to the user exactly what is being captured at the moment from the point of view of the final cut. In one embodiment, when the phone is in landscape orientation, the preview has the same size on the screen (using only a portion of the screen) as the portrait orientation preview. In one embodiment, the preview suggests that the size is the same regardless of the phone orientation.

Similarly in one embodiment when the phone is held in portrait orientation the video appears naturally, perhaps filling the entire screen. When the phone is held in (or rotated to) landscape orientation, the preview appears right side up in portrait orientation on a portion of the screen.

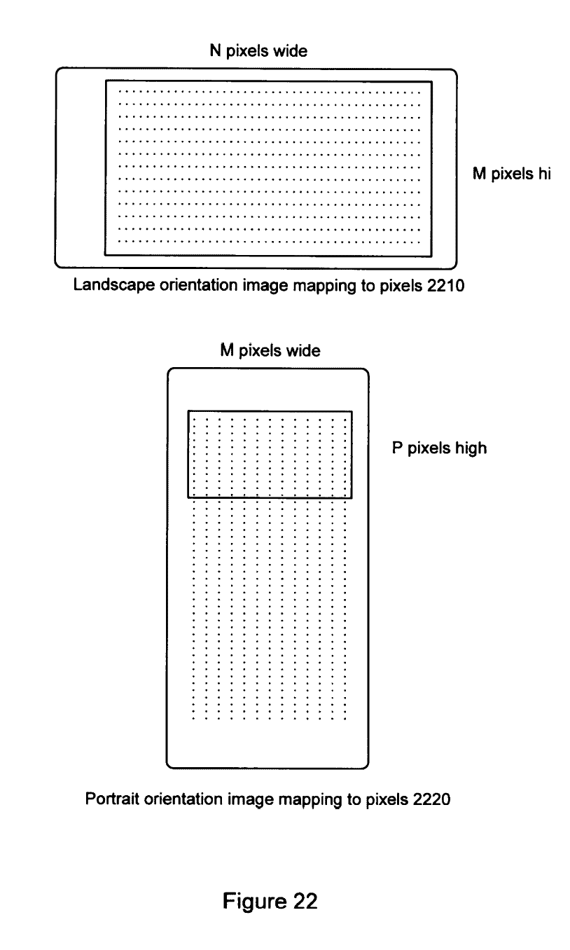

FIG. 22 shows one embodiment of the pixels or samples of the image created by projecting the image on the smart phone's video sensor. There are a number of different video capture sensors that may be used in a modern smart phone. With most video capture sensors, there are regular well-known handling of the sensor data that creates an N wide (long edge) by M high (short edge) array of square regularly arranged pixels. In FIG. 22, landscape orientation 2210 shows the use of the entire N×M pixel array. In the portrait orientation 2220, however, only a subset of the pixels are used. Now the image is M pixels wide and P pixels high. To preserve the aspect ratio of the landscape mapping in the portrait orientation, the new height needs to maintain the same aspect ratio as before (of N:M) and thus P=M*M/N=M̂2/N.

In one embodiment, the landscape-captured image is resolution reduced from N×M to M×P using well-known techniques (e.g. cropping). In this way, the movie has a continuous resolution regardless of the capture orientation. In one embodiment, the portrait-captured image resolution is matched with the original highest capture resolution. This is done by digitally upsampling the M×P image into a N×M one. Note that such sampling techniques are well known to one familiar with the art (e.g. bilinear, bi-cubic spline). The choice of the appropriate up or down sampling can be done depending on the nature of the content as well as the software and hardware tools available by the system.

The above embodiments share the same property: a landscape window is generated from a portrait-captured image or video and is cropped and rotated providing a zoomed and correctly oriented region of the image at the same resolution of the original captured landscape mode. Thus, the portrait-captured image (or video) uses a subset of the pixels, and therefore as smaller angle of view, compared to the landscape-captured image (or video). In effect, the portrait-captured image is zoomed in with respect to the landscape-captured image.

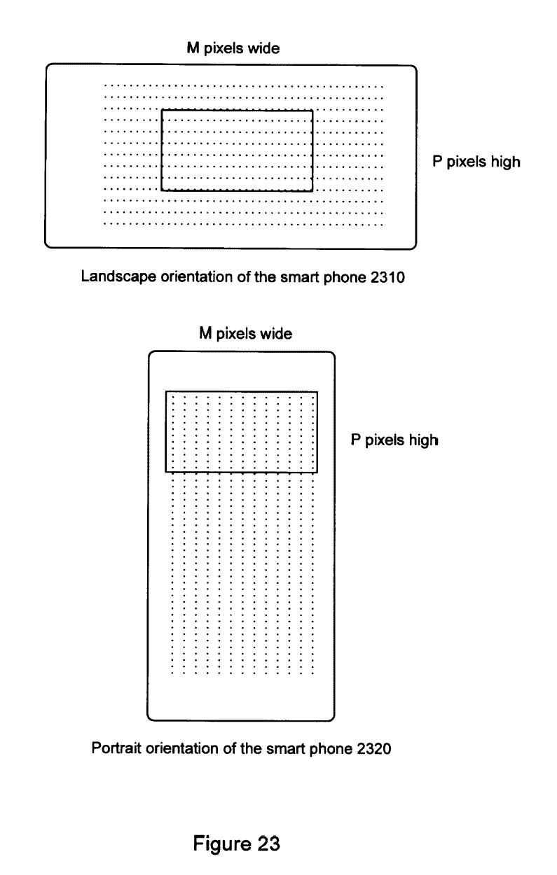

FIG. 23 shows a different embodiment. The landscape-captured image or video is cropped to the M×P size as is the portrait-capture image. In this embodiment, the resolutions are the same and the image area are the same and the angle of view is the same. Therefore, no resolution reduction or enhancement is necessary and there is no zoom effect.

Note that in all of the above embodiments, neither dimension (width or height) need use the full extent of the image sensor. Also, any resolution can be achieved with resolution reduction and/or enhancement of both landscape and portrait-captured images.

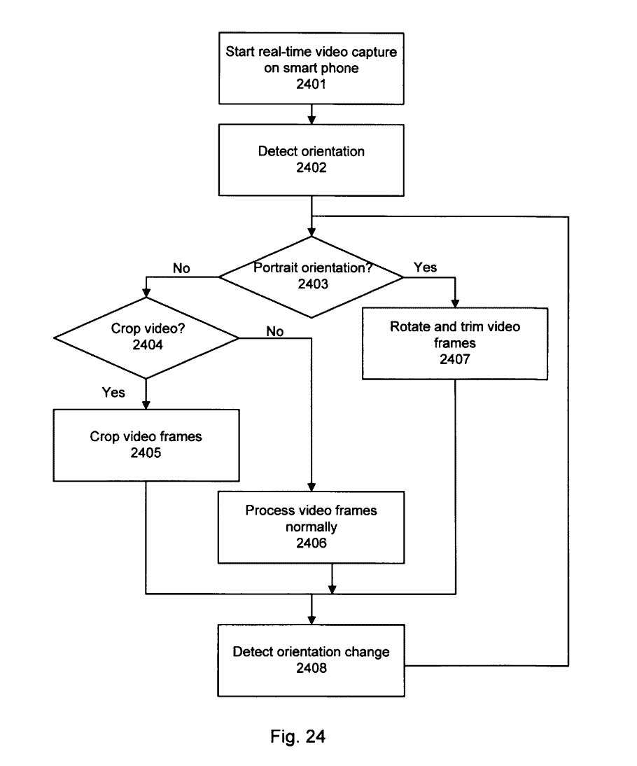

FIG. 24 shows the flow for the Portscape™ embodiments. Using a smart phone, the video capture is started 2401. The smart phone detects the orientation 2402. If the orientation is portrait (2403 yes) then each video frame is rotated and cropped according to the above description 2407. If the orientation is landscape (2403 no) then, if the landscape setting is in crop mode (2404 yes) each video frame is cropped according to the above description 2405. If the landscape setting is in full frame mode (2404 no) then each from is handled normally.

All of these video handling operations continue until a change in orientation is detected or the video capture is ended. If the orientation changes, the system is set back to 2403 and progresses from there.

During the change in orientation, special visual treatment may be applied to on the preview screen in order to make the transition appear continuous and smooth.

The determination as to when to perform the rotation and sampling is based on the configuration of the system and sensor data that determines the orientation. In one embodiment, the rotation and upsampling 2407 is done prior to storing the video stream on a persistent memory. In yet another embodiment, the system stores the orientation information that notes the change of orientation and the actual rotation 2407 and upsampling can be done at later stages of the processing, such as at playback time or when clips are extracted

When the user switches orientations from one to the other, there is a noticeable transition stage that can be part or a few seconds long. In one embodiment, the system can also be instructed to create a more pleasing transition by removing the portion where the image was rotated or smoothly dissolves between the two.

In many embodiments, the preview image (video) on the display screen is processed to provide the user with the sense of what is being capture. This is independent of the embodiments that process for persistent storage or create tags for later processing. For the preview image (video) each single frame is rotated, cropped, resolution enlarged or reduced, and translated as necessary to provide the preview shown in FIG. 21. In some embodiments, the portrait preview will show the zoom effect created by the image mapping shown in FIG. 22.

In one embodiment, the raw video is corrected for orientation and/or scale before saving to a file or memory. Thus, the file will be orientation corrected for rotations of plus or minus 90 degrees via this pixel mapping between landscape and portrait capture orientation. Similarly, the raw video is corrected for rotations of 180 degrees (e.g. portrait to upside down portrait or landscape to upside down landscape) before the raw video is saved. In one embodiment, the raw video is not corrected. In such an embodiment, the orientation is saved as metadata and used to correct the orientation when extracting clips (rough or final cut) or when playing the video. In one embodiment, the viewer is never presented with a video that is upside down or sideways.

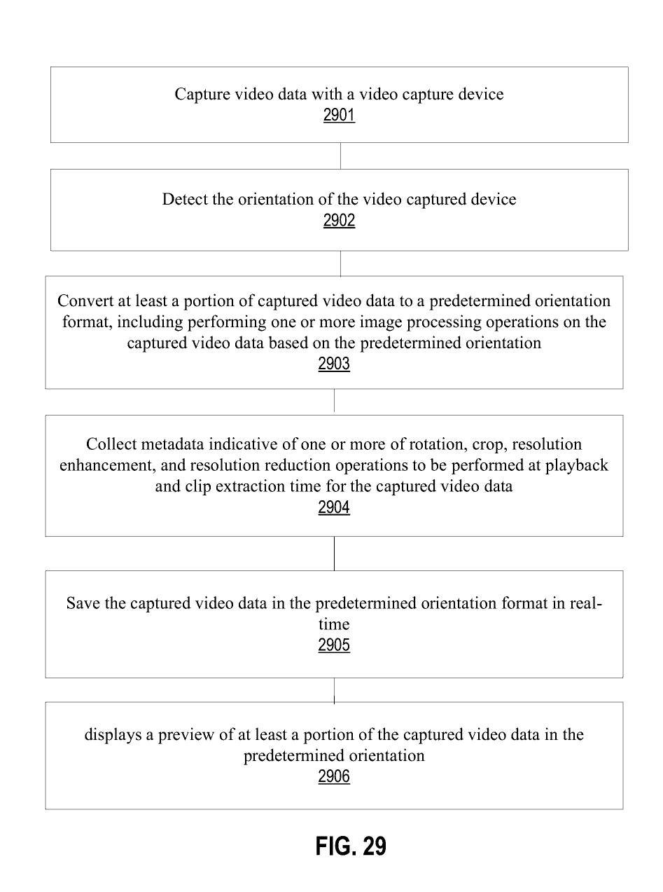

FIG. 29 is a flow diagram of one embodiment of a process for processing captured video data. The process is performed by processing logic that may comprise hardware (circuitry, dedicated logic, etc.), software (such as is run on a general purpose computer system or a dedicated machine), firmware, or a combination of these three.

Referring to FIG. 29, the process begins by capturing video data with a video capture device (processing block 2901). In one embodiment, the video capture device comprises a smart phone. In one embodiment, capturing the video data occurs in real-time.

Processing logic detects the orientation of the video captured device (processing block 2902).

Next, processing logic converts at least a portion of captured video data to a predetermined orientation format, including performing one or more image processing operations on the captured video data based on the predetermined orientation (processing block 2903). In one embodiment, this conversion is based on the detected orientation.

In one embodiment, processing logic collects metadata indicative of one or more of rotation, crop, resolution enhancement, and resolution reduction operations to be performed at playback and clip extraction time for the captured video data (processing block 2904). This information is saved in a memory for later use.

Processing logic saves the captured video data in the predetermined orientation format in real-time (processing block 2905).

Processing logic also displays a preview of at least a portion of the captured video data in the predetermined orientation (processing block 2906). In one embodiment, displaying a preview of at least a portion of the captured video data in the predetermined orientation comprises displaying a cropped portion of the captured video data to appear as if captured with a panning effect.

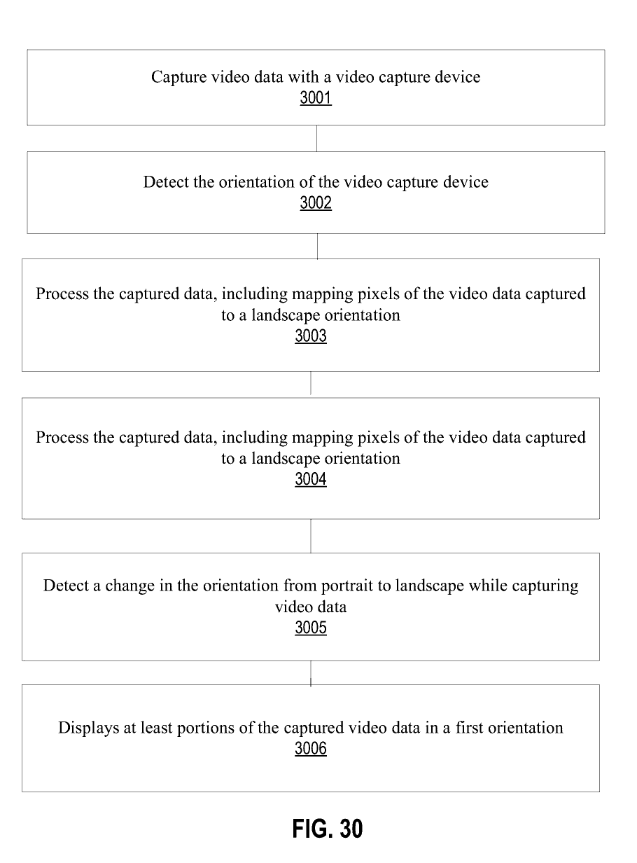

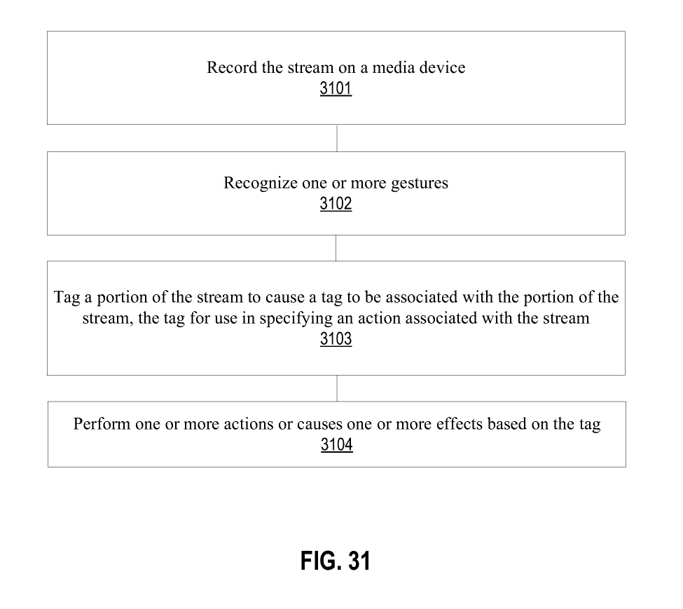

FIG. 30 is a flow diagram of one embodiment of a process for processing captured video data. The process is performed by processing logic that may comprise hardware (circuitry, dedicated logic, etc.), software (such as is run on a general purpose computer system or a dedicated machine), firmware, or a combination of these three.

Referring to FIG. 30, the process begins by capturing video data with a video capture device (processing block 3001). In one embodiment, the video capture device comprises a smart phone.

Next, processing logic detects the orientation of the video capture device (processing block 3002). In one embodiment, detecting orientation of the video capture device occurs while capturing the video data. The detection may be performed using sensors on the video capture device. In one embodiment, the landscape orientation is either landscape left or landscape right and the portrait orientation is either portrait up or portrait down.

If the video capture device is determined to be in a portrait orientation, then processing logic processes the captured data, including mapping pixels of the video data captured to a landscape orientation (processing block 3003). In one embodiment, if the video capture device is in portrait orientation, then the processing performed by processing logic includes downsampling captured video data to reduce a number of pixels in frames of the captured video data when capturing in landscape to match a number of pixels in frames of video data captured. In one embodiment, if the video capture device is in portrait orientation, then the processing performed by processing logic includes rotating and cropping video frames of the video data captured by the video capture device. In one embodiment, the captured video data after cropping has an aspect ratio equal to the aspect ratio of the captured video prior to cropping

If the video capture device is determined to be in a landscape orientation, then processing logic processes the captured data, including mapping pixels of the video data captured to a landscape orientation (processing block 3004). In one embodiment, if the video capture device is in landscape orientation, then the processing performed by processing logic includes creating a zoomed out effect for captured video data in response to detecting the orientation has been changed from portrait to landscape, the zoomed out effect being based on use of a smaller angle of view when capturing video data with the video capture device in the portrait orientation than the angle of view when capturing video data. In one embodiment, if the video capture device is in landscape orientation, then the processing performed by processing logic includes upsampling captured video data to increase a number of pixels in frames of the captured video data to match a number of pixels in frames of video data captured. In one embodiment, if the video capture device is in landscape orientation, then the processing performed by processing logic includes determining whether to crop video frames based on a mode of the video capture device and cropping the video data if the mode of the video capture device is a first mode. In one embodiment, if in the first mode, then processing logic crops the video data if the mode of the video capture device by reducing image resolution of the captured video data from N×M to M×P via downsampling, where N, M and P are integers and N is a width of the captured video data prior to cropping and M is the height of the captured video data prior to cropping and N is greater than M, and M is the width of the captured video data after cropping and P is the height of the captured video data after cropping and M is greater than P.

Next, processing logic detects a change in the orientation from portrait to landscape while capturing video data (processing block 3005). In one embodiment, processing logic creates a zoomed in effect for a display of at least portions of captured video data, where the zoomed in effect is based on a change from a full viewing angle in which video data is being captured in one orientation and a limited viewing angle in which the video data is being captured after a change in orientation. In one embodiment, if processing logic detects a change in orientation from portrait to landscape, processing logic continuously maps pixels of captured video data to a landscape orientation while the video capture device is in a landscape orientation. In one embodiment, processing logic processes the captured video data by digitally upsampling captured video data to increase resolution from M×P to N×M in response to detecting a change in orientation to landscape, where N, M and P are integers, and for M×P, M is the width of the captured video data and P is the height of the captured video data prior to upsampling and M is greater than P, and for N×M, N is a width of the captured video data and M is the height of the captured video data after upsampling and N is greater than M.

In one embodiment, processing logic captures a landscape aspect ratio of a camera sensor of the video capture device oriented in portrait mode and preserves the landscape aspect ratio when the orientation is changed between landscape and portrait. In another embodiment, processing logic captures a portrait aspect ratio of a camera sensor of the video capture device oriented in landscape mode and preserves the portrait aspect ratio when the orientation is changed between landscape and portrait.

Also, processing logic displays at least portions of the captured video data in a first orientation (processing block 3006). In one embodiment, the first orientation is user selected, by default or learned. In one embodiment, processing logic displays the video data on a screen of the video capture device in landscape orientation regardless of the orientation of the video capture device. In one embodiment, while capturing video data with a video capture device in a portrait orientation, processing logic displays a preview of the captured video in a landscape perspective, wherein the preview has a size equal to a size of a portrait orientation preview.

In one embodiment, Portscape™ and the Portscaping™ method and operations described above are performed by a device, such as, for example, smart devices of FIG. 9 and FIG. 11, that includes a camera to capture video data; a first memory to store captured video data; one or more processors coupled to the memory to process the captured video data; a display screen coupled to the one or more processors to display portions of the captured video data; one or more sensors to capture signal information; a second memory coupled to the one or more processors, wherein the memory includes instructions which when executed by the one or more processors implement logic to: detect orientation of the video capture device, map pixels of the video data captured to a landscape orientation if the video capture device is in a portrait orientation, and cause the display of video data on the display screen in landscape orientation regardless of the orientation of the video capture device.

In one embodiment, the landscape orientation is either landscape left or landscape right and the portrait orientation is either portrait up or portrait down. In another embodiment, the one or more processors execute instructions to implement logic to convert at least a portion of captured video data to a predetermined orientation format and perform one or more image processing operations on the captured video data based on the predetermined orientation. In yet another embodiment, the video data is captured in real-time, and the one or more processors execute instructions to implement logic to save the captured video data in the predetermined orientation format in real-time and display a preview of at least a portion of the captured video data in the predetermined orientation. In one embodiment, the one or more processors execute instructions to implement logic to create a zoomed in effect for a display of at least portions of captured video data, the zoomed in effect being based on a change from a full viewing angle in which video data is being captured in one orientation and a limited viewing angle in which the video data is being captured after a change in orientation.

In one embodiment, the one or more processors execute instructions to implement logic to detect a change in the orientation from portrait to landscape while capturing video data and continuously map pixels of captured video data to a landscape orientation while the video capture device is in a landscape orientation. In one embodiment, the one or more processors execute instructions to implement logic to create a zoomed out effect for captured video data in response to detecting the orientation has been changed from portrait to landscape, and the zoomed out effect is based on use of a smaller angle of view when capturing video data with the video capture device in the portrait orientation than the angle of view when capturing video data with the video capture device in the landscape orientation.

In one embodiment, the one or more processors execute instructions to implement logic to upsample captured video data to increase a number of pixels in frames of the captured video data to match a number of pixels in frames of video data captured while the video capture device is in landscape orientation. In another embodiment, if the orientation is landscape, then one or more processors execute instructions to implement logic to determine whether to trim video frames based on a mode of the video capture device, and trim the video data if the mode of the video capture device is a first mode. In yet another embodiment, the one or more processors execute instructions to implement logic to downsample captured video data to reduce a number of pixels in frames of the captured video data when capturing in landscape to match a number of pixels in frames of video data captured while the video capture device is in portrait orientation.

In one embodiment, if the orientation is portrait, then one or more processors execute instructions to implement logic to rotate and trim video frames of the video data captured by the video capture device. In one embodiment, the one or more processors execute instructions to implement logic to, while capturing video data with a video capture device in a portrait orientation, display a preview of the captured video in a landscape perspective, wherein the preview has a size equal to a size of a portrait orientation preview. In one embodiment, the one or more processors execute instructions to implement logic to detect a change in the orientation from landscape to portrait while capturing video data and repeat mapping pixels of the video data captured to a landscape based on the change in orientation.

### An Embodiment of a Storage Server System

FIG. 18 depicts a block diagram of a storage system server. Referring to FIG. 18, server 1810 includes a bus 1812 to interconnect subsystems of server 1810, such as a processor 1814, a system memory 1817 (e.g., RAM, ROM, etc.), an input/output controller 1818, an external device, such as a display screen 1824 via display adapter 1826, serial ports 1828 and 1830, a keyboard 1832 (interfaced with a keyboard controller 1833), a storage interface 1834, a floppy disk drive 1837 operative to receive a floppy disk 1838, a host bus adapter (HBA) interface card 1835A operative to connect with a Fibre Channel network 1890, a host bus adapter (HBA) interface card 1835B operative to connect to a SCSI bus 1839, and an optical disk drive 1840. Also included are a mouse 1846 (or other point-and-click device, coupled to bus 1812 via serial port 1828), a modem 1847 (coupled to bus 1812 via serial port 1830), and a network interface 1848 (coupled directly to bus 1812).

Bus 1812 allows data communication between central processor 1814 and system memory 1817. System memory 1817 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 1810 are generally stored on and accessed via a computer readable medium, such as a hard disk drive (e.g., fixed disk 1844), an optical drive (e.g., optical drive 1840), a floppy disk unit 1837, or other storage medium.

Storage interface 1834, as with the other storage interfaces of computer system 1810, can connect to a standard computer readable medium for storage and/or retrieval of information, such as a fixed disk drive 1844. Fixed disk drive 1844 may be a part of computer system 1810 or may be separate and accessed through other interface systems.

Modem 1847 may provide a direct connection to a remote server via a telephone link or to the Internet via an internet service provider (ISP). Network interface 1848 may provide a direct connection to a remote server or to a capture device. Network interface 1848 may provide a direct connection to a remote server via a direct network link to the Internet via a POP (point of presence). Network interface 1848 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 18 need not be present to practice the techniques described herein. The devices and subsystems can be interconnected in different ways from that shown in FIG. 18. The operation of a computer system such as that shown in FIG. 18 is readily known in the art and is not discussed in detail in this application.

Code to implement the storage server operations described herein can be stored in computer-readable storage media such as one or more of system memory 1817, fixed disk 1844, optical disk 1842, or floppy disk 1838. The operating system provided on computer system 1810 may be MS-DOS®, MS-WINDOWS®, OS/2®, UNIX®, Linux®, Android, or another known operating system.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A video editing system comprising:
editing processing logic controllable to perform, on one or more raw input feeds, a plurality of different edits to render one or more final cut clips for viewing,
each of the one or more edits to transform data from one or more of the raw input feeds into the one or more of the plurality of final cut clips by
generating tags that identify highlights from signals, and
generating one or more variations of the final cut clips as a result of independent control and application of the editing processing logic to data from the one or more raw input feeds, wherein the highlights are generated based on a master highlight list generated based on processing of tags from the tagging.

2. The video editing system defined in claim 1 wherein the master highlight list is generated by analyzing the tags and creating a correspondence between each of the tags and a portion of a raw input stream.

3. The video editing system defined in claim 1 wherein the master highlight list is generated by defining a beginning and an end of a highlight given a point in time and context of a tag, and creating a list of highlights for use in editing raw or rough input streams in non-real-time.

4. The video editing system defined in claim 1 wherein the master highlight list is generated based on results from a machine learning system.

5. The video editing system defined in claim 1 wherein the master highlight list is generated based on stakeholder preferences.

6. The video editing system defined in claim 1 wherein the master highlight list is generated based on analysis of a contextual environment in which a video was tagged.

7. The video editing system defined in claim 1 wherein at least one of the one or more rough-cut or final-cut versions is created from raw video data based on one version of a highlight list and one set of editing parameters from interaction by at least one stakeholder.

8. The video editing system defined in claim 1 wherein at least one of the one or more final-cut versions is created from one rough-cut version based on one version of a highlight list and one set of editing parameters from interaction by at least one stakeholder.

9. The video editing system defined in claim 1 wherein the editing process generates multiple instantiations of both rough cut versions and final cut versions of the video data based on multiple instantiations of a highlight list generated via tagging.

10. The video editing system defined in claim 1 wherein the editing process generates multiple final cut versions from a single rough-cut version according to preferences of different stakeholders.

11. The video editing system defined in claim 10 wherein the editing process generates multiple final cut versions from a signal rough-cut version according to a combination of preferences of two or more stakeholders.

12. A video editing process comprising:
performing, with editing processing logic, on one or more raw input feeds, a plurality of different edits to render one or more final cut clips for viewing, including performing each of the one or more edits to transform data from one or more of the raw input feeds into the one or more of the plurality of final cut clips by
generating tags that identify highlights from signals, and
generating one or more variations of the final cut clips as a result of independent control and application of the editing processing logic to data from the one or more raw input feeds, wherein the highlights are generated based on a master highlight list generated based on processing of tags from the tagging.

13. The video editing method defined in claim 12 wherein the master highlight list is generated by analyzing the tags and creating a correspondence between each of the tags and a portion of a raw input stream.

14. The video editing method defined in claim 12 wherein the master highlight list is generated by defining a beginning and an end of a highlight given a point in time and context of a tag, and creating a list of highlights for use in editing raw or rough input streams in non-real-time.

15. The video editing method defined in claim 12 wherein the master highlight list is generated based on results from a machine learning system.

16. The video editing method defined in claim 12 wherein the master highlight list is generated based on stakeholder preferences.

17. The video editing method defined in claim 12 wherein the master highlight list is generated based on analysis of a contextual environment in which a video was tagged.

18. An article of manufacture having one or more non-transitory computer readable storage media storing instructions which, when executed by a system, causes the system to perform a video editing process comprising:
performing, with editing processing logic, on one or more raw input feeds, a plurality of different edits to render one or more final cut clips for viewing, including performing each of the one or more edits to transform data from one or more of the raw input feeds into the one or more of the plurality of final cut clips by
generating tags that identify highlights from signals, and
generating one or more variations of the final cut clips as a result of independent control and application of the editing processing logic to data from the one or more raw input feeds, wherein the highlights are generated based on a master highlight list generated based on processing of tags from the tagging.

19. The article of manufacture defined in claim 18 wherein the master highlight list is generated based on stakeholder preferences.

20. The article of manufacture defined in claim 18 wherein the editing process generates multiple final cut versions from a single rough-cut version according to preferences of different stakeholders.

21. The article of manufacture defined in claim 18 wherein the editing process generates multiple final cut versions from a signal rough-cut version according to a combination of preferences of two or more stakeholders.
